(19) United States
(12) Patent Application Publication
(10) Pub. No.: US 2008/0145800 A1
(43) Pub. Date: Jun. 19, 2008

(54) PHOTOTHERMOGRAPHIC MATERIALS CONTAINING DEVELOPER AND CO-DEVELOPER

(76) Inventors: Chaofeng Zou, Maplewood, MN (US); Fong Vang, Forest Lake, MN (US); Doreen C. Lynch, Afton, MN (US); William D. Ramsden, Afton, MN (US); Sharon M. Simpson, Lake Elmo, MN (US); Kumars Sakizadeh, Woodbury, MN (US)

Correspondence Address: Carestream Health Inc,, 150 Verona Street, Rochester, NY, 14608, US

(21) Appl. No.: 11/735,530

(22) Filed: Apr. 16, 2007

Related U.S. Application Data
(63) Continuation-in-part of application No. 11/611,913, filed on Dec. 18, 2006.

(51) Int. Cl. G03C 5/00

(52) U.S. Cl. 430/330; 430/564

(57) ABSTRACT

Use of a combination of a trisphenol reducing agent (developer) and a substituted olefinic co-developer in photothermographic materials provides a number of improvements including a reduction of sensitivity to high humidity and improved processing latitude.

### CROSS-REFERENCE TO RELATED APPLICATIONS

This is a continuation-in-part of application Ser. No. 11/611,913, filed Dec. 18, 2006 entitled PHOTOTHERMOGRAPHIC MATERIALS CONTAINING DEVELOPER AND CO-DEVELOPER by Chaofeng Zou et al.

### FIELD OF THE INVENTION

This invention relates to black-and-white photothermographic materials having a combination of a trisphenol reducing agent and a substituted olefinic co-developer that exhibit improved processing latitude and reduced sensitivity to humidity. This invention also relates to methods of imaging and using these materials.

### BACKGROUND OF THE INVENTION

Silver-containing photothermographic imaging materials (that is, photosensitive thermally developable imaging materials) that are imaged with actinic radiation and then developed using heat and without liquid processing, have also been known in the art for many years. Such materials are used in a recording process wherein an image is formed by imagewise exposure of the photothermographic material to specific electromagnetic radiation (for example, X-radiation, or ultraviolet, visible, or infrared radiation) and developed by the use of thermal energy. These materials, also known as “dry silver” materials, generally comprise a support having coated thereon: (a) a photocatalyst (that is, a photosensitive compound such as silver halide) that upon such exposure provides a latent image in exposed grains that are capable of acting as a catalyst for the subsequent formation of a silver image in a development step, (b) a relatively or completely non-photosensitive source of reducible silver ions, (c) a reducing composition (acting as a developer) for the reducible silver ions, and (d) a binder. The latent image is then developed by application of thermal energy.

In photothermographic materials, exposure of the photosensitive silver halide to light produces small clusters containing silver atoms (Ag⁰)ₙ. The imagewise distribution of these clusters, known in the art as a latent image, is generally not visible by ordinary means. Thus, the photosensitive material must be further developed to produce a visible image. This is accomplished by the reduction of silver ions that are in catalytic proximity to silver halide grains bearing the silver-containing clusters of the latent image. This produces a black-and-white image. The non-photosensitive silver source is catalytically reduced to form the visible black-and-white negative image of silver while much of the silver halide, generally, remains as silver halide and is not reduced.

In photothermographic materials, a typical non-photosensitive reducible silver source is a silver salt of a long chain aliphatic carboxylic acid having from 10 to 30 carbon atoms, such as behenic acid or mixtures of acids of similar molecular weight. At elevated temperatures, the silver of the silver carboxylate is reduced by a reducing agent for silver ion (also known as a developer), whereby elemental silver is formed. The reducing agent for the reducible silver ions, often referred to as a “developer”, may be any compound that, in the presence of the latent image, can reduce silver ion to metallic silver and is usually of relatively low activity until it is heated to a temperature sufficient to cause the reaction. A wide variety of classes of compounds have been disclosed in the literature that function as reducing agents for photothermographic materials. Upon heating, and at elevated temperatures, the reducible silver ions are reduced by the reducing agent. This reaction occurs preferentially in the regions surrounding the latent image and produces a negative image of metallic silver having a color that ranges from yellow to deep black depending upon the presence of toning agents and other components in the photothermographic imaging layer(s).

### Differences Between Photothermography and Photography

The imaging arts have long recognized that the field of photothermography is clearly distinct from that of photography. Photothermographic materials differ significantly from conventional silver halide photographic materials that require processing with aqueous processing solutions.

In photothermographic imaging materials, a visible image is created in the absence of a processing solvent by heat as a result of the reaction of a reducing agent incorporated within the material. Heating at 50° C. or more is essential for this dry development. In contrast, conventional photographic imaging materials require processing in aqueous processing baths at more moderate temperatures (from 30° C. to 50° C.) to provide a visible image.

In photothermographic materials, only a small amount of silver halide is used to capture light and a non-photosensitive source of reducible silver ions (for example, a silver carboxylate or a silver benzotriazole) is used to generate the visible image using thermal development. Thus, the imaged photosensitive silver halide serves as a catalyst for the physical development process involving the non-photosensitive source of reducible silver ions and the incorporated reducing agent. In contrast, conventional wet-processed, black-and-white photographic materials use only one form of silver (that is, silver halide) that, upon chemical development, is itself at least partially converted into the silver image, or that upon physical development requires addition of an external silver source (or other reducible metal ions that form black images upon reduction to the corresponding metal). Thus, photothermographic materials require an amount of silver halide per unit area that is only a fraction of that used in conventional wet-processed photographic materials.

In photothermographic materials, all of the “chemistry” for imaging is incorporated within the material itself. For example, such materials include a reducing agent (that is, a developer for the reducible silver ions) while conventional photographic materials usually do not. The incorporation of the reducing agent into photothermographic materials can lead to increased formation of various types of “fog” or other undesirable sensitometric side effects. Therefore, much effort has gone into the preparation and manufacture of photothermographic materials to minimize these problems.

Moreover, in photothermographic materials, the unexposed silver halide generally remains intact after development and the material must be stabilized against further imaging and development. In contrast, silver halide is removed from conventional photographic materials after solution development to prevent further imaging (that is in the aqueous fixing step).

Because photothermographic materials require dry thermal processing, they present distinctly different problems and require different materials in manufacture and use, compared to conventional, wet-processed silver halide photographic materials. Additives that have one effect in conventional silver halide photographic materials may behave quite differently when incorporated in photothermographic materials where the underlying chemistry is significantly more complex. The incorporation of such additives as, for example, stabilizers, antifoggants, speed enhancers, supersensitizers, and spectral and chemical sensitizers in conventional photographic materials is not predictive of whether such additives will prove beneficial or detrimental in photothermographic materials. For example, it is not uncommon for a photographic antifoggant useful in conventional photographic materials to cause various types of fog when incorporated into photothermographic materials, or for supersensitizers that are effective in photographic materials to be inactive in photothermographic materials.

These and other distinctions between photothermographic and photographic materials are described in Unconventional Imaging Processes, E. Brinckman et al. (Eds.), The Focal Press, London and New York, 1978, pp. 74-75, in D. H. Klosterboer, Imaging Processes and Materials, (Neblette's Eighth Edition), J. Sturge, V. Walworth, and A. Shepp, Eds., Van Nostrand-Reinhold, New York, 1989, Chapter 9, pp. 279-291, in C. Zou et al., J. Imaging Sci. Technol. 1996, 40, pp. 94-103, and in M. R. V. Sahyun, J. Imaging Sci. Technol. 1998, 42, 23.

### Problem to be Solved

U.S. Pat. No. 6,413,712 (Yoshioka et al.), U.S. Pat. No. 5,968,725 (Katoh), U.S. Pat. No. 6,090,538 (Arai), and U.S. Pat. No. 6,645,714 (Oya) describe various binary mixtures of bisphenols with monophenols or trisphenols with monophenols as reducing agents (developers) in photothermographic materials.

Nucleating agents or co-developers have been described in the art for use in photothermographic materials to provide unique properties such as ultra high image contrast, higher development reactivity, or higher silver efficiency. For example, substituted olefinic co-developers such as acrylonitrile co-developers are described in U.S. Pat. No. 5,545,515 (Murray et al.) and U.S. Pat. No. 5,635,339 (Murray). Other useful acrylonitrile co-developers have a crown ether-alkali metal complex cation and an enolate anion of an aldehyde with at least one electron withdrawing group in the α-position as described for example in copending and commonly assigned U.S. Ser. No. 11/455,415 (filed Jun. 19, 2006 by Simpson and Sakizadeh). Yet, other useful acrylonitrile co-developers have a phosphonium cation and enolate anion of an aldehyde as described for example, in copending and commonly assigned U.S. Ser. No. 11/611,914 (filed Dec. 18, 2006 by Simpson and Sakizadeh).

However, due to the reactive nature of many known nucleating agents, it has been difficult to use them for practical applications in commercial products that require the contrast of the sensitometric D vs. log E curve to be less than 5 to provide images with continuous tone (that is, to give an adequate gray scale range necessary for medical diagnostic purposes). The sensitometric properties of photothermographic materials containing known co-developers as development accelerators or as silver efficiency enhancing agents generally fluctuate with changing humidity conditions during coating, storage, imaging, and processing. We also observed that there is a need to improve the development processing latitude with respect to variations in processing time and temperature, especially under high humidity conditions.

Thus, there is a need to find a way to benefit from the presence of co-developers in photothermographic materials without detrimental effects on sensitometric properties and processing latitude observed in high humidity conditions. There is also a need to reduce sensitivity of the materials to varying humidity conditions.

### SUMMARY OF THE INVENTION

To address this need, this invention provides a photothermographic material comprising a support having on at least one side thereof, one or more photothermographic imaging layers comprising in reactive association:

a. a photosensitive silver halide,

b. a non-photosensitive source of reducible silver ions,

c. a reducing agent composition for the reducible silver ions,

d. a polymeric binder, and

e. a substituted olefinic co-developer,

wherein the reducing agent composition comprises a trisphenol reducing agent represented by the following Structure (I):

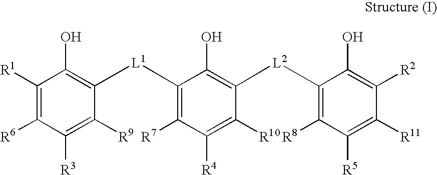

wherein L¹ and L² are independently sulfur or a mono-substituted or unsubstituted methylene groups,

R¹ and R² are independently primary or secondary substituted or unsubstituted alkyl groups having 1 to 12 carbon atoms,

R³, R⁴, and R⁵ are independently substituted or unsubstituted alkyl groups having 1 to 12 carbon atoms, substituted or unsubstituted alkoxy groups having 1 to 12 carbon atoms, or halo groups, and

R⁶, R⁷, R⁸, R⁹, R¹⁰, and R¹¹ are independently hydrogen or any substituent that is substitutable on a benzene ring.

This invention further provides a method of forming a visible image comprising:

(A) imagewise exposing a photothermographic material of this invention to electromagnetic radiation to form a latent image,

(B) simultaneously or sequentially, heating the exposed photothermographic material to develop the latent image into a visible image.

We have found that by incorporating specific combinations of a trisphenol reducing agent and a substituted olefinic co-developer in the photothermographic materials, improved processing latitude and reduced sensitivity to humidity were achieved with little change in other sensitometric properties. These advantages were an unexpected improvement over the use of solely a bisphenol reducing agent with a substituted olefinic co-developer. It has also been found that the use of certain substituted olefinic co-developers with a trisphenol reducing agent provides improved solution “pot life”, which is the time between preparation of a photothermographic solution/dispersion and its coating onto a support. Using the present invention, “pot-life” can vary with only minimal changes in the photothermographic sensitometric properties, and thus leading to improved manufacturing flexibility. It has further been found that the use of certain substituted olefinic co-developers with a trisphenol reducing agent provides improved “shelf life”, meaning that the photothermographic imaging material has improved retention of its sensitometric properties during storage prior to use.

### DETAILED DESCRIPTION OF THE INVENTION

The photothermographic materials of this invention are used to provide black-and-white or color images using appropriate imaging chemistry and particularly non-photosensitive organic silver salts, photosensitive silver halides, reducing agents, toners, binders, and other components known to a skilled artisan. The reducing agent and substituted olefinic co-developer combinations described herein are present in reactive association with the photosensitive silver halide and non-photosensitive silver salt.

The photothermographic materials can be used in black-and-white or color photothermography and in electronically generated black-and-white or color hardcopy recording. They can be used in microfilm applications, in radiographic imaging (for example digital medical imaging), X-ray radiography, and in industrial radiography. Furthermore, the absorbance of these materials between 350 and 450 nm is desirably low (less than 0.5), to permit their use in the graphic arts area (for example, image-setting and phototype-setting), in the manufacture of printing plates, in contact printing, in duplicating (“duping”), and in proofing. Black-and-white imaging is particularly useful.

The photothermographic materials are particularly useful for imaging of human or animal subjects in response to X-radiation, ultraviolet, visible, or infrared radiation for use in a medical diagnosis. Such applications include, but are not limited to, thoracic imaging, mammography, dental imaging, orthopedic imaging, general medical radiography, therapeutic radiography, veterinary radiography, and autoradiography. When used with X-radiation, the photothermographic materials may be used in combination with one or more phosphor intensifying screens, with phosphors incorporated within the photothermographic emulsion, or with combinations thereof. Such materials are also useful for dental radiography when they are directly imaged by X-radiation. The materials are also useful for non-medical uses of X-radiation such as X-ray lithography and industrial radiography.

The photothermographic materials can be made sensitive to radiation of any suitable wavelength. Thus, in some embodiments, the materials are sensitive at ultraviolet, visible, infrared, or near infrared wavelengths, of the electromagnetic spectrum. In most embodiments, the materials are sensitive to radiation greater than 600 nm (for example, sensitive to infrared radiation from about 700 up to about 950 nm). Increased sensitivity to a particular region of the spectrum is imparted through the use of various spectral sensitizing dyes.

In the photothermographic materials, the components needed for imaging can be in one or more photothermographic imaging layers on one side (“frontside”) of the support. The layer(s) that contain the photosensitive photocatalyst (such as a photosensitive silver halide) or non-photosensitive source of reducible silver ions, or both, are referred to herein as photothermographic emulsion layer(s). The photocatalyst and the non-photosensitive source of reducible silver ions are in catalytic proximity and generally are in the same emulsion layer.

Where the photothermographic materials contain imaging layers on one side of the support only, various non-imaging layers are usually disposed on the “backside” (non-emulsion or non-imaging side) of the materials, including conductive/antistatic layers, antihalation layers, protective layers, and transport enabling layers.

Various non-imaging layers can also be disposed on the “frontside” or imaging or emulsion side of the support, including protective frontside overcoat layers, primer layers, interlayers, opacifying layers, conductive/antistatic layers, antihalation layers, acutance layers, auxiliary layers, and other layers readily apparent to one skilled in the art.

For some embodiments, it may be useful that the photothermographic materials be “double-sided” or “duplitized” and have the same or different photothermographic coatings (or imaging layers) on both sides of the support. In such constructions each side can also include one or more protective overcoat layers, primer layers, interlayers, acutance layers, conductive/antistatic layers auxiliary layers, anti-crossover layers, and other layers readily apparent to one skilled in the art, as well as the required conductive layer(s).

When the photothermographic materials are heat-developed as described below in a substantially water-free condition after, or simultaneously with, imagewise exposure, a silver image (for example, a black-and-white silver image) is obtained.

### DEFINITIONS

As used herein:

In the descriptions of the photothermographic materials, “a” or “an” component refers to “at least one” of that component (for example, the reducing agents, substituted olefinic co-developers, and phosphonium salts described herein).

As used herein, “black-and-white” refers to an image formed by silver metal, as opposed to an image formed using a combination of dyes or color couplers.

Unless otherwise indicated, when the term “photothermographic materials” is used herein, the term refers to embodiments of the present invention.

Heating in a substantially water-free condition as used herein, means heating at a temperature of from about 50° C. to about 250° C. with little more than ambient water vapor present. The term “substantially water-free condition” means that the reaction system is approximately in equilibrium with water in the air and water or any other solvent for inducing or promoting the reaction is not particularly or positively supplied from the exterior to the material. Such a condition is described in T. H. James, The Theory of the Photographic Process, Fourth Edition, Eastman Kodak Company, Rochester, N.Y., 1977, p. 374.

“Photothermographic material(s)” means a dry processable integral element comprising a support and at least one photothermographic emulsion layer or a photothermographic set of emulsion layers (wherein the photosensitive silver halide and the source of reducible silver ions are in one layer and the other necessary components or additives are distributed, as desired, in the same layer or in an adjacent coated layer). These materials also include multilayer constructions in which one or more imaging components are in different layers, but are in “reactive association”. For example, one layer can include the non-photosensitive source of reducible silver ions and another layer can include the reducing and substituted olefinic co-developer, but the two reactive components are in reactive association with each other. By “integral”, we mean that all imaging chemistry required for imaging is in the material without diffusion of imaging chemistry or reaction products (such as a dye) from or to another element (such as a receiver element).

When used in photothermography, the term, “imagewise exposing” or “imagewise exposure” means that the material is imaged as a dry processable material using any exposure means that provides a latent image using electromagnetic radiation. This includes, for example, by analog exposure where an image is formed by projection onto the photosensitive material as well as by digital exposure where the image is formed one pixel at a time such as by modulation of scanning laser radiation.

The term “emulsion layer”, “imaging layer”, or “photothermographic emulsion layer” means a layer of a photothermographic material that contains the photosensitive silver halide (when used) and/or non-photosensitive source of reducible silver ions, or a reducing agent composition. Such layers can also contain additional components or desirable additives. These layers are on what is referred to as the “frontside” of the support.

“Photocatalyst” means a photosensitive compound such as silver halide that, upon exposure to radiation, provides a compound that is capable of acting as a catalyst for the subsequent development of the image-forming material.

“Catalytic proximity” or “reactive association” means that the reactive components are in the same layer or in adjacent layers so that they readily come into contact with each other during imaging and thermal development.

The terms “reducing agent” and “developer” mean the same, and the terms “co-reducing agent” and “co-developer” also mean the same.

“Simultaneous coating” or “wet-on-wet” coating means that when multiple layers are coated, subsequent layers are coated onto the initially coated layer before the initially coated layer is dry. Simultaneous coating can be used to apply layers on the frontside, backside, or both sides of the support.

“Transparent” means capable of transmitting visible light or imaging radiation without appreciable scattering or absorption.

The phrases “silver salt” and “organic silver salt” refer to an organic molecule having a bond to a silver atom. Although the compounds so formed are technically silver coordination complexes or silver compounds they are also often referred to as silver salts.

The phrase “aryl group” refers to an organic group derived from an aromatic hydrocarbon by removal of one atom, such as a phenyl group formed by removal of one hydrogen atom from benzene.

“Silver Efficiency” is defined as Dmax divided by the total silver coating weight in units of g/m².

The term “buried layer” means that there is at least one other layer disposed over the layer (such as a “buried” backside conductive layer).

The terms “coating weight”, “coat weight”, and “coverage” are synonymous, and are usually expressed in weight or moles per unit area such as g/m² or mol/m².

“Ultraviolet region of the spectrum” refers to that region of the spectrum less than or equal to 400 nm (for example, from about 100 nm to about 400 nm) although parts of these ranges may be visible to the naked human eye.

“Visible region of the spectrum” refers to that region of the spectrum of from about 400 nm to about 700 nm.

“Short wavelength visible region of the spectrum” refers to that region of the spectrum of from about 400 nm to about 450 nm.

“Red region of the spectrum” refers to that region of the spectrum of from about 600 nm to about 700 nm.

“Infrared region of the spectrum” refers to that region of the spectrum of from about 700 nm to about 1400 nm.

“Non-photosensitive” means not intentionally light sensitive.

The sensitometric terms “photospeed”, “speed”, or “photographic speed” (also known as sensitivity), absorbance, and contrast have conventional definitions known in the imaging arts. The sensitometric term absorbance is another term for optical density (OD).

Speed-2 is Log1/E+4 corresponding to the density value of 1.0 above Dmin where E is the exposure in ergs/cm².

Average Contrast-1(“AC-1”) is the absolute value of the slope of the line joining the density points at 0.60 and 2.00 above Dmin.

In photothermographic materials, the term Dmin (lower case) is considered herein as image density achieved when the photothermographic material is thermally developed without prior exposure to radiation. The term Dmax (lower case) is the maximum image density achieved in the imaged area of a particular sample after imaging and development.

The term DMIN (upper case) is the density of the nonimaged, undeveloped material. The term DMAX (upper case) is the maximum image density achievable when the photothermographic material is exposed and then thermally developed. DMAX is also known as “Saturation Density”.

As is well understood in this art, for the chemical compounds herein described, substitution is not only tolerated, but is often advisable and various substituents are anticipated on the compounds used in the present invention unless otherwise stated. Thus, when a compound is referred to as “having the structure” of a given formula or being a “derivative” of a compound, any substitution that does not alter the bond structure of the formula or the shown atoms within that structure is included within the formula, unless such substitution is specifically excluded by language.

Olefinic compounds (such as olefinic co-developers) that are described or shown with one particular geometry about the carbon-carbon double bond will be understood to include both “cis” and “trans” isomers about the double bond, including mixtures thereof.

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. For example, alkyl group includes ether and thioether groups (for example CH₃—₂—₂—O—CH₂— and CH₃—₂—₂—S—CH₂—), haloalkyl, nitroalkyl, alkylcarboxy, carboxyalkyl, carboxamido, hydroxyalkyl, sulfoalkyl, and other groups readily apparent to one skilled in the art. Substituents that adversely react with other active ingredients, such as very strongly electrophilic or oxidizing substituents, would, of course, be excluded by the skilled artisan as not being inert or harmless.

Research Disclosure (http://www.researchdisclosure.com) is a publication of Kenneth Mason Publications Ltd., The Book Barn, Westbourne, Hampshire PO10 8RS, UK. It is also available from Emsworth Design Inc., 200 Park Avenue South, Room 1101, New York, N.Y. 10003.

Other aspects, advantages, and benefits of the present invention are apparent from the detailed description, examples, and claims provided in this application.

### The Photocatalyst

As noted above, photothermographic materials include one or more photocatalysts in the photothermographic emulsion layer(s). Useful photocatalysts are typically photosensitive silver halides such as silver bromide, silver iodide, silver chloride, silver bromoiodide, silver chlorobromoiodide, silver chlorobromide, and others readily apparent to one skilled in the art. Mixtures of silver halides can also be used in any suitable proportion. Silver bromide and silver iodide are useful. Also useful is silver bromoiodide in which any suitable amount of iodide is present up to almost 100% silver iodide and more likely up to about 40 mol % silver iodide. For example, the silver bromoiodide can comprise at least 70 mole % (for example, at least 85 mole % or at least 90 mole %) bromide (based on total silver halide). The remainder of the halide is iodide, chloride, or chloride and iodide. In most embodiments, the additional halide is iodide. Silver bromide and silver bromoiodide are useful, with the latter silver halide generally having up to 10 mole % silver iodide.

In some embodiments of aqueous-based photothermographic materials, higher amounts of iodide may be present in homogeneous photosensitive silver halide grains, and particularly from about 20 mol % up to the saturation limit of iodide as described, for example, U.S. Patent Application Publication 2004/0053173 (Maskasky et al.).

The silver halide grains may have any crystalline habit or morphology including, but not limited to, cubic, octahedral, tetrahedral, orthorhombic, rhombic, dodecahedral, other polyhedral, tabular, laminar, twinned, or platelet morphologies and may have epitaxial growth of crystals thereon. If desired, a mixture of grains with different morphologies can be employed. Silver halide grains having cubic and tabular morphology (or both) are useful.

The silver halide grains may have a uniform ratio of halide throughout. They may also have a graded halide content, with a continuously varying ratio of, for example, silver bromide and silver iodide or they may be of the core-shell type, having a discrete core of one or more silver halides, and a discrete shell of one or more different silver halides. Core-shell silver halide grains useful in photothermographic materials and methods of preparing these materials are described in U.S. Pat. No. 5,382,504 (Shor et al.). Iridium and/or copper doped core-shell and non-core-shell grains are described in U.S. Pat. No. 5,434,043 (Zou et al.) and U.S. Pat. No. 5,939,249 (Zou). Bismuth(III)-doped high silver iodide emulsions for aqueous-based photothermographic materials are described in U.S. Pat. No. 6,942,960 (Maskasky et al.).

In some instances, it may be helpful to prepare the photosensitive silver halide grains in the presence of a hydroxytetraazaindene (such as 4-hydroxy-6-methyl-1,3,3a,7-tetraazaindene) or an N-heterocyclic compound comprising at least one mercapto group (such as 1-phenyl-5-mercaptotetrazole) as described in U.S. Pat. No. 6,413,710 (Shor et al.).

The photosensitive silver halide can be added to (or formed within) the emulsion layer(s) in any fashion as long as it is placed in catalytic proximity to the non-photosensitive source of reducible silver ions.

In many embodiments, the silver halides is preformed and prepared by an ex-situ process. With this technique, one has the possibility of more precisely controlling the grain size, grain size distribution, dopant levels, and composition of the silver halide, so that one can impart more specific properties to both the silver halide grains and the resulting photothermographic material.

In some constructions, it is desired to form the non-photosensitive source of reducible silver ions in the presence of ex-situ-prepared silver halide. In this process, the source of reducible silver ions, such as a long chain fatty acid silver carboxylate (commonly referred to as a silver “soap” or homogenate), is formed in the presence of the preformed silver halide grains. Co-precipitation of the source of reducible silver ions in the presence of silver halide provides a more intimate mixture of the two materials to provide a material often referred to as a “preformed soap” [see U.S. Pat. No. 3,839,049 (Simons)].

In other constructions, the preformed silver halide grains are added to and “physically mixed” with the non-photosensitive source of reducible silver ions.

Preformed silver halide emulsions can be prepared by aqueous or organic processes and can be unwashed or washed to remove soluble salts. Soluble salts can be removed by any desired procedure for example as described in U.S. Pat. No. 2,489,341 (Waller et al.), U.S. Pat. No. 2,565,418 (Yackel), U.S. Pat. No. 2,614,928 (Yutzy et al.), U.S. Pat. No. 2,618,556 (Hewitson et al.), and U.S. Pat. No. 3,241,969 (Hart et al.).

It is also effective to use an in-situ process in which a halide- or a halogen-containing compound is added to an organic silver salt to partially convert the silver of the organic silver salt to silver halide. Inorganic halides (such as zinc bromide, zinc iodide, calcium bromide, lithium bromide, lithium iodide, or mixtures thereof) or an organic halogen-containing compound (such as N-bromo-succinimide or pyridinium hydrobromide perbromide) can be used. The details of such in-situ generation of silver halide are described in U.S. Pat. No. 3,457,075 (Morgan et al.).

It is also effective to use a mixture of both preformed and in-situ generated silver halide. The preformed silver halide is preferably present in a preformed soap.

Additional methods of preparing silver halides and organic silver salts and blending them are described in Research Disclosure, June 1978, item 17029, U.S. Pat. No. 3,700,458 (Lindholm) and U.S. Pat. No. 4,076,539 (Ikenoue et al.), and Japan Kokai 49-013224 (Fuji), 50-017216 (Fuji), and 51-042529 (Fuji).

The silver halide grains used in the imaging formulations can vary in average diameter of up to several micrometers (μm) depending on the desired use. For example, silver halide grains for use in preformed emulsions containing silver carboxylates are cubic grains having a number average particle size of from about 0.01 to about 1.0 μm, or typically those having a number average particle size of from about 0.03 to about 0.1 μm. The grains may have a number average particle size of 0.06 μm or less, and typically they have a number average particle size of from about 0.03 to about 0.06 μm. Mixtures of grains of various average particle size can also be used. Silver halide grains for high-speed photothermographic constructions use are tabular grains having an average thickness of at least 0.02 μm and up to and including 0.10 μm, an equivalent circular diameter of at least 0.5 μm and up to and including 8 μm and an aspect ratio of at least 5:1. Other grains have an average thickness of at least 0.03 μm and up to and including 0.08 μm, an equivalent circular diameter of at least 0.75 μm and up to and including 6 μm and an aspect ratio of at least 10:1.

The average size of the photosensitive silver halide grains is expressed by the average diameter if the grains are spherical, and by the average of the diameters of equivalent circles for the projected images if the grains are cubic or in other non-spherical shapes. Representative grain sizing methods are described in Particle Size Analysis, ASTM Symposium on Light Microscopy, R. P. Loveland, 1955, pp. 94-122, and in C. E. K. Mees and T. H. James, The Theory of the Photographic Process, Third Edition, Macmillan, New York, 1966, Chapter 2. Particle size measurements may be expressed in terms of the projected areas of grains or approximations of their diameters. These will provide reasonably accurate results if the grains of interest are substantially uniform in shape.

The one or more light-sensitive silver halides are generally present in an amount of from about 0.005 to about 0.5 mole, typically from about 0.01 to about 0.25 mole, or from about 0.03 to about 0.15 mole, per mole of non-photosensitive source of reducible silver ions.

### Chemical Sensitization

The photosensitive silver halides can be chemically sensitized using any useful compound that contains sulfur, tellurium, or selenium, or may comprise a compound containing gold, platinum, palladium, ruthenium, rhodium, iridium, or combinations thereof, a reducing agent such as a tin halide or a combination of any of these. The details of these materials are provided for example, in T. H. James, The Theory of the Photographic Process, Fourth Edition, Eastman Kodak Company, Rochester, N.Y., 1977, Chapter 5, pp. 149-169. Suitable conventional chemical sensitization procedures are also described in U.S. Pat. No. 1,623,499 (Sheppard et al.), U.S. Pat. No. 2,399,083 (Waller et al.), U.S. Pat. No. 3,297,446 (Dunn), U.S. Pat. No. 3,297,447 (McVeigh), U.S. Pat. No. 5,049,485 (Deaton), U.S. Pat. No. 5,252,455 (Deaton), U.S. Pat. No. 5,391,727 (Deaton), U.S. Pat. No. 5,759,761 (Lushington et al.), and U.S. Pat. No. 5,912,111 (Lok et al.), and EP 0 915 371A1 (Lok et al.).

Mercaptotetrazoles and tetraazindenes as described in U.S. Pat. No. 5,691,127 (Daubendiek et al.) can also be used as suitable addenda for tabular silver halide grains.

Certain substituted and unsubstituted thiourea compounds can be used as chemical sensitizers including those described in U.S. Pat. No. 6,368,779 (Lynch et al.).

Still other additional chemical sensitizers include certain tellurium-containing compounds that are described in U.S. Pat. No. 6,699,647 (Lynch et al.), and certain selenium-containing compounds that are described in U.S. Pat. No. 6,620,577 (Lynch et al.).

Combinations of gold(III)-containing compounds and either sulfur-, tellurium-, or selenium-containing compounds are also useful as chemical sensitizers as described in U.S. Pat. No. 6,423,481 (Simpson et al.).

In addition, sulfur-containing compounds can be decomposed on silver halide grains in an oxidizing environment according to the teaching in U.S. Pat. No. 5,891,615 (Winslow et al.). Examples of sulfur-containing compounds that can be used in this fashion include sulfur-containing spectral sensitizing dyes. Other useful sulfur-containing chemical sensitizing compounds that can be decomposed in an oxidizing environment are the diphenylphosphine sulfide compounds described in U.S. Pat. No. 7,026,105 (Simpson et al.) and U.S. Pat. No. 7,063,941 (Burleva et al.), and in U.S. Patent Application Publication 2005/0123871 (Burleva et al.).

The chemical sensitizers can be present in conventional amounts that generally depend upon the average size of the silver halide grains. Generally, the total amount is at least 10⁻¹⁰ mole per mole of total silver, and typically from about 10⁻⁸ to about 10⁻² mole per mole of total silver for silver halide grains having an average size of from about 0.01 to about 1 μm.

### Spectral Sensitization

The photosensitive silver halides may be spectrally sensitized with one or more spectral sensitizing dyes that are known to enhance silver halide sensitivity to ultraviolet, visible, and/or infrared radiation (that is, sensitivity within the range of from about 300 to about 1400 nm). In most embodiments, the photosensitive silver halide is sensitized to infrared radiation (that is from about 700 to about 950 nm). Non-limiting examples of spectral sensitizing dyes that can be employed include cyanine dyes, merocyanine dyes, complex cyanine dyes, complex merocyanine dyes, holopolar cyanine dyes, hemicyanine dyes, styryl dyes, and hemioxanol dyes. They may be added at any stage in the preparation of the photothermographic emulsion, but are generally added after chemical sensitization is achieved.

Suitable spectral sensitizing dyes such as those described in U.S. Pat. No. 3,719,495 (Lea), U.S. Pat. No. 4,396,712 (Kinoshita et al.), U.S. Pat. No. 4,439,520 (Kofron et al.), U.S. Pat. No. 4,690,883 (Kubodera et al.), U.S. Pat. No. 4,840,882 (Iwagaki et al.), U.S. Pat. No. 5,064,753 (Kohno et al.), U.S. Pat. No. 5,281,515 (Delprato et al.), U.S. Pat. No. 5,393,654 (Burrows et al.), U.S. Pat. No. 5,441,866 (Miller et al.), U.S. Pat. No. 5,508,162 (Dankosh), U.S. Pat. No. 5,510,236 (Dankosh), and U.S. Pat. No. 5,541,054 (Miller et al.), Japan Kokai 2000-063690 (Tanaka et al.), 2000-112054 (Fukusaka et al.), 2000-273329 (Tanaka et al.), 2001-005145 (Arai), 2001-064527 (Oshiyama et al.), and 2001-154305 (Kita et al.) can be used. Useful spectral sensitizing dyes are also described in Research Disclosure, December 1989, item 308119, Section IV and Research Disclosure, 1994, item 36544, section V.

Teachings relating to specific combinations of spectral sensitizing dyes also include U.S. Pat. No. 4,581,329 (Sugimoto et al.), U.S. Pat. No. 4,582,786 (Ikeda et al.), U.S. Pat. No. 4,609,621 (Sugimoto et al.), U.S. Pat. No. 4,675,279 (Shuto et al.), U.S. Pat. No. 4,678,741 (Yamada et al.), U.S. Pat. No. 4,720,451 (Shuto et al.), U.S. Pat. No. 4,818,675 (Miyasaka et al.), U.S. Pat. No. 4,945,036 (Arai et al.), and U.S. Pat. No. 4,952,491 (Nishikawa et al.).

Also useful are spectral sensitizing dyes that decolorize by the action of light or heat as described in U.S. Pat. No. 4,524,128 (Edwards et al.) and Japan Kokai 2001-109101 (Adachi), 2001-154305 (Kita et al.), and 2001-183770 (Hanyu et al.).

Dyes and other compounds may be selected for the purpose of supersensitization to attain much higher sensitivity than the sum of sensitivities that can be achieved by using a sensitizer alone. Examples of such supersensitizers include the metal chelating compounds disclosed in U.S. Pat. No. 4,873,184 (Simpson), the large cyclic compounds featuring a heteroatom disclosed in U.S. Pat. No. 6,475,710 (Kudo et al.), the stilbene compounds disclosed in EP 0 821 271 (Uytterhoeven et al.).

An appropriate amount of spectral sensitizing dye added is generally about 10⁻¹⁰ to 10⁻¹ mole, and typically, about 10⁻⁷ to 10⁻² mole per mole of silver halide.

### Non-Photosensitive Source of Reducible Silver Ions

The non-photosensitive source of reducible silver ions in the thermally developable materials is a silver-organic compound that contains reducible silver(I) ions. Such compounds are generally silver salts of silver organic coordinating ligands that are comparatively stable to light and form a silver image when heated to 50° C. or higher in the presence of an exposed photocatalyst (such as silver halide, when used in a photothermographic material) and a reducing agent composition.

The primary organic silver salt is often a silver salt of an aliphatic carboxylic acid (described below). Mixtures of silver salts of aliphatic carboxylic acids are particularly useful where the mixture includes at least silver behenate.

Useful silver carboxylates include silver salts of long-chain aliphatic carboxylic acids. The aliphatic carboxylic acids generally have aliphatic chains that contain 10 to 30, and preferably 15 to 28, carbon atoms. Examples of such preferred silver salts include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. For example, at least silver behenate can be used alone or in mixtures with other silver carboxylates.

Silver salts other than the silver carboxylates described above can be used also. Such silver salts include silver salts of aliphatic carboxylic acids containing a thioether group as described in U.S. Pat. No. 3,330,663 (Weyde et al.), soluble silver carboxylates comprising hydrocarbon chains incorporating ether or thioether linkages or sterically hindered substitution in the α- (on a hydrocarbon group) or ortho- (on an phenyl group) position as described in U.S. Pat. No. 5,491,059 (Whitcomb), silver salts of dicarboxylic acids, silver salts of sulfonates as described in U.S. Pat. No. 4,504,575 (Lee), silver salts of sulfosuccinates as described in EP 0 227 141A1 (Leenders et al.), silver salts of aryl carboxylic acids (such as silver benzoate), silver salts of acetylenes as described, for example in U.S. Pat. No. 4,761,361 (Ozaki et al.) and U.S. Pat. No. 4,775,613 (Hirai et al.), and silver salts of heterocyclic compounds containing mercapto or thione groups and derivatives as described in U.S. Pat. No. 4,123,274 (Knight et al.) and U.S. Pat. No. 3,785,830 (Sullivan et al.).

It is also convenient to use silver half soaps such as an equimolar blend of silver carboxylate and carboxylic acid that analyzes for about 14.5% by weight solids of silver in the blend and that is prepared by precipitation from an aqueous solution of an ammonium or an alkali metal salt of a commercially available fatty carboxylic acid, or by addition of the free fatty acid to the silver soap.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.) and the references cited above.

Sources of non-photosensitive reducible silver ions can also be core-shell silver salts as described in U.S. Pat. No. 6,355,408 (Whitcomb et al.), silver dimer compounds that comprise two different silver salts as described in U.S. Pat. No. 6,472,131 (Whitcomb), or the silver core-shell compounds comprising a primary core comprising one or more photosensitive silver halides, or one or more non-photosensitive inorganic metal salts or non-silver containing organic salts, and a shell at least partially covering the primary core, wherein the shell comprises one or more non-photosensitive silver salts, each of which silver salts comprises a organic silver coordinating ligand, as described in U.S. Pat. No. 6,803,177 (Bokhonov et al.).

Organic silver salts that are particularly useful in organic solvent-based thermographic and photothermographic materials include silver benzotriazolates, silver sulfonates, silver sulfosuccinates, and silver acetylides.

Organic silver salts that are useful in aqueous based thermographic and photothermographic materials include silver salts of compounds containing an imino group. Examples of these compounds include, but are not limited to, silver salts of benzotriazole and substituted derivatives thereof (for example, silver methylbenzotriazole and silver 5-chlorobenzotriazole), silver salts of 1,2,4-triazoles or 1-H-tetrazoles such as phenylmercaptotetrazole as described in U.S. Pat. No. 4,220,709 (deMauriac), and silver salts of imidazoles and imidazole derivatives as described in U.S. Pat. No. 4,260,677 (Winslow et al.). Useful silver salts of this type are the silver salts of benzotriazole and substituted derivatives thereof. For example, a silver salt of a benzotriazole can be used in aqueous-based thermographic and photothermographic formulations.

Useful nitrogen-containing organic silver salts and methods of preparing them are described in U.S. Pat. No. 6,977,139 (Hasberg et al.). Such silver salts (particularly the silver benzotriazoles) are rod-like in shape and have an average aspect ratio of at least 3:1 and a width index for particle diameter of 1.25 or less. Silver salt particle length is generally less than 1 μm. Also useful are silver salt-toner co-precipitated nano-crystals that comprise a silver salt of a nitrogen-containing heterocyclic compound containing an imino group, and a silver salt comprising a silver salt of a mercaptotriazole, as described, for example, in U.S. Pat. No. 7,008,748 (Hasberg et al.).

The one or more non-photosensitive sources of reducible silver ions are generally present in an amount of from about 5% to about 70%, and typically from about 10% to about 50%, based on the total dry weight of the emulsion layers. Alternatively stated, the amount of the sources of reducible silver ions is generally from about 0.002 to about 0.2 mol/m² of the dry photothermographic material (typically from about 0.01 to about 0.05 mol/m²).

The total amount of silver (from all silver sources) in the photothermographic materials is generally at least 0.002 mol/m², typically from about 0.01 to about 0.05 mol/m², or from about 0.01 to about 0.02 mol/m². In other aspects, it is desirable to use total silver [from both silver halide (when present) and reducible silver salts] at a coating weight generally of less than 2.6 g/m², typically at least 1 but less than 2.0 g/m², or equal to or less than 1.9 g/m².

### Reducing Agent

The reducing agent composition comprising a reducing agent for the source of reducible silver ions comprises at least one trisphenol reducing agent represented by the following Structure (I):

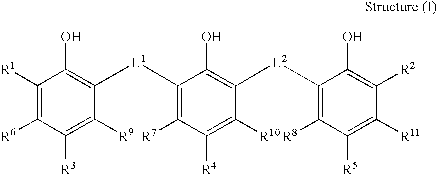

wherein L¹, L², and L³ are independently sulfur or a mono-substituted or unsubstituted methylene groups, R¹ and R² are independently primary or secondary substituted or unsubstituted alkyl groups having 1 to 12 carbon atoms that can be linear, branched or cyclic (such as methyl, ethyl, n-propyl, iso-propyl, iso-butyl, cyclohexyl, benzyl, 4-methylcyclohexyl, norbornyl, or isobornyl),

R³, R⁴, and R⁵ are independently substituted or unsubstituted alkyl groups having 1 to 12 carbon atoms (such as methyl, ethyl, n-propyl, iso-propyl, iso-butyl, tert-butyl, cyclohexyl, benzyl, 4-methylcyclohexyl, norbornyl, or isobornyl), substituted or unsubstituted alkoxy groups having 1 to 12 carbon atoms (such as methoxy, ethoxy, propoxy, iso-propoxy, or n-butoxy), or halo groups (such as chloro or bromo), and

R⁶, R⁷, R⁸, R⁹, R¹⁰, and R¹¹ are independently hydrogen or any substituent that is substitutable on a benzene ring.

In some embodiments, L¹ and L² are independently methylene groups or mono-substituted methylene groups (for example, a mono-substituted methylene group substituted with one alkyl group, aryl group, cycloalkyl group, or heterocyclic group),

R¹ and R² are independently substituted or unsubstituted primary or secondary alkyl groups having 1 to 8 carbon atoms,

R³, R⁴, and R⁵ are independently substituted or unsubstituted alkyl groups having 1 to 6 carbon atoms, and

R⁶, R⁷, R⁸, R⁹, R¹⁰, and R¹¹ are independently hydrogen, or substituted or unsubstituted methyl, ethyl, or methoxy groups, or chloro groups.

In still other embodiments, L¹ and L² are unsubstituted methylene groups,

R¹ and R² are the same substituted or unsubstituted primary or secondary alkyl groups having 1 to 6 carbon atoms,

R³, R⁴, and R⁵ are the same substituted or unsubstituted methyl or ethyl groups, and

R⁶, R⁷, R⁸, R⁹, R¹⁰, and R¹¹ are independently hydrogen or unsubstituted methyl groups.

Compounds (I-1) to (I-18) in TABLE I are representative of the trisphenol reducing agents represented by Structure (I) (in which R⁶, R⁷, R⁸, R⁹, R¹⁰, and R¹¹ are each hydrogen) that are useful in the present invention. Of these listed compounds, Compounds (I-2) and (I-3) of TABLE I are particularly useful.

TABLE I

| Com- | | | | |
|---|---|---|---|---|
| pound | R₁, R₂ | R₃, R₅ | R₄ | L¹, L² |
| I-1 | CH₃ | t-C₄H₉ | CH₃ | CH₂ |
| I-2 | CH₃ | CH₃ | CH₃ | CH₂ |
| I-3 | Cyclo- | CH₃ | CH₃ | CH₂ |
| | hexyl | | | |
| I-4 | Isobornyl | CH₃ | CH₃ | CH₂ |
| I-5 | CH₃ | CH₃ | CH₃ | CH(C₃H₇) |
| I-6 | C₂H₅ | CH₃ | CH₃ | CH₂ |
| I-7 | CH₃ | C₂H₅ | CH₃ | CH₂ |
| I-8 | CH₃ | CH₃ | t-C₄H₉ | CH₂ |
| I-9 | CH₃ | CH₃ | C₂H₅ | CH₂ |
| I-10 | CH₃ | CH₃ | OCH₃ | CH₂ |
| I-11 | CH₃ | CH₃ | Cl | CH₂ |
| I-12 | Norbornyl | CH₃ | CH₃ | CH₂ |
| I-13 | CH₃ | CH₃ | CH₃ | CH(CH₂CH₂C₆H₅) |
| I-14 | i-(C₃H₇) | CH₃ | CH₃ | CH₂ |
| I-15 | Cyclo- | CH₃ | CH₃ | CH₂ |
| | pentyl | | | |
| I-16 | CH₃ | CH₂CH₂OH | CH₃ | CH₂ |
| I-17 | CH₃ | CH₃ | CH₃ | CH(CH₂CH₂CH₂OH) |
| I-18 | CH₃ | CH₃ | Cyclohexyl | CH₂ |

The various trisphenols represented by Structure (I) can be obtained from a number of commercial sources, including Aldrich Chemical Company (Milwaukee, Wis.), or they can be prepared using known synthetic methods, for example, the procedures described in D. J. Beaver et al., J. Amer Chem. Soc., 1953, 75, 5579-81.

The trisphenol reducing agents represented by the compounds of Structure (I) generally provide from about 1 to about 45% (dry weight), and typically from about 1 to about 20%, of the emulsion layer in which it is located. In multilayer constructions, if the reducing agent(s) is added to a layer other than an emulsion layer, slightly higher proportions, of from about 2 to 55 weight % may be more desirable. Thus, the total range for the total amount of phenolic reducing agents can be from about 1 to about 55% (dry weight). Also, these phenolic reducing agents are generally present in an amount of at least 0.05 and up to and including about 0.5 mol/mol of total silver in the photothermographic material, or at least 0.05 mmol/m², and typically in an amount of from about 0.1 to about 0.4 mol/mol of total silver, or from about 1 to about 5 mmol/m². Other additional reducing agents (described below) that may be present could contribute additional amounts of overall reducing agents to the imaging chemistry. However, the trisphenols of Structure (I) are the “predominant” reducing agents in the photothermographic materials, which means that they generally comprise at least 50 mol % and typically at least 70 mol % of the total reducing agents (developers) in the photothermographic materials.

In some embodiments, a reducing agent of Structure (I) is used in combination with one or more monophenol reducing agents represented by Structure (II) below, or one or more bisphenol reducing agents represented by Structure (III) below, or one or more of both of the monophenol or bisphenol reducing agents. In other embodiments, at least one bisphenol reducing agent is present.

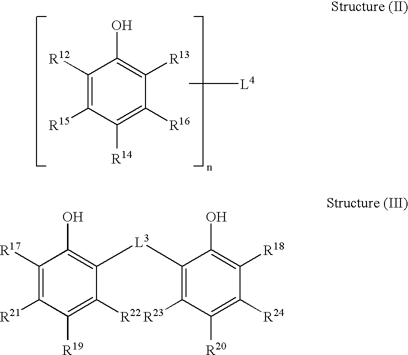

wherein L³ is sulfur or a mono-substituted or unsubstituted methylene group,

R¹⁹ and R²⁰ are independently substituted or unsubstituted alkyl groups having 1 to 12 carbon atoms (such as methyl, ethyl, n-propyl, iso-propyl, iso-butyl, tert-butyl, cyclohexyl, benzyl, 4-methylcyclohexyl, norbornyl, or isobornyl), substituted or unsubstituted alkoxy groups having 1 to 12 carbon atoms (such as methoxy, ethoxy, propoxy, iso-propoxy, or n-butoxy), or halo groups (such as chloro or bromo),

R²¹, R²², R²¹, and R²⁴ are independently hydrogen or any substituent that is substitutable on a benzene ring,

R¹² and R¹³ are independently substituted or unsubstituted alkyl groups having 1 to 12 carbon atoms exclusive of 2-hydroxyphenylmethyl group, (such as methyl, ethyl, n-propyl, iso-propyl, iso-butyl, tert-butyl, 1-methylcyclohexyl, cyclohexyl, benzyl, tert-pentyl, norbornyl, or isobornyl), substituted or unsubstituted alkoxy groups having 1 to 12 carbon atoms (as defined above), halo groups (such as chloro or bromo), or hydrogen, such that both R¹² and R¹³ are not both simultaneously hydrogen,

R¹⁴, R¹⁵, and R are independently hydrogen, or any substituent that is substitutable on a benzene ring,

R¹⁷ and R¹⁸ are independently substituted or unsubstituted alkyl groups having 1 to 12 carbon atoms (as defined above for R¹² and R¹³),

n is an integer of 1 or greater, and

when n is 2 or greater, L⁴ is a single bond or a linking group that is attached to any of R¹², R¹³, R¹⁴, R¹⁵, or R¹⁶.

In some embodiments, L³ is a methylene group or mono-substituted methylene group (for example, a mono-substituted methylene group substituted with one alkyl group, aryl group, cycloalkyl group, or heterocyclic group),

R¹⁹ and R²⁰ are independently substituted or unsubstituted alkyl groups having 1 to 6 carbon atoms,

R¹⁵, R¹⁶, R²¹, R²², R²³, and R²⁴ are independently hydrogen, or substituted or unsubstituted methyl, ethyl, or methoxy groups, or chloro groups,

R¹², R¹³, R¹⁷, and R¹⁸ are independently substituted or unsubstituted primary, secondary, or tertiary alkyl groups having 1 to 7 carbon atoms, and

R¹⁴ is a substituted or unsubstituted alkyl group having 1 to 4 carbon atoms, and

n is 1 to 4, provided that when n is 2 or greater, L⁴ is a single bond or a linking group that is attached to any of R¹⁴, R¹⁵, R¹⁶.

In some other embodiments, L³ is an unsubstituted methylene group,

R¹⁹ and R²⁰ are the same substituted or unsubstituted methyl or ethyl groups,

R¹⁵, R¹⁶, R²¹, R²², R²³, and R²⁴ are independently hydrogen or unsubstituted methyl groups,

R¹², R¹³, R¹⁷, and R¹⁸ are independently substituted or unsubstituted secondary or tertiary alkyl groups having 3 to 7 carbon atoms, and

R¹⁴ is a substituted or unsubstituted alkyl group having 1 to 4 carbon atoms, or in some embodiments, R¹⁴ is a group represented by —CH₂CH₂(C═O)— and L⁴ is a group represented by —(OCH₂)₄C—, particularly when n is 4.

One skilled in the art would understand that when n is 1, L⁴ is not present.

Compounds (II-1) to (II-17) in TABLE II below are representative of the monophenol reducing agents represented by Structure (II) may be used in the present invention. Compounds (III-1) to (III-18) in TABLE III below are representative of the bisphenol reducing agents represented by Structure (III) (in which R²¹, R²², R²³, and R²⁴ are each hydrogen) that may be used in the present invention. Of these listed compounds, Compounds (I-2) and (I-3) of TABLE I, Compounds (II-8) and (II-17) of TABLE II, and Compounds (III-1) and (III-4) of TABLE III, are particularly useful.

Useful combinations of reducing agents include combinations of either or both of Compounds (I-2) and (I-3) of TABLE I with either or both of Compounds (II-8) and (II-17) of TABLE II. Other useful combinations include combinations of either or both of Compounds I-2 and I-3 of TABLE I with either or both of Compounds (III-1) and (III-4) of TABLE III. Still other useful combinations include combinations of either or both of Compounds (I-2) and (I-3) of TABLE I with either or both of Compounds (II-8) and (II-17) of TABLE II and either or both of Compounds (III-1) and (III-4) of TABLE III.

TABLE II

| Compound | R¹², R¹³ | R¹⁴ | R¹⁵, R¹⁶ | L⁴ | n |
|---|---|---|---|---|---|
| II-1 | t-C₄H₉ | CH₃ | H | Nil | 1 |
| II-2 | t-C₄H₉ | t-C₄H₉ | H | Nil | 1 |
| II-3 | t-C₄H₉, CH₃ | CH₃ | H | Nil | 1 |
| II-4 | t-C₄H₉ | COOCH₃ | H | Nil | 1 |
| II-5 | t-C₄H₉ | COOC₁₈H₃₇ | H | Nil | 1 |
| II-6 | t-C₅H₁₁ | CH₃ | H | Nil | 1 |
| II-7 | t-C₄H₉ | C₉H₁₉ | H | Nil | 1 |
| II-8 | t-C₄H₉ | CH₂CH₂(C═O)— | H | (—OCH₂)₄C | 4 |
| II-9 | t-C₄H₉ | CH₂CH₂(C═O)— | H | 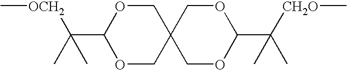 | 2 |
| II-10 | t-C₄H₉ | CH₂— | H | single bond | 2 |
| II-11 | t-C₄H₉ | CH₂CH₂(C═O)— | H | —OCH₂CH₂O— | 2 |
| II-11 | t-C₄H₉ | CH₂CH₂(C═O)— | H | (—OCH₂)₃CCH₂CH₃ | 3 |
| II-12 | t-C₄H₉ | CH₂CH₂O— | H | 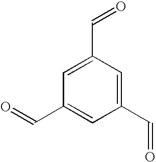 | 3 |
| II-13 | t-C₄H₉ | CH₂CH₂(C═O)— | H | 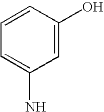 | 2 |
| II-14 | t-C₄H₉ | CH₂CH₂— | H | single bond | 2 |
| II-15 | t-C₄H₉ | CH₂— | H | 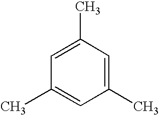 | 3 |
| II-16 | t-C₄H₉ | CH₂CH₂(C═O)— | H | OCH₂CH₂—S—CH₂CH₂O | 2 |
| II-17 | t-C₄H₉, CH₃ | CH₃ | CH₂—, H | 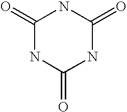 | 3 |

TABLE III

| Com- | | | |
|---|---|---|---|
| pound | R₁₇, R₁₈ | R₁₉, R₂₀ | L³ |
| III-1 | t-C₄H₉ | CH₃ | CH₂ |
| III-2 | CH₃ | CH₃ | CH(CH₂CH₂C₆H₅) |
| III-3 | CH₃ | CH₃ | CH(Cyclohexyl) |
| III-4 | 1-CH₃(Cyclo- | CH₃ | CH₂ |
| | hexyl) | | |
| III-5 | Isobornyl | CH₃ | CH₂ |
| III-6 | Norbornyl | CH₃ | CH₂ |
| III-7 | CH₃ | CH₃ | CH(i-C₃H₇) |
| III-8 | CH₃ | C₂H₅ | CH₂ |
| III-9 | t-C₄H₉ | CH₃ | S |
| III-10 | t-C₅H₁₁ | CH₃ | CH₂ |
| III-11 | Cyclohexyl | CH₃ | CH₂ |
| III-12 | t-C₄H₉ | CH₂CH₂OH | CH₂ |
| III-13 | t-C₄H₉ | CH₃ | CH(CH₂CH₂CH₂OH) |
| III-14 | t-C₄H₉ | CH₃ | CH(CH₂CH₂CH₃) |
| III-15 | t-C₄H₉ | t-C₄H₉ | CHCH₃ |
| III-16 | CH₃ | CH₂OCH₃ | CH(CH₂CH₂CH₃) |
| III-17 | CH₃ | CH₃ | CH₂(C₃H₇) |
| III-18 | CH₃ | CH₃ | CH(CH₂CH(CH₃)CH₂C(CH₃)₃) |

The various phenols represented by Structures (II) and (III) can be obtained from a number of commercial sources, including Aldrich Chemical Company (Milwaukee, Wis.), or they can be prepared using known synthetic methods.

Still other optional reducing agents include the bisphenol-phosphorous compounds described in U.S. Pat. No. 6,514,684 (Suzuki et al), the bisphenol, aromatic carboxylic acid, hydrogen bonding compound mixture described in U.S. Pat. No. 6,787,298 (Yoshioka), and the compounds that can be one-electron oxidized to provide a one-electron oxidation product that releases one or more electrons as described in U.S. Patent Application Publication 2005/0214702 (Ohzeki). Still other useful reducing agents are described in U.S. Pat. No. 3,074,809 (Owen), U.S. Pat. No. 3,080,254 (Grant, Jr.), U.S. Pat. No. 3,094,417 (Workman), U.S. Pat. No. 3,887,417 (Klein et al.), U.S. Pat. No. 4,030,931 (Noguchi et al.), and U.S. Pat. No. 5,981,151 (Leenders et al.).

Additional reducing agents that may be used along with the trisphenols described above, include amidoximes, azines, ascorbic acid, a reductone, piperidinohexose reductone, hydroxamic acids, a combination of azines and sulfonamidophenols, α-cyanophenylacetic acid derivatives, reductones, indane-1,3-diones, chromans, 1,4-dihydropyridines, and 3-pyrazolidones.

The reducing agent composition used in this invention is generally “free” of what are known as hydrazides or substituted hydrazines that are often used as nucleating agents. By “free”, we mean that such compounds are not purposely added to the photothermographic materials.

### Co-Developers

The photothermographic materials contain one or more substituted olefinic co-developers. These compounds are organic compounds that by themselves do not act as effective reducing agents (or developers) for the non-photosensitive silver salt, but when used in combination with a trisphenol reducing agent provide, upon development, increased silver development.

These substituted olefinic co-developers can be represented by the following Structure (IV):

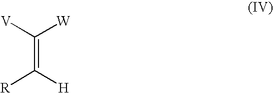

wherein V and W are independently aromatic groups or electron withdrawing groups, provided that at least one of V and W is an electron withdrawing group, or V and W can represent the atoms necessary to form a ring containing an electron withdrawing group. By “electron withdrawing group”, we mean its Hammett σₚ value as defined by the Hammett Equation log K/K^{o}=σₚρ wherein K^{o} is the acid dissociation constant of the reference in aqueous solution at 25° C., K is the corresponding constant for the para-substituted acid, and ρ is defined as 1.0 for the dissociation of para-substituted benzoic acids. A positive Hammett sigma value indicates that the substituent (or group) is electron withdrawing.

Generally useful electron withdrawing groups are those that have a Hammett σₚ value greater than 0.2 and typically greater than 0.35. Representative electron withdrawing groups include, but are not limited to, cyano, halogens, formyl, alkoxycarbonyl groups (or carboalkoxy groups), metaloxycarbonyl groups, hydroxycarbonyl groups, nitro, acetyl, perfluoroalkyl groups, alkylsulfonyl groups, arylsulfonyl groups as well as other groups listed in Lange's Handbook of Chemistry, 14^{th} Ed., McGraw-Hill, 1992, Chapter 9, pp. 2-7. Cyano is the useful electron withdrawing group in many embodiments of the invention.

The “aromatic groups” for V and W include any aromatic single or multiple ring group, with or without substitution, including but not limited to, substituted or unsubstituted phenyl, naphthyl, tolyl, pyridyl, furyl, and thienyl groups. Phenyl groups are useful groups, and halogen-substituted and haloalkyl (such as trifluoromethyl)-substituted phenyl groups are also useful especially as V groups when W is cyano. “Haloalkyl” includes alkyl groups as defined herein that have one or more of the same halo groups as substituents. Halo-saturated alkyl groups (all hydrogens replaced by halo atoms) may be useful phenyl substituents.

It is also useful that V is a carboalkoxy group having 2 to 13 carbon atoms (typically 2 to 9 carbon atoms), a carboxamido group having 2 to 13 carbon atoms (typically 2 to 7 carbon atoms), or a substituted or unsubstituted aryl group having 6 to 10 carbon atoms, and W is a cyano group.

In Structure (IV), R is a halo (such as fluoro, chloro, bromo, and iodo), hydroxy, thiohydrocarbyl (that is any group having the connecting —S—C— group such as thioalkyl, thioaryl, thiol, thioalkenyl, and thioacyl groups), oxyhydrocarbyl (that is any group having the connecting —O—C— group such as alkoxy, aryloxy, acyloxy, alkenyloxy, and similar groups), HET, —O⁻A⁺, or —S⁻A⁺, group. The acyloxy groups include those with substituted or unsubstituted aryl (or aromatic) groups as well as those with substituted or unsubstituted alkyl groups, that is the acyloxy groups can be represented by the formula (aryl or alkyl)-(C═O)O—.

In some embodiments, R is a hydroxy, alkoxy group of 1 to 24 carbon atoms, aryloxy group of 1 to 24 carbon atoms, —O⁻A^{|}, or (alkyl)-(C═O)O— group wherein the alkyl group in the acyloxy group has 1 to 24 carbon atoms and can be linear, branched, or cyclic. In still other embodiments, R is a hydroxy, —O⁻A⁺, (primary alkyl)-(C═O)O— group in which the primary alkyl group in the acyloxy group has 1 to 24 carbon atoms, or (secondary alkyl)-(C═O)O— group in which the alkyl group in the acyloxy group has 1 to 24 carbon atoms. By “primary alkyl”, we mean an alkyl group in which the carbon atom directly attached to the —(C═O)O— group is part of an unsubstituted methylene group. By “secondary alkyl”, we mean an alkyl group in which the carbon atom directly attached to the —(C═O)O— group is part of an unsubstituted methine group.

HET represents a 5- or 6-membered heteroaromatic group attached through a non-quaternary nitrogen atom. Generally, these groups are composed of only carbon and 1 to 4 nitrogen atoms, and typically, the groups contain 2 or 3 nitrogen atoms. For example, the ring can comprise 5 ring atoms including, but is not limited to, a diazole, triazole, pyrrole, or tetrazole ring, with or without exocyclic substitution (that is inclusive of the formation of fused benzene rings forming benzodiazoles, benzotriazoles, benzotetrazoles, benzopyrroles, and similar rings, with or without additional substitution). Representative HET groups are shown as part of HET-01 and HET-02 in Col. 10 of U.S. Pat. No. 5,635,339 (noted above) which compounds are incorporated herein by reference.

A⁺ is a metal, quaternary ammonium (including imidazolium), quaternary phosphonium cation, or ternary sulfonium cation. Typically, A^{|} is an alkali metal, quaternary ammonium, ternary sulfonium, or quaternary phosphonium cation, or a complex cation of an alkali metal cation with a CROWN ETHER. For example, A⁺ can be a lithium, sodium, or potassium cation, quaternary ammonium cation having 16 to 60 carbon atoms, quaternary phosphonium cation having 16 to 60 carbon atoms, or ternary sulfonium cation having 3 to 26 carbon atoms, or the complex cation of lithium, sodium, or potassium ions with a CROWN ETHER. Examples of useful quaternary ammonium and phosphonium salts, and of ternary sulfonium salts of olefinic co-developers are described in Japan Kokai 2005-338660 (Kenji), 2005-208476 (Keiko and Norio), 2003-114497 (Hiroyuki and Norio), and 2003-121964 (Hideaki and Hiroyuki).

CROWN ETHER refers to heterocyclic compounds that are, in their simplest form, substituted or unsubstituted cyclic oligomers of ethylene oxide. The essential repeating unit of any simple crown ether is ethyleneoxy, that is, —CH₂CH₂O—, which repeats twice in dioxane and six times in 18-crown-6. The nine-membered ring 1,4,7-trioxonane (9-crown-3) is often called a crown and can interact with cations. Macrocycles of the (—CH₂CH₂O—)ₙ type in which n≧4 are generally referred to as crown ethers rather than by their systematic names. This is because the molecules formed when this special group of heterocycles binds to cations resemble a crown sitting on a head in structure. The crown ethers are notable for their ability to strongly solvate cations. The oxygen atoms are ideally situated to coordinate with a cation in the interior of the ring, whereas the exterior of the ring is hydrophobic. The result is that the complexed cation is soluble in nonpolar solvents. The size of the interior of the crown ether determines the size of the cation it can solvate. Therefore, 18-crown-6 has high affinity for potassium cation, 15-crown-5 for sodium cation, and 12-crown-4 for lithium cation.

Representative, non-limiting CROWN ETHER compounds include Compounds (CR-1) to (CR-18) shown below.

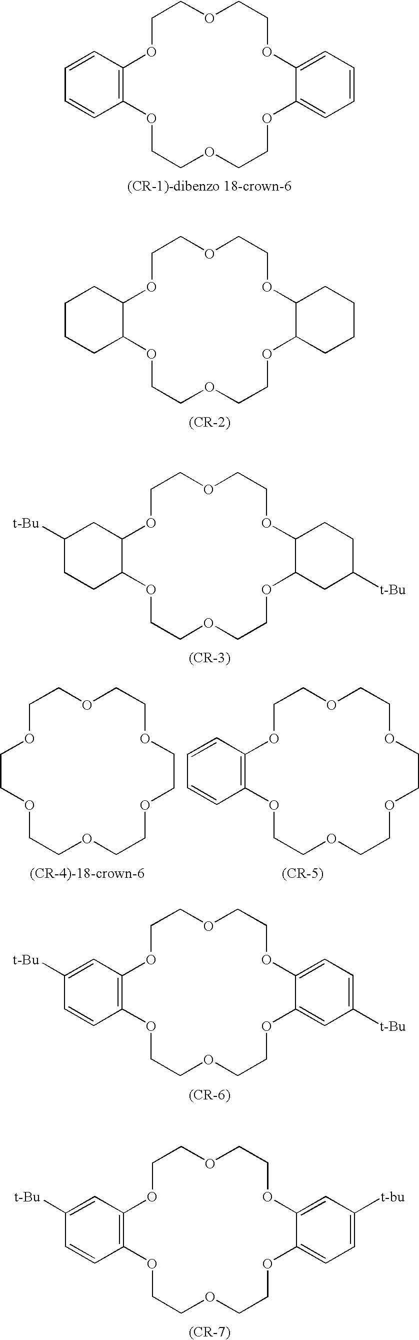

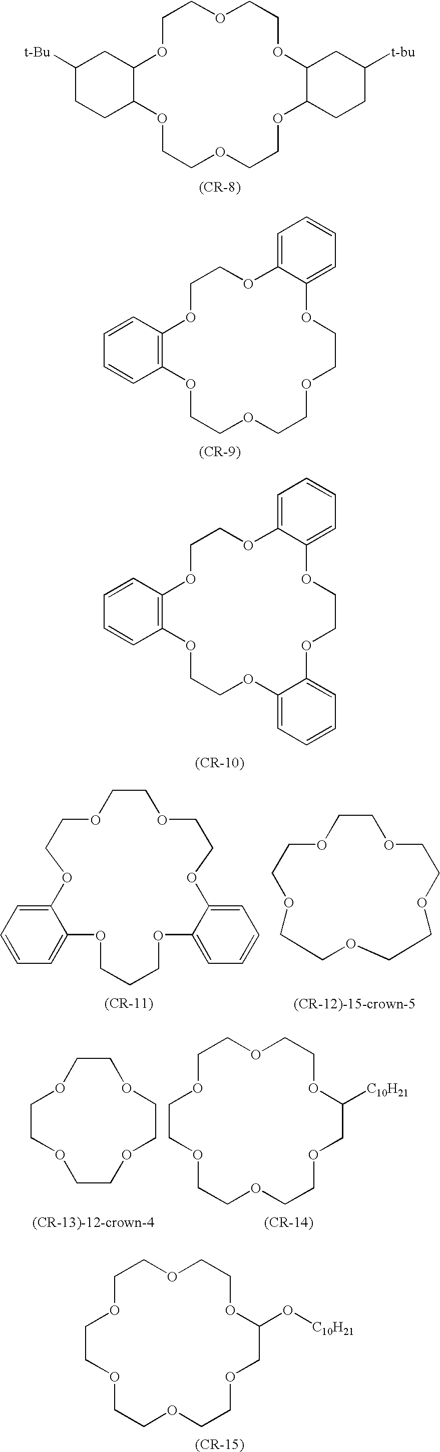

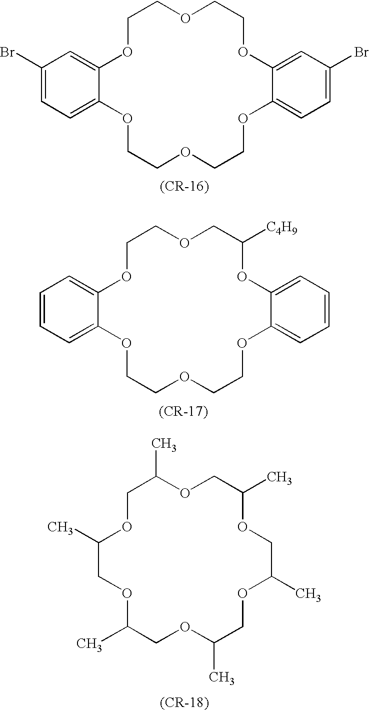

Further details about such compounds are provided in U.S. Pat. Nos. 5,545,515 and 5,635,339, both noted above, and in copending and commonly assigned U.S. Ser. No. 11/455,415 that was filed Jun. 19, 2006 by Simpson and Sakizadeh, all incorporated herein by reference.

Representative substituted olefinic co-developers useful in this invention include the following compounds, and mixtures thereof:

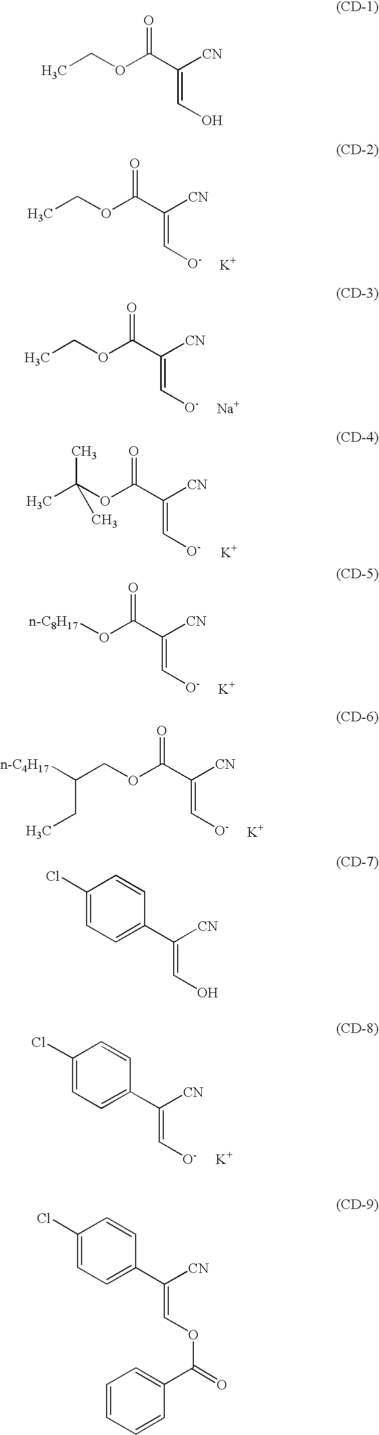

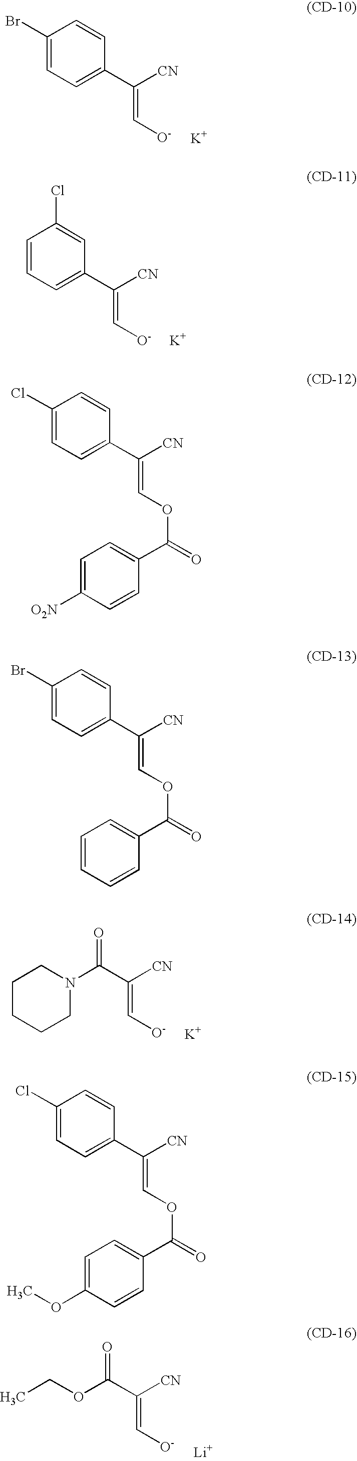

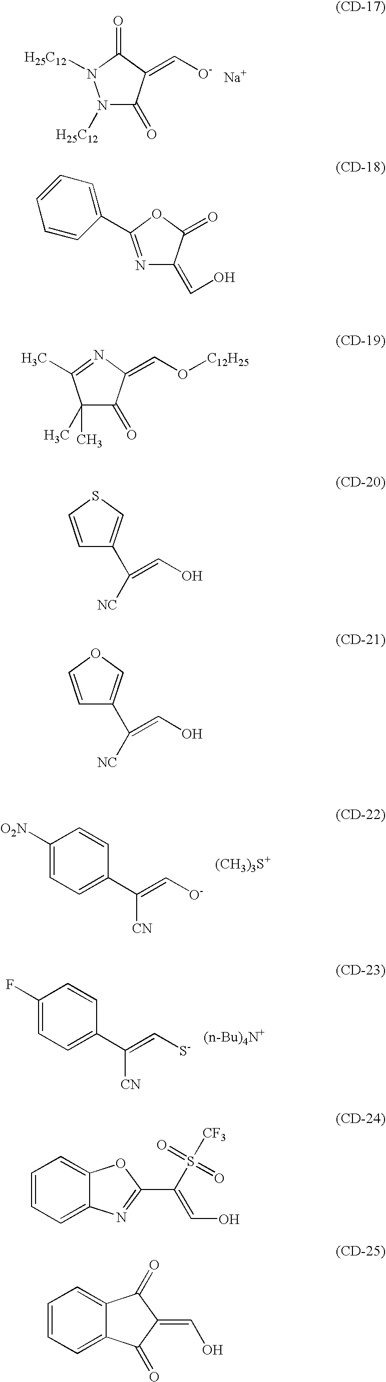

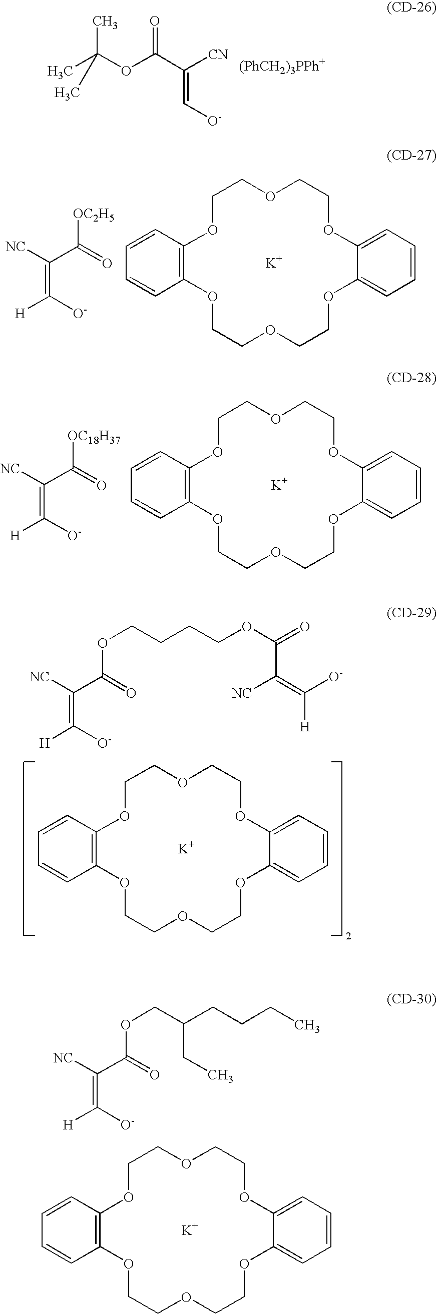

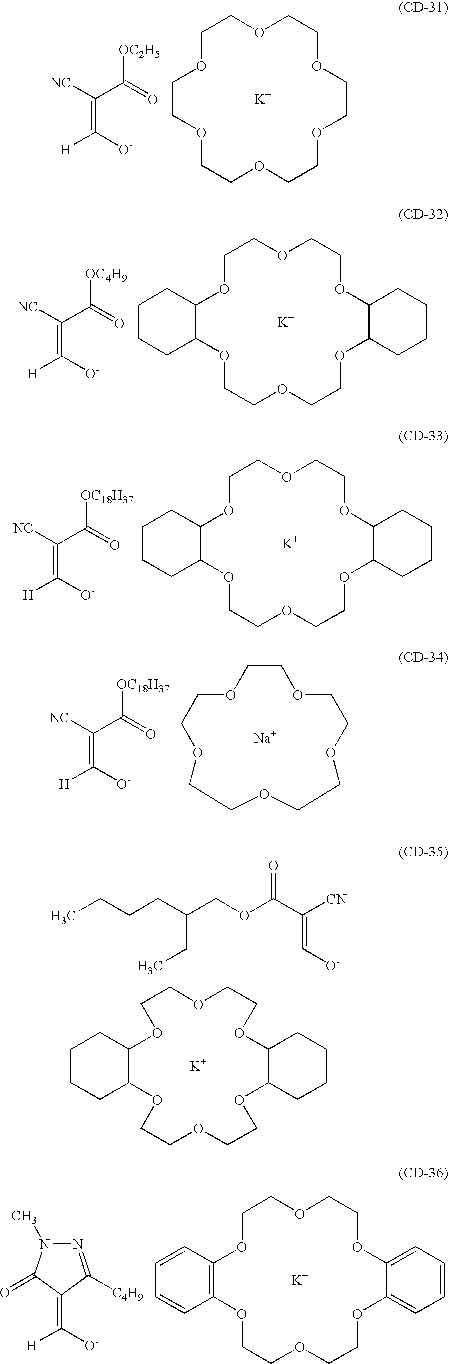

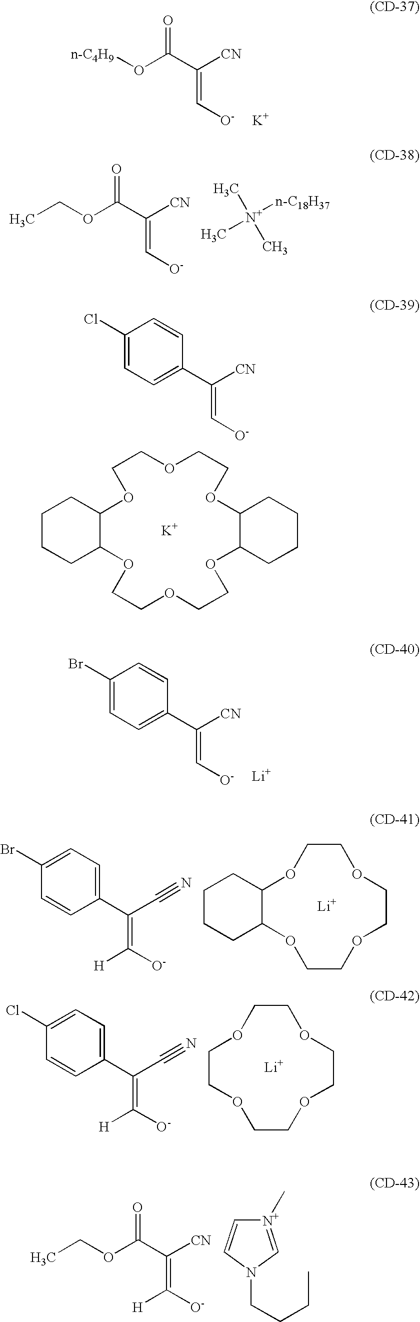

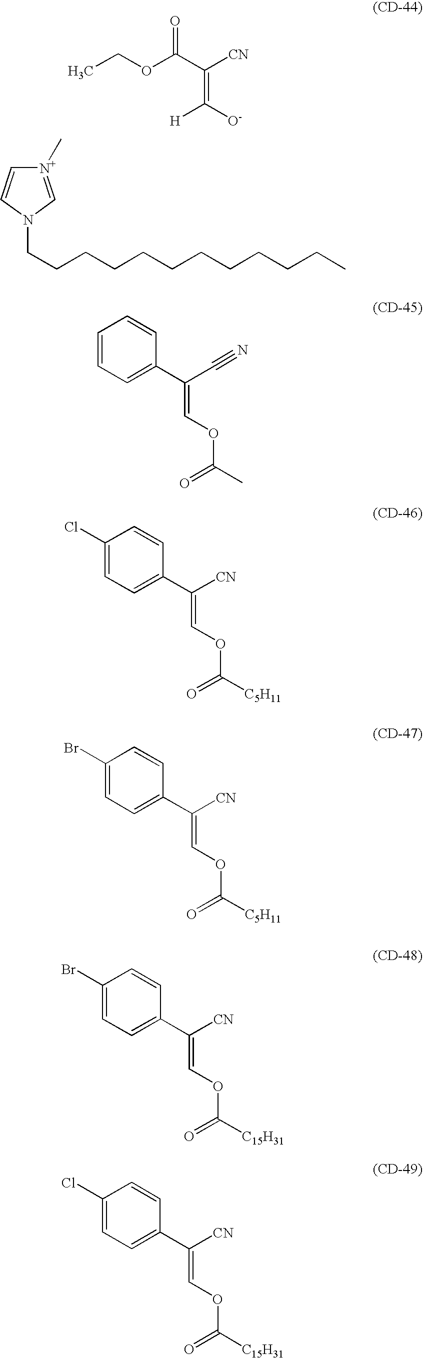

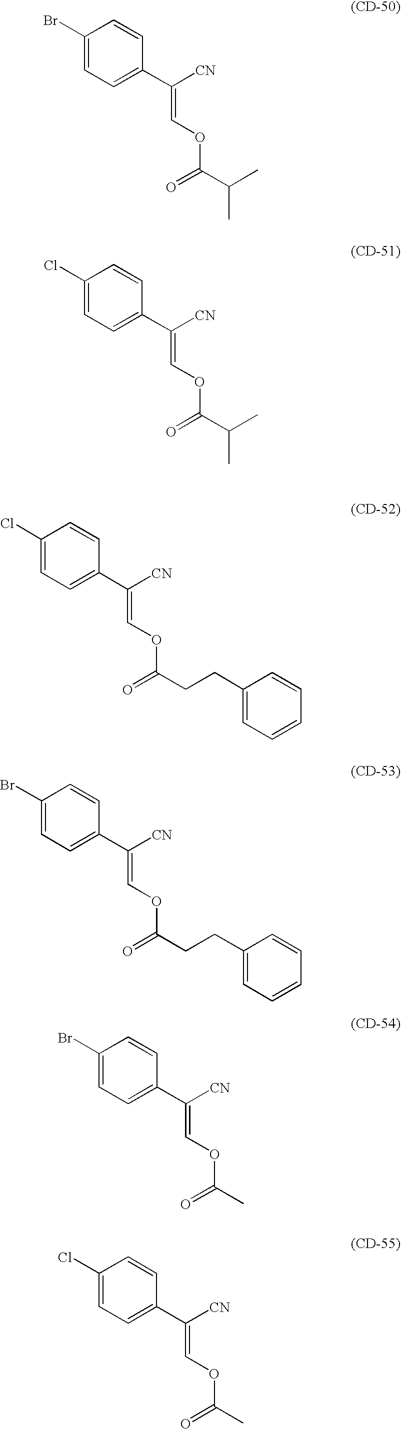

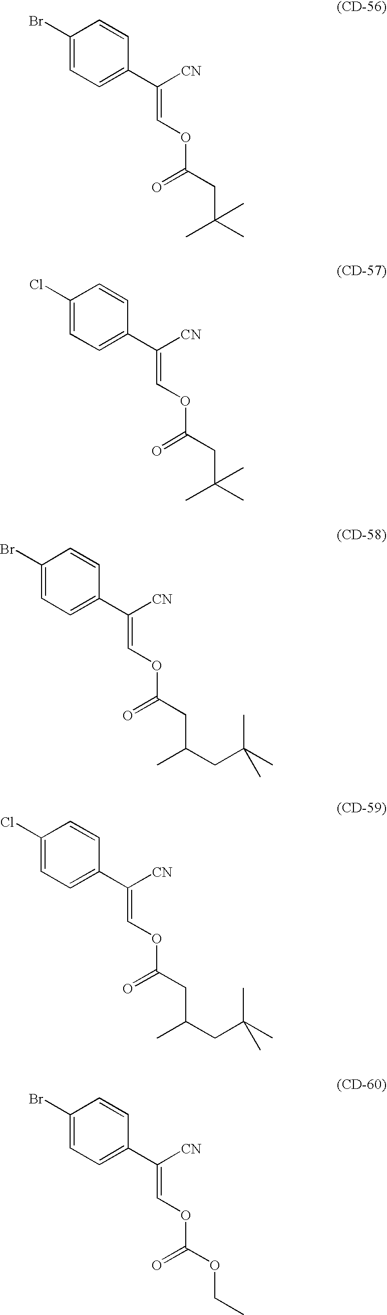

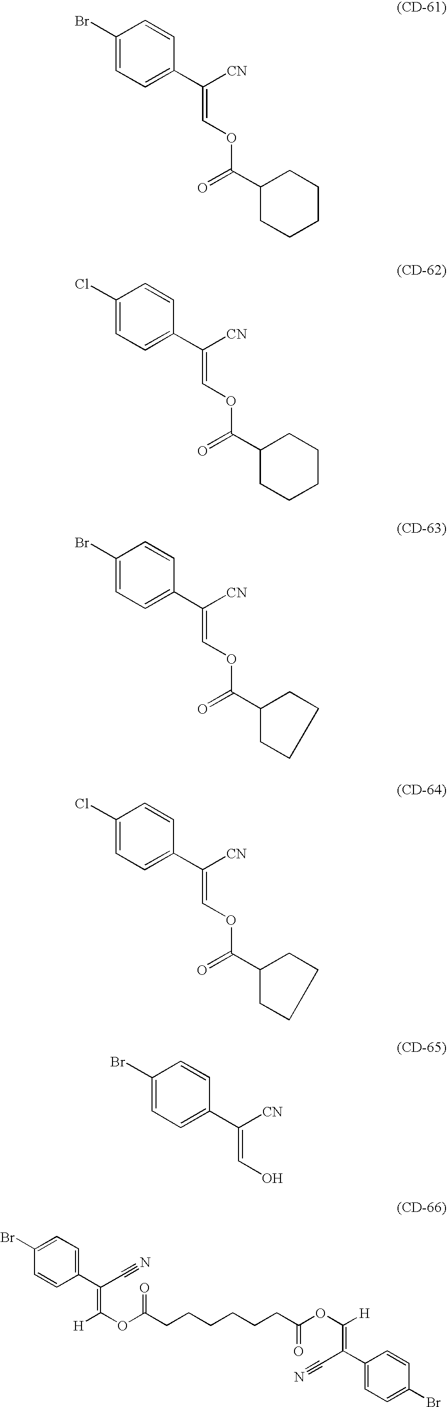

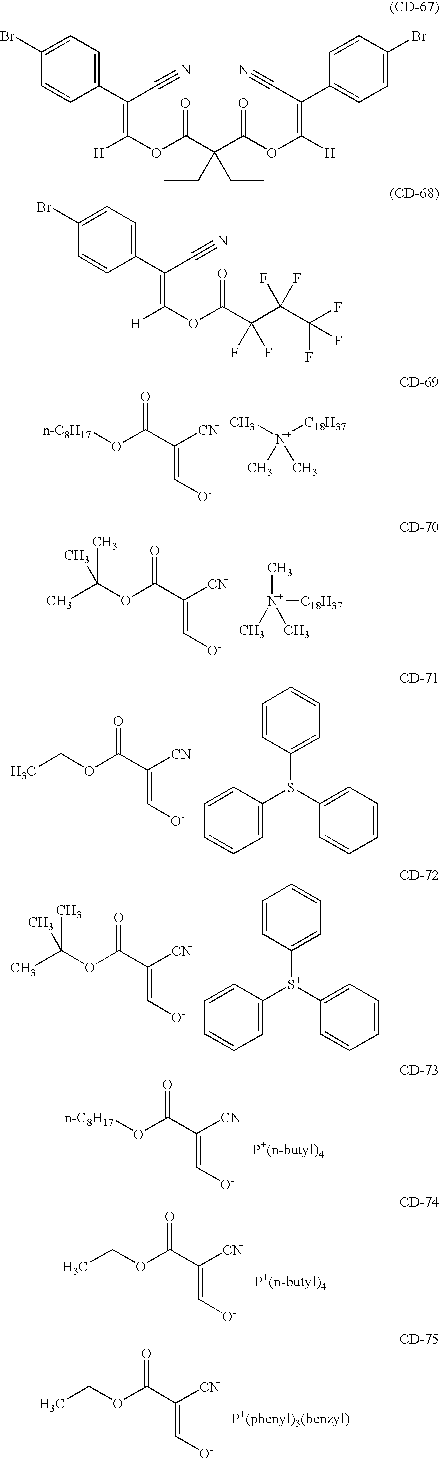

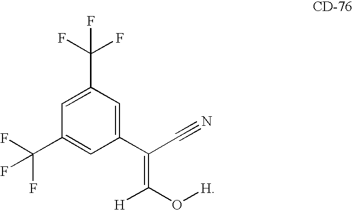

For example, substituted olefinic compounds CD-2, CD-4, CD-7, CD-8, CD-10, CD-13, CD-16, CD-32, CD-35, CD-39, CD-40, CD-46 through CD-51, CD-63, CD-65, and CD-76 are useful and compounds CD-2, CD-7, CD-8, CD-10, CD-39, CD-40, CD-47, CD-48, CD-50, CD-63, and CD-76 are particularly useful.

One or more substituted olefinic co-developers can be added to any layer on the side of the support having a photothermographic emulsion layer as long as they are allowed to come into intimate contact with the emulsion layer during coating, drying, storage, thermal development, or post-processing storage. Thus, one or more co-developers can be added directly to the photothermographic emulsion layer or to one or more overcoat layers above the emulsion layer (for example a topcoat layer, interlayer, or barrier layer) and/or below the emulsion layer (such as to a primer layer, subbing layer, or carrier layer). Typically, one or more substituted olefinic co-developers are added directly to the emulsion layer, or to an overcoat layer and allowed to diffuse into the emulsion layer.

Where the photothermographic material has one or more photothermographic layers on both sides of the support, one or more of the same or different substituted olefinic co-developers can be used on one or both sides of the support.

Generally, one or more substituted olefinic co-developers are present in a total amount of at least 0.001 mmol/m² in one or more layers on the imaging side of the support (for example, the emulsion layer into which they are incorporated or diffused). Typically, they are present in a total amount of from about 0.005 mmol/m² to about 0.02 mmol/m², or in a total amount of from about 0.5 to about 15 mg/m² in one or more layers on an imaging side of the support. The molar ratio of substituted olefinic co-developer agent to trisphenol reducing agent is generally from about 0.001:1 to about 0.02:1, and typically from about 0.004:1 to about 0.01:1.

Useful substituted olefinic co-developers can be obtained from a number of commercial chemical sources such as Aldrich Chemical Co. or prepared using known starting materials and procedures as described below before the Examples.

### Other Addenda

The photothermographic materials can also contain other additives such as shelf-life stabilizers, antifoggants, toners, development accelerators, acutance dyes, post-processing stabilizers or stabilizer precursors, thermal solvents (also known as melt formers), antistatic or conductive layers, and other image-modifying agents as would be readily apparent to one skilled in the art.

Suitable stabilizers that can be used alone or in combination include thiazolium salts as described in U.S. Pat. No. 2,131,038 (Brooker) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), and the heteroaromatic mercapto compounds or heteroaromatic disulfide compounds described in EP 0 559 228B1 (Philip et al.).

Heteroaromatic mercapto compounds are useful including 2-mercaptobenzimidazole, 2-mercapto-5-methylbenzimidazole, 2-mercaptobenzothiazole and 2-mercaptobenzoxazole, and mixtures thereof. A heteroaromatic mercapto compound is generally present in an emulsion layer in an amount of at least 0.0001 mole (typically from about 0.001 to about 1.0 mole) per mole of total silver in the emulsion layer.

Other useful antifoggants/stabilizers are described in U.S. Pat. No. 6,083,681 (Lynch et al.). Still other antifoggants are hydrobromic acid salts of heterocyclic compounds (such as pyridinium hydrobromide perbromide) as described in U.S. Pat. No. 5,028,523 (Skoug), benzoyl acid compounds as described in U.S. Pat. No. 4,784,939 (Pham), substituted propenenitrile compounds as described in U.S. Pat. No. 5,686,228 (Murray et al.), silyl blocked compounds as described in U.S. Pat. No. 5,358,843 (Sakizadeh et al.), the 1,3-diaryl-substituted urea compounds described copending and commonly assigned U.S. Ser. No. 11/284,928 (filed Nov. 22, 2005 by Hunt and Sakizadeh), and tribromomethylketones as described in EP 0 600 587A1 (Oliff et al.).

Additives useful as stabilizers for improving dark stability and desktop print stability are the various boron compounds described in U.S. Patent Application Publication 2006/0141404 (Philip et al.). The boron compounds can be added in an amount of from about 0.010 to about 0.50 g/m².

Also useful as stabilizers for improving the post-processing print stability of the imaged material to heat during storage (known as “hot-dark print stability”) are arylboronic acid compounds as described in copending and commonly assigned U.S. Ser. No. 11/351,773 (filed on Feb. 10, 2006 by Chen-Ho and Sakizadeh) and sulfonyldiphenols as described in copending and commonly assigned U.S. Ser. No. 11/550,461 (filed Oct. 18, 2006 by Sakizadeh, Chen-Ho, Hunt, and Burleva), both incorporated herein by reference.

The photothermographic materials can also include one or more polyhalogen stabilizers that can be represented by the formula Q-(Y)ₙ—C(Z₁Z₂X) wherein, Q represents an alkyl, aryl (including heteroaryl) or heterocyclic group, Y represents a divalent linking group, n represents 0 or 1, Z₁ and Z₂ each represents a halogen atom, and X represents a hydrogen atom, a halogen atom, or an electron-withdrawing group. Useful compounds of this type are polyhalogen stabilizers wherein Q represents an aryl group, Y represents (C═O) or SO₂, n is 1, and Z₁, Z₂, and X each represent a bromine atom. Examples of such compounds containing —SO₂CBr₃ groups are described in U.S. Pat. No. 3,874,946 (Costa et al.), U.S. Pat. No. 5,369,000 (Sakizadeh et al.), U.S. Pat. No. 5,374,514 (Kirk et al.), U.S. Pat. No. 5,460,938 (Kirk et al.), U.S. Pat. No. 5,464,747 (Sakizadeh et al.) and U.S. Pat. No. 5,594,143 (Kirk et al.). Examples of such compounds include, but are not limited to, 2-tribromomethylsulfonyl-5-methyl-1,3,4-thiadiazole, 2-tribromomethylsulfonylpyridine, 2-tribromomethylsulfonylquinoline, and 2-tribromomethylsulfonylbenzene. The polyhalogen stabilizers can be present in one or more layers in a total amount of from about 0.005 to about 0.01 mol/mol of total silver, and typically from about 0.01 to about 0.05 mol/mol of total silver.

Stabilizer precursor compounds capable of releasing stabilizers upon application of heat during imaging can also be used, as described in U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.). Also useful are the blocked aliphatic thiol compounds described in U.S. Patent Application Publication 2006/0141403 (Ramsden et al.).

In addition, certain substituted sulfonyl derivatives of benzotriazoles may be used as stabilizing compounds as described in U.S. Pat. No. 6,171,767 (Kong et al.).

“Toners” or derivatives thereof that improve the image are desirable components of the photothermographic materials. These compounds, when added to the imaging layer, shift the color of the image from yellowish-orange to brown-black or blue-black. Generally, one or more toners described herein are present in an amount of from about 0.01% to about 10% (more typically from about 0.1% to about 10%), based on the total dry weight of the layer in which the toner is included. Toners may be incorporated in the photothermographic emulsion or in an adjacent non-imaging layer.

Compounds useful as toners are described in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), U.S. Pat. No. 5,599,647 (Defieuw et al.) and GB 1,439,478 (AGFA).

Additional useful toners are substituted and unsubstituted mercaptotriazoles as described in U.S. Pat. No. 3,832,186 (Masuda et al.), U.S. Pat. No. 6,165,704 (Miyake et al.), U.S. Pat. No. 5,149,620 (Simpson et al.), U.S. Pat. No. 6,713,240 (Lynch et al.), and U.S. Pat. No. 6,841,343 (Lynch et al.).

Phthalazine and phthalazine derivatives [such as those described in U.S. Pat. No. 6,146,822 (Asanuma et al.)], phthalazinone, and phthalazinone derivatives are useful toners.

Useful phthalazinone compounds are those having sufficient solubility to completely dissolve in the formulation from which they are coated. Representative phthalazinone compounds include 6,7-dimethoxy-1-(2H)-phthalazinone, 4-(4-pentylphenyl)-1-(2H)-phthalazinone, and 4-(4-cyclohexylphenyl)-1-(2H)-phthalazinone. Mixtures of such phthalazinone compounds can be used if desired.

The addition of development accelerators that increase the rate of image development and allow reduction in silver coating weight is also useful. Suitable development accelerators include phenols, naphthols, and hydrazine-carboxamides. Such compounds are described, for example, in Y. Yoshioka, K. Yamane, T. Ohzeki, Development of Rapid Dry Photothermographic Materials with Water-Base Emulsion Coating Method, AgX 2004: The International Symposium on Silver Halide Technology “At the Forefront of Silver Halide Imaging”, Final Program and Proceedings of IS&T and SPSTJ, Ventura, Calif., Sep. 13-15, 2004, pp. 28-31, Society for Imaging Science and Technology, Springfield, Va., U.S. Pat. No. 6,566,042 (Goto et al.), U.S. Patent Application Publications 2004/234906 (Ohzeki et al.), 2005/048422 (Nakagawa), 2005/118542 (Mori et al.), (Nakagawa), and 2006/0014111 (Goto).

Thermal solvents (or melt formers) can also be used, including combinations of such compounds (for example, a combination of succinimide and dimethylurea). Thermal solvents are compounds which are solids at ambient temperature but which melt at the temperature used for processing. The thermal solvent acts as a solvent for various components of the photothermographic material, it helps to accelerate thermal development and it provides the medium for diffusion of various materials including silver ions and/or complexes and reducing agents. Known thermal solvents are disclosed in U.S. Pat. No. 3,438,776 (Yudelson), U.S. Pat. No. 5,064,753 (noted above) U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender). Thermal solvents are also described in U.S. Published Patent Application 2006/240366 (Chen-Ho et al.).

The photothermographic materials can also include one or more image stabilizing compounds that are usually incorporated in a “backside” layer. Such compounds can include phthalazinone and its derivatives, pyridazine and its derivatives, benzoxazine and benzoxazine derivatives, benzothiazine dione and its derivatives, and quinazoline dione and its derivatives, particularly as described in U.S. Pat. No. 6,599,685 (Kong). Other useful backside image stabilizers include anthracene compounds, coumarin compounds, benzophenone compounds, benzotriazole compounds, naphthalic acid imide compounds, pyrazoline compounds, or compounds described in U.S. Pat. No. 6,465,162 (Kong et al) and GB 1,565,043 (Fuji Photo).

Phosphors are materials that emit infrared, visible, or ultraviolet radiation upon excitation and can be incorporated into the photothermographic materials. Some useful phosphors are sensitive to X-radiation and emit radiation primarily in the ultraviolet, near-ultraviolet, or visible regions of the spectrum (that is, from about 100 to about 700 nm). An intrinsic phosphor is a material that is naturally (that is, intrinsically) phosphorescent. An “activated” phosphor is one composed of a basic material that may or may not be an intrinsic phosphor, to which one or more dopant(s) has been intentionally added. These dopants or activators “activate” the phosphor and cause it to emit ultraviolet or visible radiation. Multiple dopants may be used and thus the phosphor would include both “activators” and “co-activators”.

Any conventional or useful phosphor can be used, singly or in mixtures. For example, useful phosphors are described in numerous references relating to fluorescent intensifying screens as well as U.S. Pat. No. 6,440,649 (Simpson et al.) and U.S. Pat. No. 6,573,033 (Simpson et al.) that are directed to photothermographic materials. Some particularly useful phosphors are primarily “activated” phosphors known as phosphate phosphors and borate phosphors. Examples of these phosphors are rare earth phosphates, yttrium phosphates, strontium phosphates, or strontium fluoroborates (including cerium activated rare earth or yttrium phosphates, or europium activated strontium fluoroborates) as described in U.S. Patent Application Publication 2005/0233269 (Simpson et al.).

The one or more phosphors generally can be present in the photothermographic materials in an amount of at least 0.1 mole per mole, and typically from about 0.5 to about 20 mole, per mole of total silver in the photothermographic material. As noted above, generally, the amount of total silver is at least 0.002 mol/m². While the phosphors can be incorporated into any imaging layer on one or both sides of the support, typically they are in the same layer(s) as the photosensitive silver halide(s) on one or both sides of the support.

It is also useful that the photothermographic materials include one or more nucleation promoting phosphonium salts in the photothermographic emulsion layer or in a layer adjacent thereto. Such compounds have been described in U.S. Pat. No. 5,968,725 (Katoh and Sakai), U.S. Pat. No. 6,090,538 (Arai et al.), and U.S. Pat. No. 6,203,972 (Katoh et al.).

### Binders

The photosensitive silver halide the non-photosensitive source of reducible silver ions, the reducing agent composition, substituted olefinic co-developer, and any other imaging layer additives are generally combined with one or more binders that are generally hydrophobic or hydrophilic in nature. Thus, either aqueous or organic solvent-based formulations can be used to prepare the thermally developable materials. Mixtures of either or both types of binders can also be used. Generally, the binder is selected from predominantly hydrophobic polymeric materials (at least 50 dry weight % of total binders) and that the imaging layer formulation (and other layer formulations) is coated out of one or more organic solvents (described below).

Examples of typical hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral, polyvinyl acetal, and polyvinyl formal) and vinyl copolymers (such as polyvinyl acetate and polyvinyl chloride) are useful. Suitable hydrophobic binders are polyvinyl butyral resins that are available under the names MOWITAL® (Kuraray America, New York, N.Y.), S-LEC® (Sekisui Chemical Company, Troy, Mich.), BUTVAR® (Solutia, Inc., St. Louis, Mo.) and PIOLOFORM® (Wacker Chemical Company, Adrian, Mich.).

Hydrophilic binders or water-dispersible polymeric latex polymers can also be present in the formulations. Examples of useful hydrophilic binders include, but are not limited to, proteins and protein derivatives, gelatin and gelatin-like derivatives (hardened or unhardened), cellulosic materials such as hydroxymethyl cellulose and cellulosic esters, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides and other synthetic or naturally occurring vehicles commonly known for use in aqueous-based photographic emulsions (see for example, Research Disclosure, item 38957, noted above). Cationic starches can also be used as a peptizer for tabular silver halide grains as described in U.S. Pat. No. 5,620,840 (Maskasky) and U.S. Pat. No. 5,667,955 (Maskasky).

One embodiment of the polymers capable of being dispersed in aqueous solvent includes hydrophobic polymers such as acrylic polymers, polyester, rubber (for example, SBR resin), polyurethane, poly(vinyl chloride), poly(vinyl acetate), poly(vinylidene chloride), polyolefin, and the like. As the polymers above, usable are straight chain polymers, branched polymers, or crosslinked polymers. Also usable are the so-called homopolymers in which single monomer is polymerized, or copolymers in which two or more types of monomers are polymerized. In the case of a copolymer, it may be a random copolymer or a block copolymer. The molecular weight of these polymers is, in number average molecular weight, in the range from 5,000 to 1,000,000. Further, crosslinking polymer latexes are also useful.

Styrene-butadiene latex copolymers are also useful as polymer binders. The weight ratio of monomer unit for styrene to that of butadiene constituting the styrene-butadiene copolymer is generally in the range of from 40:60 to 95:5. Further, the monomer unit of styrene and that of butadiene typically account for 60% by weight to 99% by weight with respect to the copolymer. Moreover, the polymer latex contains acrylic acid or methacrylic acid, for example, in the range from 1% by weight to 6% by weight, and typically, from 2% by weight to 5% by weight, with respect to the total weight of the monomer unit of styrene and that of butadiene. The range of the molecular weight is the same as that described above.

Example latexes include styrene (50)-butadiene (47)-methacrylic acid (3), styrene (60)-butadiene (35)-divinylbenzene-methyl methacrylate (3)-methacrylic acid (2), styrene (70.5)-butadiene (26.5)-acrylic acid (3) and commercially available LACSTAR-3307B, 7132C, and Nipol Lx416. Such latexes are described in U.S. Patent Application Publication 2005/0221237 (Sakai et al.).

Hardeners for various binders may be present if desired. Useful hardeners are well known and include diisocyanate compounds as described in EP 0 600 586 B1 (Philip, Jr. et al.), vinyl sulfone compounds as described in U.S. Pat. No. 6,143,487 (Philip, Jr. et al.) and EP 0 640 589 A1 (Gathmann et al.), aldehydes and various other hardeners as described in U.S. Pat. No. 6,190,822 (Dickerson et al.). The hydrophilic binders used in the photothermographic materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-8.

Where the proportions and activities of the photothermographic materials require a particular developing time and temperature, the binder(s) should be able to withstand those conditions. When a hydrophobic binder is used, it is desired that the binder (or mixture thereof) does not decompose or lose its structural integrity at 120° C. for 60 seconds. When a hydrophilic binder is used, it is also useful that the binder does not decompose or lose its structural integrity at 150° C. for 60 seconds. In some embodiments, the binder should not decompose or lose its structural integrity at 177° C. for 60 seconds.

The polymer binder(s) is used in an amount sufficient to carry the components dispersed therein. For example, a binder is used at a level of from about 10% to about 90% by weight (typically at a level of from about 20% to about 70% by weight) based on the total dry weight of the layer. It is also useful that the photothermographic materials include at least 50 weight % hydrophobic binders in both imaging and non-imaging layers on both sides of the support.

### Support Materials

The photothermographic materials comprise a polymeric support that is typically a flexible, transparent film that has any desired thickness and is composed of one or more polymeric materials. They are required to exhibit dimensional stability during thermal development and to have suitable adhesive properties with overlying layers. Useful polymeric materials for making such supports include polyesters [such as poly(ethylene terephthalate) and poly(ethylene naphthalate)], cellulose acetate and other cellulose esters, polyvinyl acetal, polyolefins, polycarbonates, and polystyrenes. Useful supports can also be composed of polymers having good heat stability, such as polyesters and polycarbonates. Support materials may also be treated or annealed to reduce shrinkage and promote dimensional stability.

Also useful are transparent, multilayer, polymeric supports comprising numerous alternating layers of at least two different polymeric materials as described in U.S. Pat. No. 6,630,283 (Simpson et al.). Another support comprises dichroic mirror layers as described in U.S. Pat. No. 5,795,708 (Boutet).

Opaque supports can also be used, such as dyed polymeric films and resin-coated papers that are stable to high temperatures.

Support materials can contain various colorants, pigments, antihalation or acutance dyes if desired. For example, the support can include one or more dyes that provide a blue color in the resulting imaged film. Support materials may be treated using conventional procedures (such as corona discharge) to improve adhesion of overlying layers, or subbing or other adhesion-promoting layers can be used.

### Photothermographic Formulations and Constructions

An organic solvent-based coating formulation for the photothermographic emulsion layer(s) can be prepared by mixing the various components with one or more binders in a suitable organic solvent system that usually includes one or more solvents such as toluene, 2-butanone (methyl ethyl ketone), acetone, or tetrahydrofuran, or mixtures thereof. Methyl ethyl ketone is a useful coating solvent.

Alternatively, the desired imaging components can be formulated with a hydrophilic binder (such as gelatin, or a gelatin-derivative) or a hydrophobic water-dispersible polymer latex (such as a styrene-butadiene latex) in water or water-organic solvent mixtures to provide aqueous-based coating formulations.

The photothermographic materials can contain plasticizers and lubricants such as poly(alcohols) and diols as described in U.S. Pat. No. 2,960,404 (Milton et al.), fatty acids or esters as described in U.S. Pat. No. 2,588,765 (Robijns) and U.S. Pat. No. 3,121,060 (Duane), and silicone resins as described in GB 955,061 (DuPont). The materials can also contain inorganic and organic matting agents as described in U.S. Pat. No. 2,992,101 (Jelley et al.) and U.S. Pat. No. 2,701,245 (Lynn). Polymeric fluorinated surfactants may also be useful in one or more layers as described in U.S. Pat. No. 5,468,603 (Kub).

The photothermographic materials may also include a surface protective layer over the one or more emulsion layers. Layers to reduce emissions from the material may also be present, including the polymeric barrier layers described in U.S. Pat. No. 6,352,819 (Kenney et al.), U.S. Pat. No. 6,352,820 (Bauer et al.), U.S. Pat. No. 6,420,102 (Bauer et al.), U.S. Pat. No. 6,667,148 (Rao et al.), and U.S. Pat. No. 6,746,831 (Hunt).

U.S. Pat. No. 6,436,616 (Geisler et al.) describes various means of modifying photothermographic materials to reduce what is known as the “woodgrain” effect, or uneven optical density.

To promote image sharpness, the photothermographic materials can contain one or more layers containing acutance and/or antihalation dyes. These dyes are chosen to have absorption close to the exposure wavelength and are designed to absorb scattered light. One or more antihalation compositions may be incorporated into the support, backside layers, underlayers, or overcoat layers. Additionally, one or more acutance dyes may be incorporated into one or more frontside imaging layers.

Dyes useful as antihalation and acutance dyes include squaraine dyes as described in U.S. Pat. No. 5,380,635 (Gomez et al.), and U.S. Pat. No. 6,063,560 (Suzuki et al.), and EP 1 083 459A1 (Kimura), indolenine dyes as described in EP 0 342 810A1 (Leichter), and cyanine dyes as described in U.S. Pat. No. 6,689,547 (Hunt et al.).

It may also be useful to employ compositions including acutance or antihalation dyes that will decolorize or bleach with heat during processing as described in U.S. Pat. No. 5,135,842 (Kitchin et al.), U.S. Pat. No. 5,266,452 (Kitchin et al.), U.S. Pat. No. 5,314,795 (Helland et al.), and U.S. Pat. No. 6,306,566, (Sakurada et al.), and Japan Kokai 2001-142175 (Hanyu et al.) and 2001-183770 (Hanyu et al.). Useful bleaching compositions are described in Japan Kokai 11-302550 (Fujiwara), 2001-109101 (Adachi), 2001-51371 (Yabuki et al.), and 2000-029168 (Noro).

Other useful heat-bleachable antihalation compositions can include an infrared radiation absorbing compound such as an oxonol dye or various other compounds used in combination with a hexaarylbiimidazole (also known as a “HABI”), or mixtures thereof HABI compounds are described in U.S. Pat. No. 4,196,002 (Levinson et al.), U.S. Pat. No. 5,652,091 (Perry et al.), and U.S. Pat. No. 5,672,562 (Perry et al.). Examples of such heat-bleachable compositions are described for example in U.S. Pat. No. 6,455,210 (Irving et al.), U.S. Pat. No. 6,514,677 (Ramsden et al.), and U.S. Pat. No. 6,558,880 (Goswami et al.).

Under practical conditions of use, these compositions are heated to provide bleaching at a temperature of at least 90° C. for at least 0.5 seconds (typically, at a temperature of from about 100° C. to about 200° C. for from about 5 to about 20 seconds).

Mottle and other surface anomalies can be reduced by incorporating a fluorinated polymer as described, for example, in U.S. Pat. No. 5,532,121 (Yonkoski et al.) or by using particular drying techniques as described, for example in U.S. Pat. No. 5,621,983 (Ludemann et al.).

It is useful for the photothermographic material to include one or more radiation absorbing substances that are generally incorporated into one or more photothermographic layer(s)to provide a total absorbance of all layers on that side of the support of at least 0.1 (typically of at least 0.6) at the exposure wavelength of the photothermographic material. Where the imaging layers are on one side of the support only, it is also desired that the total absorbance at the exposure wavelength for all layers on the backside (non-imaging) side of the support be at least 0.2.

Photothermographic formulations can be coated by various coating procedures including wire wound rod coating, dip coating, air knife coating, curtain coating, slide coating, or extrusion coating using hoppers of the type described in U.S. Pat. No. 2,681,294 (Beguin). Layers can be coated one at a time, or two or more layers can be coated simultaneously by the procedures described in U.S. Pat. No. 2,761,791 (Russell), U.S. Pat. No. 4,001,024 (Dittman et al.), U.S. Pat. No. 4,569,863 (Keopke et al.), U.S. Pat. No. 5,340,613 (Hanzalik et al.), U.S. Pat. No. 5,405,740 (LaBelle), U.S. Pat. No.5,415,993 (Hanzalik et al.), U.S. Pat. No. 5,525,376 (Leonard), U.S. Pat. No. 5,733,608 (Kessel et al.), U.S. Pat. No. 5,849,363 (Yapel et al.), 5,843,530 (Jerry et al.), and U.S. Pat. No. 5,861,195 (Bhave et al.), and GB 837,095 (Ilford). A typical coating gap for the emulsion layer can be from about 10 to about 750 μm, and the layer can be dried in forced air at a temperature of from about 20° C. to about 100° C. The thickness of the layer can be selected to provide maximum image densities greater than about 0.2, and typically, from about 0.5 to 5.0 or more, as measured by an X-rite Model 361/V Densitometer equipped with 301 Visual Optics, available from X-rite Corporation, (Granville, Mich.).

In general, two or more layer formulations are simultaneously applied to a support using slide coating techniques, the first layer being coated on top of the second layer while the second layer is still wet. The first and second fluids used to coat these layers can be the same or different solvents. For example, subsequently to, or simultaneously with, application of the emulsion formulation(s) to the support, a protective overcoat formulation can be applied over the emulsion formulation. Simultaneous coating can be used to apply layers on the frontside, backside, or both sides of the support.

In other embodiments, a “carrier” layer formulation comprising a single-phase mixture of two or more polymers described above may be applied directly onto the support and thereby located underneath the emulsion layer(s) as described in U.S. Pat. No. 6,355,405 (Ludemann et al.). The carrier layer formulation can be simultaneously applied with application of the emulsion layer formulation(s) and any overcoat or surface protective layers.

The photothermographic materials can include one or more antistatic or conductive layers agents in any of the layers on either or both sides of the support. Conductive components include soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), electroconductive underlayers as described in U.S. Pat. No. 5,310,640 (Markin et al.), electronically-conductive metal antimonate particles as described in U.S. Pat. No. 5,368,995 (Christian et al.), and electrically-conductive metal-containing particles dispersed in a polymeric binder as described in EP 0 678 776 Al (Melpolder et al.). Some useful conductive particles are the non-acicular metal antimonate particles used in a buried backside conductive layer as described and in U.S. Pat. No. 6,689,546 (LaBelle et al.), U.S. Pat. No. 7,018,787 (Ludemann et al.), and U.S. Pat. No. 7,022,467 (Ludemann et al.) and in U.S. Patent Application Publications 2006/0046215 (Ludemann et al.), 2006/0046932, and 2006/0093973 (Ludemann et al.).

It is useful that the conductive layers be disposed on the backside of the support and especially where they are buried or underneath one or more other layers such as backside protective layer(s). Such backside conductive layers typically have a resistivity of about 10⁵ to about 10¹² ohm/sq as measured using a salt bridge water electrode resistivity measurement technique. This technique is described in R. A. Elder Resistivity Measurements on Buried Conductive Layers, EOS/ESD Symposium Proceedings, Lake Buena Vista, Fla., 1990, pp. 251-254, incorporated herein by reference. [EOS/ESD stands for Electrical Overstress/Electrostatic Discharge].

Still other conductive compositions include one or more fluorochemicals each of which is a reaction product of R_{f}—CH₂CH₂—SO₃H with an amine wherein R_{f} comprises 4 or more fully fluorinated carbon atoms as described in U.S. Pat. No. 6,699,648 (Sakizadeh et al.). Additional conductive compositions include one or more fluorochemicals described in more detail in U.S. Pat. No. 6,762,013 (Sakizadeh et al.).

The photothermographic materials may also usefully include a magnetic recording material as described in Research Disclosure, Item 34390, November 1992, or a transparent magnetic recording layer such as a layer containing magnetic particles on the underside of a transparent support as described in U.S. Pat. No. 4,302,523 (Audran et al.).

While the carrier and emulsion layers can be coated on one side of the film support, manufacturing methods can also include forming on the opposing or backside of the polymeric support, one or more additional layers, including a conductive layer, antihalation layer, or a layer containing a matting agent (such as silica), or a combination of such layers. Alternatively, one backside layer can perform all of the desired functions.

In some embodiments, a conductive “carrier” layer formulation comprising a single-phase mixture of two or more polymers and non-acicular metal antimonate particles, may be applied directly onto the backside of the support and thereby be located underneath other backside layers. The carrier layer formulation can be simultaneously applied with application of these other backside layer formulations.

Layers to promote adhesion of one layer to another are also known, such as those described in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described in U.S. Pat. No. 5,928,857 (Geisler et al.).

It is also contemplated that the photothermographic materials include one or more photothermographic layers on both sides of the support and/or an antihalation underlayer beneath at least one photothermographic layer on at least one side of the support. In addition, the materials can have an outermost protective layer disposed over all photothermographic layers on both sides of the support.

### Imaging/Development

The photothermographic materials can be imaged in any suitable manner consistent with the type of material, using any suitable imaging source to which they are sensitive (typically some type of radiation or electronic signal). In most embodiments, the materials are sensitive to radiation in the range of from about at least 100 nm to about 1400 nm. In some embodiments, they materials are generally sensitive to radiation in the range of from about 300 nm to about 600 nm, typically from about 300 to about 450 nm, or from a wavelength of from about 360 to 420 nm. In other embodiments, the materials are sensitized generally to radiation from about 600 to about 1200 nm and typically to infrared radiation from about 700 to about 950 nm. If necessary, sensitivity to a particular wavelength can be achieved by using appropriate spectral sensitizing dyes.

Imaging can be carried out by exposing the photothermographic materials to a suitable source of radiation to which they are sensitive, including X-radiation, ultraviolet radiation, visible light, near infrared radiation, and infrared radiation to provide a latent image. Suitable exposure means are well known and include phosphor emitted radiation (such as X-ray induced phosphor emitted radiation), incandescent or fluorescent lamps, xenon flash lamps, lasers, laser diodes, light emitting diodes, infrared lasers, infrared laser diodes, infrared light-emitting diodes, infrared lamps, or any other ultraviolet, visible, or infrared radiation source readily apparent to one skilled in the art such as described in Research Disclosure, item 38957 (noted above). Useful infrared exposure means include laser diodes emitting at from about 700 to about 950 nm, including laser diodes that are modulated to increase imaging efficiency using what is known as multi-longitudinal exposure techniques as described in U.S. Pat. No. 5,780,207 (Mohapatra et al.). Other exposure techniques are described in U.S. Pat. No. 5,493,327 (McCallum et al.).

The photothermographic materials also can be indirectly imaged using an X-radiation imaging source and one or more prompt-emitting or storage X-radiation sensitive phosphor screens adjacent to the photothermographic material. The phosphors emit suitable radiation to expose the photothermographic material. Useful X-ray screens are those having phosphors emitting in the near ultraviolet region of the spectrum (from 300 to 400 nm), in the blue region of the spectrum (from 400 to 500 nm), and in the green region of the spectrum (from 500 to 600 nm).

In other embodiments, the photothermographic materials can be imaged directly using an X-radiation imaging source to provide a latent image.

Thermal development conditions will vary, depending on the construction used but will typically involve heating the imagewise exposed photothermographic material at a suitably elevated temperature, for example, at from about 50° C. to about 250° C. (typically from about 80° C. to about 200° C. or from about 100° C. to about 200° C.) for a sufficient period of time, generally from about 1 to about 120 seconds. Heating can be accomplished using any suitable heating means such as contacting the material with a heated drum, plates, or rollers, or by providing a heating resistance layer on the rear surface of the material and supplying electric current to the layer so as to heat the material. One useful heat development procedure for photothermographic materials includes heating within a temperature range of from 110 to 150° C. for 25 seconds or less, for example, at least 3 and up to 25 seconds (and typically for 20 seconds or less) to develop the latent image into a visible image having a maximum density (Dmax) of at least 3.0. Line speeds during development of greater than 61 cm/min, such as from 61 to 200 cm/min, can be used.

Thermal development of photothermographic materials is carried out with the material being in a substantially water-free environment and without application of any solvent to the material.

### Use as a Photomask

The photothermographic materials can be sufficiently transmissive in the range of from about 350 to about 450 nm in non-imaged areas to allow their use in a method where there is a subsequent exposure of an ultraviolet or short wavelength visible radiation sensitive imageable medium. The photothermographic materials absorb ultraviolet or short wavelength visible radiation in the areas where there is a visible image and transmit ultraviolet or short wavelength visible radiation where there is no visible image. The photothermographic materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate. Exposing the imageable material to the imaging radiation through the visible image in the exposed and heat-developed photothermographic material provides an image in the imageable material. This method is particularly useful where the imageable medium comprises a printing plate and the photothermographic material serves as an image-setting film.

Thus, in some other embodiments wherein the photothermographic material comprises a transparent support, the image-forming method further comprises, after steps (A) and (B) or step (A′) noted above:

(C) positioning the exposed and heat-developed photothermographic material between a source of imaging radiation and an imageable material that is sensitive to the imaging radiation, and

(D) exposing the imageable material to the imaging radiation through the visible image in the exposed and heat-developed photothermographic material to provide an image in the imageable material.

The following examples are provided to illustrate the practice of the present invention and the invention is not meant to be limited thereby.

### MATERIALS AND METHODS FOR THE EXAMPLES

All materials used in the following examples are readily available from standard commercial sources, such as Aldrich Chemical Co. (Milwaukee Wis.), or were prepared by known methods. All percentages are by weight unless otherwise indicated. The following additional terms and materials were used.

Many of the chemical components used herein are provided as a solution. The term “active ingredient” means the amount or the percentage of the desired chemical component contained in a sample. All amounts listed herein are the amount of active ingredient added unless otherwise specified.

PARALOID® A-21 is an acrylic copolymer available from Rohm and Haas (Philadelphia, Pa.).

BZT is benzotriazole.

CAB 171-15S is a cellulose acetate butyrate resin available from Eastman Chemical Co (Kingsport, Tenn.).

DESMODUR® N3300 is a trimer of an aliphatic hexamethylene diisocyanate available from Bayer Chemicals (Pittsburgh, Pa.).

PIOLOFORM® BL-16 is reported to be a polyvinyl butyral resin having a glass transition temperature of about 84° C. PIOLOFORM® BM-18 is reported to be a polyvinyl butyral resin having glass transition temperature of about 70° C. Both are available from Wacker Polymer Systems (Adrian, Mich.).

MEK is methyl ethyl ketone (or 2-butanone).

H-1 has the following structure:

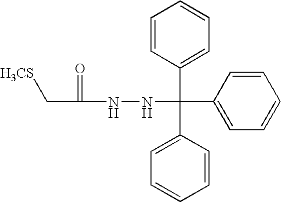

H-2 has the following structure:

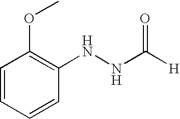

Vinyl Sulfone-1 (VS-1) is described in U.S. Pat. No. 6,143,487 and has the structure shown below.

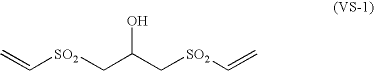

Antifoggant AF-A is 2-pyridyltribromomethylsulfone and has the structure shown below.

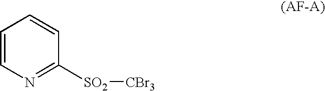

Antifoggant AF-B is ethyl-2-cyano-3-oxobutanoate. It is described in U.S. Pat. No. 5,686,228 (Murray et al.) and has the structure shown below.

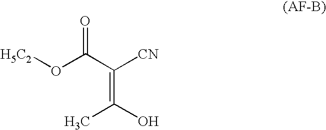

Acutance Dye AD-1 has the following structure:

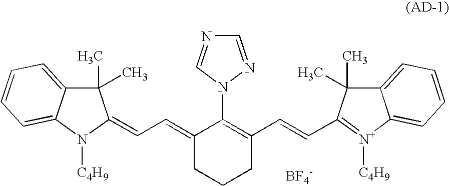

Sensitizing Dye A is described in U.S. Pat. No. 5,541,054 (Miller et al.) has the structure shown below.

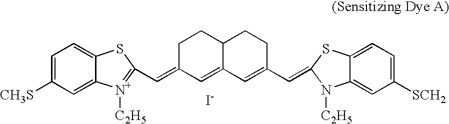

Tinting Dye TD-1 has the following structure:

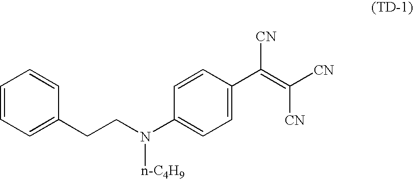

Support Dye SD-1 has the following structure:

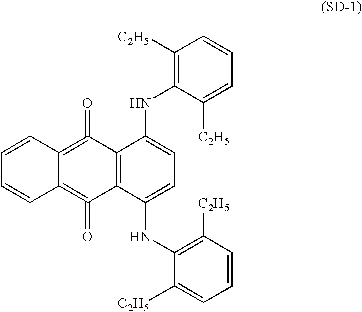

The olefinic substituted co-developers useful in the practice of this invention can be prepared by modification of methods described in U.S. Pat. No. 5,545,515 (Murray et al.), U.S. Pat. No. 5,635,339 (Murray), and U.S. Pat. No. 5,654,130 (Murray), all of which are incorporated herein by reference. α-Hydroxymethylene nitriles were prepared according to the method described in U.S. Pat. No. 4,228,087 (Dubois et al.).

In general, the phosphonium salts of substituted olefinic co-developers were prepared from the reaction of a corresponding alkali metal salt of the acrylonitrile with tetra-substituted phosphonium chloride, bromide, or tetrafluoroborate in water/methanol solution followed by extraction with chloroform (representative methods shown below). Ammonium and sulfonium salts of substituted olefinic co-developers were prepared similar to the procedures described for phosphonium salts as above except that tetra-substituted ammonium halides and tri-substituted sulfonium halides were employed. Co-developers with crown ethers were prepared according to the procedures described in copending and commonly assigned U.S. Ser. No. 11/455,415 (filed Jun. 19, 2006 by Simpson & Sakizadeh), also incorporated herein by reference.

CD-8, CD-13, and CD-21 were prepared using procedures described in U.S. Pat. No. 4,209,621 (Dusza et al.) or U.S. Pat. No. 4,567,263 (Eicken et al.), or in De Munno et al., Journal of the Chemical Society, Perkin Transactions 2: Physical Organic Chemistry (1977), (9), 1121-4, Badhwar et al., Journal of the Chemical Society (1931), 1541-6, Weissflog et al., Zeitschrift fuer Chemie (1986), 26(2), 65-6, and Fuson et al., Journal of Organic Chemistry (1944), 9, 187-92.

Specific synthetic examples are as follows:

### Preparation of potassium salt of 3-oxo-2-cyanopropanoic acid t-butyl ester (CD-4)

t-Butylcyanoacetate (28.23 g, o.2 mol), triethylorthoformate (59.28 g, 0.4 mol), and acetic anhydride (81.67 g, 0.8 mol) were mixed and refluxed under nitrogen for 6 hours. Upon cooling to room temperature, solvents were removed on a rotary evaporator and the crude product (orange color oil) was subjected to distillation under reduce pressure to give 3-ethoxy-2-cyanopropanoic acid t-butyl ester as colorless oil. Yield 32 g (81%). 3-Ethoxy-2-cyanopropanoic acid t-butyl ester (1.97 g, 10 mmol) was dissolved in 10 ml methanol. Potassium hydroxide (0.57 g, 10 mmol) was added and stirred until a clear yellow-orange color solution was obtained. Solvent was removed on a rotary evaporator to give 1.96 g (95%) of the desired compound (CD-4). m.p. 204°-205° C.

### Preparation of 1-butyl-3-methylimidazolium salt of 3-oxo-2-cyanopropanoic acid ethyl ester (CD-43)

Into a solution of potassium 3-oxo-2-cyanopropanoic acid ethyl ester (1.79 g, 10 mmol) in methanol (15 ml) was added 1.74 g (10 mmol) of 1-butyl-3-methylimidazolium chloride with stirring that resulted in precipitation of potassium chloride. Water (10 ml) was added and the mixture was extracted with chloroform (2×10 ml) and dried over MgSO₄. Removal of the solvent on a rotary evaporator left the desired product as oily residue in quantitative yield.

### Preparation of 1-dodecyl-3-methylimidazolium salt of 3-oxo-2-cyanopropanoic acid ethyl ester (CD-44)

CD-44 was prepared similar to the method used to prepare CD-43 but 1-dodecyl-3-methylimidazolium chloride was used instead of 1-butyl-3-methylimidazolium chloride. The desired product was isolated as a yellow waxy material.

### Preparation of 3-oxo-2-cyanopropanoic acid ethyl ester octadecyltrimethylammonium salt (CD-38)

A solution of trimethylstearylammonium chloride (1.74 g, 5 mmol) in water (60 ml) was added into a solution of potassium salt of 3-oxo-2-cyanoprpanoic acid ethyl ester (0.895 g, 5 mmol) in water (20 ml) to give a yellow color gel. The gel was dissolved in 40 ml methanol and extracted with chloroform (2×15 ml) followed by drying over MgSO₄. Removal of the solvent on a rotary evaporator under reduced pressure gave the desired product as yellow color residue that solidified by keeping in dry ice. Yield 1.82 g (80%).

### Preparation of 3-oxo-2-cyanopropanoic acid n-octyl ester octadecyltrimethylammonium salt (CD-69)

A solution of trimethylstearylammonium chloride (3.48 g, 10 mmol) in water (120 ml) was added into a solution of potassium salt of 3-oxo-2-cyanoprpanoic acid n-octyl ester (2.63 g, 10 mmol) in methanol (20 ml) to give a yellow solution of fine dispersions. This was dissolved by adding more methanol (150 ml) into the reaction mixture and extracting it with chloroform (2×25 ml) followed by drying over MgSO₄. Removal of the solvent on a rotary evaporator under reduced pressure gave desired product as a bright yellow color crystalline material. Yield 4.5 g (84%).

### Preparation of 3-oxo-2-cyanopropanoic acid t-butyl ester octadecyltrimethylammonium salt (CD-70)

A solution of trimethylstearylammonium chloride (3.48 g, 10 mmol) in water (120 ml) was added into a solution of potassium salt of 3-oxo-2-cyanopropanoic acid t-butyl ester (2.072 g, 10 mmol) in methanol (20 ml) to give a yellow colored gel. The gel-like solution turned clear by addition of more methanol (50 ml) into the reaction mixture. This was extracted with chloroform (2×25 ml) followed by drying over MgSO₄. Removal of the solvent on a rotary evaporator under reduced pressure gave the desired product as a yellow residue that turned into a fine powder by treating it with n-heptane. Yield 4.6 g (96%).

### Preparation of 3-oxo-2-cyanopropanoic acid ethyl ester triphenylsulfonium salt (CD-71)

Into a solution of potassium salt of 3-oxo-2-cyanopropanoic acid ethyl ester (1.79 g, 10 mmol) in water (10 ml) was added a 50% solution of triphenylsulfonium chloride in water (5.96 g, 10 mmol). The reaction mixture turned cloudy. Water (15 ml) was added and the mixture was extracted with chloroform (2×25 ml) followed by drying over MgSO₄. The removal of the solvent on a rotary evaporator under reduced pressure gave desired product as yellow crystalline material. Yield 3.2 g (80%).

Preparation of 3-oxo-2-cyanopropanoic acid t-butyl ester triphenylsulfonium salt (CD-72)

This compound was prepared similar to the preceding compound at 79% yield from potassium salt of 3-oxo-2-cyanopropanoic acid t-butyl ester (2.07 g, 10 mmol) and 50% solution of triphenylsulfonium chloride in water (5.96 g, 10 mmol) as a yellow color, light weight (fluffy) crystalline material.

### Preparation of 3-oxo-2-cyanopropanoic acid n-octyl ester tetra-n-butylphosphonium salt (CD-73)

Into a solution of 3-oxo-2-cyanopropanoic acid n-octyl ester potassium salt (1.27 g, 5 mmol) in methanol (10 ml) was added a solution of tetra-n-butylphosphonium chloride (1.47 g, 5 mmol) in methanol (10 ml). Precipitated potassium chloride was filtered off and water (20 ml) was added to the methanol solution followed by extraction of product with chloroform (2×15 ml). The chloroform solution was dried over MgSO₄. Removal of the solvent on a rotary evaporator under reduced pressure gave the desired product as an oily yellow reside in quantitative yield.

### Preparation of 3-oxo-2-cyanopropanoic acid ethyl ester tetra-n-butylphosphonium salt (CD-74)

Into a solution of 3-oxo-2-cyanopropanoic acid ethyl ester potassium salt (1.8 g, 10 mmol) in water (15 ml) was added a solution of tetra-n-butylphosphonium tetrafluoroborate (3.46 g, 10 mmol) in water (15 ml) followed by extraction of the product with chloroform (2×15 ml). The chloroform solution was dried over MgSO₄. Removal of the solvent on a rotary evaporator under reduced pressure gave the desired pure product as an oily yellow reside in quantitative yield.

### Preparation of 3-oxo-2-cyanopropanoic acid ethyl ester benzyltriphenylphosphonium salt (CD-75)

A solution of benzyltriphenylphosphonium chloride (3.88 g, 10 mmol) in water/methanol (35 ml:5 ml) was added into a solution of 3-oxo-2-cyanopropanoic acid ethyl ester potassium salt (1.8 g, 10 mmol) in water (20 ml). The reaction mixture was then extracted with chloroform (2×15 ml) and dried over MgSO₄. Removal of the solvent on a rotary evaporator under reduced pressure gave the desired product in quantitative yield as a yellow oily residue.

Other phosphonium-containing substituted olefinic co-developers can be prepared using procedures described in copending and commonly assigned U.S. Ser. No. 11/611,914 (filed Dec. 18, 2006 by Simpson and Sakizadeh), which is incorporated herein by reference.

### Example 1

The following example demonstrates the use of a combination of a trisphenol reducing agent (or developer) and a substituted olefinic co-developer according to the present invention, and compares the invention to other combinations of reducing agents (or developers) and the same co-developer.

Preparation of Photothermographic Emulsion Formulation:

A preformed silver halide, silver carboxylate soap dispersion, was prepared in similar fashion to that described in U.S. Pat. No. 5,939,249 (noted above). The core-shell silver halide emulsion had a silver iodobromide core with 8% iodide, and a silver bromide shell doped with iridium and copper. The core made up 25% of each silver halide grain, and the shell made up the remaining 75%. The silver halide grains were cubic in shape, and had a mean grain size between 0.055 and 0.06 μm. The preformed silver halide, silver carboxylate soap dispersion was made by mixing 26.1% preformed silver halide, silver carboxylate soap, 2.1% PIOLOFORM® BM-18 polyvinyl butyral binder, and 71.8% MEK, and homogenizing three times at 8000 psi (55 MPa).

A photothermographic emulsion formulation was prepared at 67° F. (19.4° C.) containing 174 parts of the above preformed silver halide, silver carboxylate soap dispersion, and 22 parts MEK. To this formulation was added 1.6 parts of a 15% solution of pyridinium hydrobromide perbromide in methanol, with stirring. After 45 minutes of mixing, 2.1 parts of an 11% zinc bromide solution in methanol was added. Stirring was continued and after 30 minutes, a solution of 0.18 parts 2-mercapto-5-methylbenzimidazole, 0.009 parts of Sensitizing Dye A, 2.0 parts of 2-(4-chlorobenzoyl)benzoic acid, 10.8 parts of methanol, and 3.4 parts of MEK were added. After stirring for 75 minutes, the temperature was lowered to 50° F. (10° C.), and 37.6 parts of PIOLOFORM® BM-18, and 21.2 parts of PIOLOFORM® BL-16, and 10 parts of MEK were added. Mixing was continued for another 15 minutes.

The emulsion formulation was completed by adding the materials shown below. Five minutes were allowed between the additions of each component.

Solution A containing:

| | |
|---|---|
| Antifoggant AF-A | 0.80 parts |
| Tetrachlorophthalic acid | 0.37 parts |
| 4-Methylphthalic acid | 1.21 parts |
| MEK | 21 parts |
| Methanol | 0.36 parts |
| DESMODUR ® N3300 Solution | 0.66 parts in |
| | 0.33 parts MEK |
| Phthalazine solution | 1.42 parts in |
| | 6.3 parts MEK |

To 30 parts of the completed emulsion formulation was added the amount of comparative or inventive developer and co-developer in 1.30 parts of methanol and 1.50 parts MEK as shown in TABLE IV, TABLE V, and the descriptions in Examples 1 and 2.

Overcoat Formulation:

The Overcoat Formulation was prepared by mixing the following materials:

| | |
|---|---|
| MEK | 166 parts |
| PARALOID ® A-21 | 1.06 parts |
| CAB 171-15S | 11.52 parts |
| Vinyl Sulfone VS-1 | 0.59 parts, 75% active |
| Benzotriazole | 0.165 parts |
| Acutance Dye AD-1 | 0.32 parts |
| Antifoggant AF-B | 0.29 parts |
| DESMODUR ® N3300 Solution | 0.89 parts, in |
| | 0.41 parts MEK |
| Tinting Dye TD-1 | 0.012 parts |

Preparation of Photothermographic Materials:

The photothermographic emulsion and overcoat formulations were simultaneously coated onto a 7 mil (178 μm) polyethylene terephthalate support, tinted blue with support dye SD-1. An automated dual knife coater equipped with an in-line dryer was used. Immediately after coating, samples were dried in a forced air oven at 85° C. for 6 minutes. The photothermographic emulsion formulation was coated to obtain a coating weight of between about 1.50 and 1.55 g of total silver/m² (0.0139 to 0.0144 mol/m²). The overcoat formulation was coated to obtain about a dry coating weight of about 0.2 g/ft² (2.2 g/m²) and an absorbance in the imaging layer of between 1.5 and 1.6 at 815 nm.

The backside of the support had been coated with an antihalation and antistatic layer having an absorbance greater than 0.3 between 805 and 815 nm, and a resistivity of less than 10¹¹ ohms/square.

Samples of each photothermographic material were cut into strips and imaged with a laser sensitometer at 810 nm. Samples were allowed to equilibrate for 2 hours after exposure but before development. One set of samples was equilibrated at 75° F. (23.9° C.) and 20-23% RH (low humidity conditions). Another set was equilibrated at 68° F. (20° C.) and 80-88% RH (high humidity conditions). Development was carried out under these conditions.

Samples were then thermally developed to generate continuous tone wedges with image densities varying from a minimum density (Dmin) to a maximum density (Dmax) possible for the exposure source and development conditions. Development was carried out on a 6-inch diameter (15.2 cm) heated rotating drum. The strip contacted the drum for 210 degrees of its revolution, about 11 inches (28 cm). Samples were developed at 122.5° C. for 15 and 25 seconds.

A strip sample of each photothermographic material was scanned using a computerized densitometer equipped with both a visible filter and a blue filter having peak transmission at about 440 nm.

Each of the bisphenol and trisphenol developers were combined with a substituted olefinic co-developer, CD-2, in the photothermographic emulsion formulation. TABLE IV below shows the values for Dₘᵢₙ, Dₘₐₓ, and Average Contrast (AC1) for samples equilibrated and processed under both the low humidity and high humidity conditions noted above. A molar ratio of CD-2 to silver of 0.000092:1 was used in all of the coatings in this example.

TABLE V shows the changes in Dₘᵢₙ, Dₘₐₓ, and AC1 between samples processed for 15 and 25 seconds under the two relative humidity conditions. As can be seen from the data in TABLE V, the use of the substituted olefinic co-developer in combination with a trisphenol developer provided smaller changes in AC1 and Dₘᵢₙ when the imaged materials were developed for 25 seconds, especially under the high humidity conditions.

TABLE IV

| | | Ratio of | | | | |
|---|---|---|---|---|---|---|
| | Devel- | Developer/Ag | Humid- | | | |
| | oper | (mol/mol) | ity % | Dₘᵢₙ | Dₘₐₓ | AC1 |
| Comparative | III-1 | 0.16 | 24 | 0.209 | 3.77 | 3.98 |
| Inventive | I-2 | 0.32 | 24 | 0.215 | 3.78 | 2.30 |
| Comparative | III-1 | 0.16 | 86 | 0.223 | 3.83 | 5.03 |
| Inventive | I-2 | 0.32 | 86 | 0.213 | 3.71 | 3.07 |
| Comparative | III-17 | 0.32 | 20 | 0.214 | 3.84 | 3.37 |
| Inventive | I-2 | 0.32 | 20 | 0.210 | 3.78 | 3.87 |
| Comparative | III-17 | 0.32 | 80 | 0.215 | 4.05 | 4.37 |
| Inventive | I-2 | 0.32 | 80 | 0.213 | 4.04 | 4.30 |
| Comparative | III-4 | 0.16 | 20 | 0.219 | 3.99 | 3.92 |
| Inventive | I-2 | 0.32 | 20 | 0.203 | 3.73 | 2.73 |
| Comparative | III-4 | 0.16 | 80 | 0.220 | 4.13 | 5.83 |
| Inventive | I-2 | 0.32 | 80 | 0.216 | 4.05 | 2.97 |

TABLE V

| | Developer | Humidity | ΔDₘᵢₙ | ΔDₘₐₓ | ΔAC1 |
|---|---|---|---|---|---|
| Comparative | III-1 | 24 | +0.043 | +0.177 | +4.30 |
| Inventive | I-2 | 24 | +0.007 | +0.227 | +0.05 |
| Comparative | III-1 | 86 | +0.039 | +0.305 | +6.64 |
| Inventive | I-2 | 86 | +0.012 | +0.172 | +0.81 |
| Comparative | III-17 | 20 | +0.009 | | +2.44 |
| Inventive | I-2 | 20 | +0.006 | | −0.140 |
| Comparative | III-17 | 80 | +0.008 | | +3.81 |
| Inventive | I-2 | 80 | +0.007 | | +1.44 |
| Comparative | III-4 | 20 | +0.020 | | +1.91 |
| Inventive | I-2 | 20 | +0.021 | | +0.83 |
| Comparative | III-4 | 80 | +0.019 | | +4.13 |
| Inventive | I-2 | 80 | +0.004 | | +1.73 |

### Example 2

In this example, the use of a substituted olefinic co-developer according to the present invention (CD-2) was compared with the use of other types of co-developers or development accelerators known in the art for use in photothermographic materials. These co-developers were used in combination with a trisphenol reducing agent or developer from this invention (I-2).

As can be seen from TABLE VI below, when combined with a trisphenol developer, a hydrazine type co-developer known in the art (H-1 or H-2) showed very low silver efficiency (Dₘₐₓ/Ag) when a comparable molar concentration of a substituted olefinic co-developer was used. When higher concentrations of the hydrazine compounds were used to achieve the comparable silver efficiency as that of the inventive substituted olefinic co-developer, the sensitometry, especially the silver efficiency and contrast, of samples containing hydrazine co-developers exhibited much greater sensitivity to humidity.

TABLE VI

| | | Co- | | | | | Humidity | |
|---|---|---|---|---|---|---|---|---|
| | Co- | Developer/Ag | | | | | Sensitivity | |
| | Developer | Mole Ratio | Humidity | Dmin | D/max/Ag | AC1 | ΔDmax/Ag | ΔAC1 |
| Inventive | CD-2 | 9.2 × 10⁻⁵ | 23% | 0.236 | 2.47 | 2.93 | | |
| Inventive | CD-2 | 9.2 × 10⁻⁵ | 88% | 0.237 | 2.54 | 3.79 | 0.06 | 0.86 |
| Comparative | H-1 | 9.2 × 10⁻⁵ | 23% | 0.232 | 1.95 | 1.88 | | |
| Comparative | H-1 | 9.2 × 10⁻⁵ | 88% | 0.234 | 2.01 | 1.75 | 0.06 | −0.13 |
| Comparative | H-1 | 6.8 × 10⁻³ | 23% | 0.234 | 1.93 | 2.00 | | |
| Comparative | H-1 | 6.8 × 10⁻³ | 88% | 0.235 | 2.11 | 2.14 | 0.18 | 0.14 |
| Comparative | H-2 | 9.2 × 10⁻⁵ | 23% | 0.235 | 2.38 | 2.72 | | |
| Comparative | H-2 | 9.2 × 10⁻⁵ | 88% | 0.237 | 2.55 | 6.29 | 0.17 | 3.57 |
| Comparative | H-2 | 6.8 × 10⁻³ | 23% | 0.257 | 2.51 | 19.81 | | |
| Comparative | H-2 | 6.8 × 10⁻³ | 88% | Fogged | Fogged | N/A | N/A | N/A |

### Example 3

The following example demonstrates the use of a combination of a trisphenol reducing agent (or developer) and a substituted olefinic co-developer according to the present invention, and compares the invention to other combinations of reducing agents (or developers) and the same co-developer.

A preformed silver halide, silver carboxylate soap dispersion, was prepared as described in Example 1.

A photothermographic emulsion formulation was prepared at 67° F. (19.4° C.) containing 174 parts of the above preformed silver halide, silver carboxylate soap dispersion, and 4.6 parts MEK. To this formulation was added 1.6 parts of a 15% solution of pyridinium hydrobromide perbromide in methanol, with stirring. After 45 minutes of mixing, 2.1 parts of an 11% zinc bromide solution in methanol was added. Stirring was continued and after 30 minutes, a solution of 0.18 parts 2-mercapto-5-methylbenzimidazole, 0.009 parts of Sensitizing Dye A, 2.0 parts of 2-(4-chlorobenzoyl)benzoic acid, 10.8 parts of methanol, and 3.4 parts of MEK were added. After stirring for 75 minutes, the temperature was lowered to 50° F. (10° C.), and 37.6 parts of PIOLOFORM® BM-18, and 21.2 parts of PIOLOFORM® BL-16, and 50.9 parts of MEK were added. Mixing was continued for another 15 minutes.

The emulsion formulation was completed by adding the materials shown below. Five minutes were allowed between the additions of each component.

| | |
|---|---|
| Developer | See below |
| Solution A containing: | |
| Antifoggant AF-A | 0.80 parts |
| Tetrachlorophthalic acid | 0.37 parts |
| 4-Methylphthalic acid | 0.71 parts |
| MEK | 21 parts |
| Methanol | 0.36 parts |
| DESMODUR ® N3300 Solution | 0.66 parts in |
| | 0.33 parts MEK |
| Phthalazine solution | 1.42 parts in |
| | 6.3 parts MEK |

When the comparative developer (III-4) was used, 6.73 parts were added to the emulsion formulation as indicated above. When the inventive developer (I-2) was used, 7.95 parts were added. To 28.38 parts or 28.48 parts of the completed emulsion formulation containing the comparative developer (III-4) or the inventive developer (I-2), respectively, was added the substituted olefinic co-developer. The substituted olefinic co-developer was added as a solution of 1.34×10⁻⁴ moles per 6.75 parts methanol as shown in TABLE VII, TABLE VIII, and the descriptions in Example 3. Mixing was continued for another 15 minutes.

Overcoat Formulation:

The Overcoat Formulation was prepared by mixing the following materials:

| | |
|---|---|
| MEK | 290 parts |
| PARALOID ® A-21 | 1.85 parts |
| CAB 171-15S | 20.25 parts |
| Vinyl Sulfone VS-1 | 0.96 parts, 80.8% active |
| Benzotriazole | 0.29 parts |
| Acutance Dye AD-1 | 0.50 parts |
| Antifoggant AF-B | 0.51 parts |
| DESMODUR ® N3300 Solution | 1.54 parts, in |
| | 0.76 parts MEK |
| Tinting Dye TD-1 | 0.013 parts |

Preparation of Photothermographic Materials:

The photothermographic emulsion and overcoat formulations were simultaneously coated onto a 7 mil (178 μm) polyethylene terephthalate support, tinted blue with support dye SD-1. An automated dual knife coater equipped with an in-line dryer was used. Immediately after coating, samples were dried in a forced air oven at 85° C. for 6 minutes. The photothermographic emulsion formulation was coated to obtain a coating weight of between about 1.50 and 1.60 g of total silver/m² (0.0139 to 0.0148 mol/m²). The overcoat formulation was coated to obtain about a dry coating weight of about 0.2 g/ft² (2.2 g/m²) and an absorbance in the imaging layer of between 1.45 and 1.55 at 815 nm.

The backside of the support had been coated with an antihalation and antistatic layer having an absorbance greater than 0.3 between 805 and 815 nm, and a resistivity of less than 10¹¹ ohms/square.

Samples of each photothermographic material were imaged and processed as described in Example 1.

A strip sample of each photothermographic material was scanned using a computerized densitometer equipped with both a visible filter and a blue filter having peak transmission at about 440 nm.

The bisphenol (III-4) or trisphenol (I-2) developers were combined with a substituted olefinic co-developer, CD-32, CD-37, or CD-38, in the photothermographic emulsion formulation. TABLE VII below shows the values for Dₘᵢₙ, Dₘₐₓ, and Average Contrast (AC1) for samples equilibrated and processed under both the low humidity and high humidity conditions noted above. Some substituted olefinic co-developer concentrations are higher with the inventive developer to maintain similar initial sensitometry and Ag efficiency (Dₘₐₓ/Ag coating weight).

TABLE VIII shows the changes in Dₘᵢₙ, Dₘₐₓ, and AC1 between samples processed for 15 and 25 seconds under the two relative humidity conditions. As can be seen from the data in TABLE VIII, the use of the substituted olefinic co-developer in combination with a trisphenol developer provided smaller changes in AC1 and Dₘᵢₙ when the imaged materials were developed for 25 seconds, especially under the high humidity conditions.

TABLE VII

| | | | Amount of Co- | | | | |
|---|---|---|---|---|---|---|---|
| | | | Developer (×10⁻⁶ | | | | |
| | Developer | Co-Developer | moles) | Humidity % | Dₘᵢₙ | Dₘₐₓ | AC1 |
| Comparative | III-4 | CD-37 | 10.2 | 25 | 0.211 | 3.70 | 2.50 |
| Inventive | I-2 | CD-37 | 11.4 | 32 | 0.211 | 3.60 | 2.79 |
| Comparative | III-4 | CD-37 | 10.2 | 80 | 0.212 | 4.00 | 3.17 |
| Inventive | I-2 | CD-37 | 11.4 | 86 | 0.210 | 3.87 | 3.49 |
| Comparative | III-4 | CD-32 | 10.2 | 25 | 0.209 | 3.64 | 2.71 |
| Inventive | I-2 | CD-32 | 11.4 | 32 | 0.212 | 3.56 | 2.76 |
| Comparative | III-4 | CD-32 | 10.2 | 80 | 0.211 | 3.90 | 3.40 |
| Inventive | I-2 | CD-32 | 11.4 | 86 | 0.211 | 3.88 | 3.57 |
| Comparative | III-4 | CD-38 | 10.2 | 33 | 0.211 | 3.97 | 4.37 |
| Inventive | I-2 | CD-38 | 10.2 | 33 | 0.214 | 3.91 | 4.18 |
| Comparative | III-4 | CD-38 | 10.2 | 84 | 0.214 | 4.05 | 4.86 |
| Inventive | I-2 | CD-38 | 10.2 | 84 | 0.215 | 4.10 | 4.85 |

TABLE VIII

| | Devel- | Co- | Humid- | | | |
|---|---|---|---|---|---|---|
| | oper | Developer | ity | ΔDₘᵢₙ | ΔDₘₐₓ | ΔAC1 |
| Comparative | III-4 | CD-37 | 25 | +0.018 | −0.056 | +1.29 |
| Inventive | I-1 | CD-37 | 32 | +0.015 | +0.047 | +0.67 |
| Comparative | III-4 | CD-37 | 80 | +0.021 | +0.020 | +2.12 |
| Inventive | I-2 | CD-37 | 86 | +0.015 | −0.140 | +1.52 |
| Comparative | III-4 | CD-32 | 25 | +0.019 | −0.012 | +1.34 |
| Inventive | I-2 | CD-32 | 32 | +0.013 | +0.048 | +0.52 |
| Comparative | III-4 | CD-32 | 80 | +0.020 | +0.130 | +2.68 |
| Inventive | I-2 | CD-32 | 86 | +0.016 | +0.020 | +1.29 |
| Comparative | III-4 | CD-38 | 33 | +0.019 | +0.067 | +3.30 |
| Inventive | I-2 | CD-38 | 33 | +0.017 | −0.004 | +1.45 |
| Comparative | III-4 | CD-38 | 84 | +0.017 | +0.150 | +4.38 |
| Inventive | I-2 | CD-38 | 84 | +0.015 | +0.010 | +3.86 |

### Example 4

It is highly desirable in the manufacture of photothermographic imaging materials that the photothermographic imaging layer coating solution/dispersion (formulation) be stable with respect to the sensitometric property changes, when kept for 24 hours. This example demonstrates that olefinic co-developers of Structure (IV) in which R is an alkyl acyloxy group, in combination with a developer mixture containing trisphenol and bisphenol, resulted in improved imaging layer formulation stability (“pot life”).

The procedures of preparation, formulation, and coating of photothermographic materials are similar to those shown in Example 1 and 2, except the identity and quantities of developer and co-developers are varied as shown in TABLE IX below.

Imaging layer formulations thus prepared were coated immediately to obtain “0 hr pot life” samples. The same formulations were then held at 10° C. (50° F.) for 24 hours before the “aged” formulations were again coated to obtain “24 hr pot life” samples. Sensitometric properties for both samples were determined at 2 humidity levels and the changes in silver efficiency (ΔDmax/Ag) and Speed2 (ΔSpeed2) were determined. As can be seen from TABLE IX, the “24 hr pot life” samples containing olefinic co-developer of Structure (IV) in which R is a pentyl acyloxy group (for example, Compound CD-47) showed no speed and silver efficiency losses compared to the “0 hr pot-life” samples (i.e., ΔDmax/Ag and ΔSpeed2 are both non-negative). In contrast, the “24 hr pot life” samples containing olefinic co-developers that do not have an R substituent that is an alkyl acyloxy group showed silver efficiency and speed losses (ΔDmax/Ag and/or ΔSpeed2 are negative).

TABLE IX

| | | Pot | Processing | | | | | | | |
|---|---|---|---|---|---|---|---|---|---|---|
| | | Life | Humidity | | | | | | 24 hr Pot-Life Change | |
| Co-Developer (mol) | Developer (mol/mol) | (hr) | % RH | Ag g/m² | Dmax/Ag | Dmin | Dmax | Speed2 | ΔDmax/Ag | ΔSpeed2 |
| CD-2 (7.4 × 10⁻⁶) | I-2/III-1(1.9 × 10⁻³/1.6 × 10⁻⁴) | 0 | 24 | 1.59 | 2.39 | 0.234 | 3.803 | 1.649 | | |
| CD-2 (7.4 × 10⁻⁶) | I-2/III-1(1.9 × 10⁻³/1.6 × 10⁻⁴) | 24 | 24 | 1.58 | 2.34 | 0.233 | 3.690 | 1.573 | −0.06 | −0.076 |
| CD-2 (7.4 × 10⁻⁶) | I-2/III-1(1.6 × 10⁻³/4.8 × 10⁻⁴) | 0 | 24 | 1.47 | 2.53 | 0.238 | 4.334 | 1.646 | | |
| CD-2 (7.4 × 10⁻⁶) | I-2/III-1(1.6 × 10⁻³/4.8 × 10⁻⁴) | 24 | 24 | 1.51 | 2.34 | 0.220 | 3.641 | 1.467 | −0.20 | −0.178 |
| CD-30 (9.8 × 10⁻⁶) | I-2/III-1(1.6 × 10⁻³/4.8 × 10⁻⁴) | 0 | 24 | 1.51 | 2.08 | 0.243 | 3.954 | 1.559 | | |
| CD-30 (9.8 × 10⁻⁶) | I-2/III-1(1.6 × 10⁻³/4.8 × 10⁻⁴) | 24 | 24 | 1.57 | 2.05 | 0.222 | 2.828 | 1.392 | −0.04 | −0.167 |
| CD-30 (1.1 × 10⁻⁵) | I-2/III-1(1.6 × 10⁻³/4.8 × 10⁻⁴) | 0 | 24 | 1.49 | 2.26 | 0.242 | 4.073 | 1.554 | | |
| CD-30 (1.1 × 10⁻⁵) | I-2/III-1(1.6 × 10⁻³/4.8 × 10⁻⁴) | 24 | 24 | 1.51 | 2.17 | 0.224 | 3.454 | 1.457 | −0.09 | −0.098 |
| CD-47 (7.4 × 10⁻⁶) | I-2/III-1(1.9 × 10⁻³/1.6 × 10⁻⁴) | 0 | 24 | 1.56 | 2.41 | 0.230 | 3.765 | 1.762 | | |
| CD-47 (7.4 × 10⁻⁶) | I-2/III-1(1.9 × 10⁻³/1.6 × 10⁻⁴) | 24 | 24 | 1.55 | 2.45 | 0.233 | 3.804 | 1.868 | 0.04 | 0.106 |
| CD-2 (7.4 × 10⁻⁶) | I-2/III-1(1.9 × 10⁻³/1.6 × 10⁻⁴) | 0 | 85 | 1.48 | 2.59 | 0.231 | 3.827 | 1.800 | | |
| CD-2 (7.4 × 10⁻⁶) | I-2/III-1(1.9 × 10⁻³/1.6 × 10⁻⁴) | 24 | 85 | 1.57 | 2.51 | 0.233 | 3.934 | 1.729 | −0.08 | −0.072 |
| CD-2 (7.4 × 10⁻⁶) | I-2/III-1(1.6 × 10⁻³/4.8 × 10⁻⁴) | 0 | 85 | 1.58 | 2.67 | 0.234 | 4.111 | 1.717 | | |
| CD-2 (7.4 × 10⁻⁶) | I-2/III-1(1.6 × 10⁻³/4.8 × 10⁻⁴) | 24 | 85 | 1.69 | 2.46 | 0.224 | 4.225 | 1.606 | −0.21 | −0.111 |
| CD-30 (9.8 × 10⁻⁶) | I-2/III-1(1.6 × 10⁻³/4.8 × 10⁻⁴) | 0 | 85 | 1.65 | 2.36 | 0.239 | 4.004 | 1.555 | | |
| CD-30 (9.8 × 10⁻⁶) | I-2/III-1(1.6 × 10⁻³/4.8 × 10⁻⁴) | 24 | 85 | 1.74 | 2.28 | 0.228 | 3.755 | 1.454 | −0.07 | −0.101 |
| CD-30 (1.1 × 10⁻⁵) | I-2/III-1(1.6 × 10⁻³/4.8 × 10⁻⁴) | 0 | 85 | 1.64 | 2.45 | 0.237 | 3.917 | 1.582 | | |
| CD-30 (1.1 × 10⁻⁵) | I-2/III-1(1.6 × 10⁻³/4.8 × 10⁻⁴) | 24 | 85 | 1.64 | 2.47 | 0.227 | 4.110 | 1.478 | 0.02 | −0.104 |
| CD-47 (7.4 × 10⁻⁶) | I-2/III-1(1.9 × 10⁻³/1.6 × 10⁻⁴) | 0 | 85 | 1.58 | 2.59 | 0.229 | 4.098 | 1.982 | | |
| CD-47 (7.4 × 10⁻⁶) | I-2/III-1(1.9 × 10⁻³/1.6 × 10⁻⁴) | 24 | 85 | 1.55 | 2.60 | 0.235 | 4.034 | 2.078 | 0.01 | 0.096 |

### Example 5

Another desirable quality of the photothermographic imaging material is a stable sensitometric response as the material is used over time. This is referred to as shelf-life stability and desirable results provide minimal sensitometric change when kept at various temperatures and humidity. This example demonstrates that the use of olefinic co-developers of Structure (IV) in which R is an alkyl acyloxy group results in improved shelf-life stability with minimal silver efficiency and contrast changes.

The procedures for preparation, formulation, and coating of the photothermographic materials are similar to those shown in Example 3 except a combination of the trisphenol (I-2) developer (6.03 parts), bisphenol (III-3) (1.64 parts), and 4-methylphthalic acid (1.07 parts) were added to the emulsion formulation. Also acutance dye AD-1 (0.56 parts) and tinting dye TD-1 (0.021 parts) were added in the overcoat formulation.

To demonstrate the shelf-life stability, the photothermographic materials were initially exposed and processed as described in Example 3. Additional unexposed samples were placed in a breathable black poly bag for 7 days in either a dry humidity of 11% and 43.3° C. (110° F.) or a wet humidity of 50% and 48.9° C. (120° F.). These samples were then imaged and exposed in either low or high humidity conditions as described in Example 3. The aged and initial sensitometry was compared at the low and high humidity conditions.

As can be seen by TABLE X below, use of the alkyl acyloxy-substituted olefinic co-developer, CD-47, provided minimal loss in silver efficiency and contrast after aging in low or high humidity as compared use of the hydroxy-substituted co-developer, CD-65. In addition, the alkyl acyloxy-substituted co-developer, CD-46 provided less of a change in silver efficiency and contrast than the —O⁻K⁺-substituted co-developer, CD-8.

TABLE X

| | Amount of Co- | Initial or | Processing | | | | | | | | | |
|---|---|---|---|---|---|---|---|---|---|---|---|---|
| Co- | Developer | Aging | Humidity | | | | | | | | | |
| Developer | (×10⁻⁶ moles) | Conditions | % RH | Dmax/Ag | Dmin | Dmax | SPD2 | AC1 | AC2 | ΔDmax/Ag | ΔAC1 | ΔAC2 |
| CD-65 | 4.4 | Initial | 23 | 2.37 | 0.241 | 3.72 | 1.60 | 2.65 | 2.89 | | | |
| CD-65 | 4.4 | Dry | 23 | 1.62 | 0.240 | 2.65 | 1.18 | 2.05 | — | −0.75 | −0.60 | — |
| CD-65 | 4.4 | Initial | 83 | 2.59 | 0.241 | 4.20 | 1.81 | 3.48 | 3.41 | | | |
| CD-65 | 4.4 | Wet | 83 | 1.99 | 0.249 | 3.22 | 1.35 | 2.35 | 2.78 | −0.60 | −1.14 | −0.63 |
| CD-47 | 6.2 | Initial | 23 | 2.43 | 0.241 | 3.77 | 1.65 | 2.89 | 3.02 | | | |
| CD-47 | 6.2 | Dry | 23 | 2.39 | 0.240 | 3.72 | 1.32 | 3.07 | 3.85 | −0.05 | 0.18 | 0.83 |
| CD-47 | 6.2 | Initial | 83 | 2.66 | 0.240 | 4.17 | 1.91 | 3.78 | 3.51 | | | |
| CD-47 | 6.2 | Wet | 83 | 2.59 | 0.248 | 3.96 | 1.51 | 3.60 | 4.22 | −0.07 | −0.18 | 0.71 |
| CD-8 | 5.4 | Initial | 23 | 2.39 | 0.235 | 3.68 | 1.62 | 2.83 | 3.10 | | | |
| CD-8 | 5.4 | Dry | 23 | 1.49 | 0.240 | 2.27 | 1.11 | 1.79 | — | −0.90 | −1.04 | — |
| CD-8 | 5.4 | Initial | 83 | 2.68 | 0.235 | 4.07 | 1.86 | 3.75 | 3.57 | | | |
| CD-8 | 5.4 | Wet | 83 | 2.02 | 0.241 | 3.06 | 1.34 | 2.32 | 2.72 | −0.66 | −1.43 | −0.86 |
| CD-46 | 6.0 | Initial | 23 | 2.42 | 0.236 | 3.69 | 1.58 | 2.578 | 2.75 | | | |
| CD-46 | 6.0 | Dry | 23 | 2.21 | 0.240 | 3.31 | 1.23 | 2.52 | 3.33 | −0.22 | −0.05 | 0.59 |
| CD-46 | 6.0 | Initial | 83 | 2.63 | 0.236 | 4.00 | 1.88 | 3.39 | 3.24 | | | |
| CD-46 | 6.0 | Wet | 83 | 2.41 | 0.231 | 3.54 | 1.34 | 2.73 | 3.45 | −0.22 | −0.66 | 0.21 |

### Example 6

This example demonstrates that the use of alkyl acyloxy-substituted olefinic co-developers, CD-47, CD-48, and CD-50, that resulted in improved shelf-life stability with minimal silver efficiency and contrast changes. All preparations, coating, imaging, and shelf-life testing were as described in Example 5. As shown in the following TABLE XI, use of these alkyl acyloxy-substituted olefinic co-developers provided smaller changes in silver efficiency and contrast after aging under low or high humidity conditions as compared to use of the hydroxy-substituted co-developer, CD-65.

TABLE XI

| | Amount of Co- | Initial or | Processing | | | | | | | | | |
|---|---|---|---|---|---|---|---|---|---|---|---|---|
| Co- | Developer | Aging | Humidity | | | | | | | | | |
| Developer | (×10⁻⁶ moles) | Conditions | % RH | Dmax/Ag | Dmin | Dmax | SPD2 | AC1 | AC2 | ΔDmax/Ag | ΔAC1 | ΔAC2 |
| CD-65 | 4.4 | Initial | 23 | 2.49 | 0.236 | 3.88 | 1.79 | 3.60 | 3.68 | | | |
| CD-65 | 4.4 | Dry | 23 | 2.38 | 0.240 | 3.67 | 1.46 | 3.10 | 3.71 | −0.11 | −0.50 | 0.02 |
| CD-65 | 4.4 | Initial | 85 | 2.69 | 0.238 | 4.07 | 1.94 | 4.06 | 3.95 | | | |
| CD-65 | 4.4 | Wet | 85 | 2.22 | 0.245 | 3.38 | 1.51 | 2.69 | 3.15 | −0.47 | −1.37 | −0.80 |
| CD-47 | 5.6 | Initial | 23 | 2.45 | 0.233 | 3.82 | 1.82 | 3.87 | 3.80 | | | |
| CD-47 | 5.6 | Dry | 23 | 2.59 | 0.240 | 4.06 | 1.63 | 4.31 | 4.72 | 0.14 | 0.43 | 0.92 |
| CD-47 | 5.6 | Initial | 85 | 2.74 | 0.236 | 4.14 | 1.99 | 4.45 | 4.25 | | | |
| CD-47 | 5.6 | Wet | 85 | 2.52 | 0.245 | 3.91 | 1.65 | 3.70 | 4.51 | −0.21 | −0.76 | 0.26 |
| CD-48 | 5.6 | Initial | 23 | 2.45 | 0.237 | 3.75 | 1.77 | 3.61 | 3.80 | | | |
| CD-48 | 5.6 | Dry | 23 | 2.46 | 0.240 | 3.93 | 1.55 | 3.86 | 4.29 | 0.00 | 0.25 | 0.49 |
| CD-48 | 5.6 | Initial | 85 | 2.59 | 0.236 | 4.12 | 1.91 | 4.33 | 4.18 | | | |
| CD-48 | 5.6 | Wet | 85 | 2.40 | 0.247 | 3.67 | 1.55 | 3.28 | 4.04 | −0.19 | −1.04 | −0.15 |
| CD-50 | 5.6 | Initial | 23 | 2.48 | 0.236 | 3.69 | 1.80 | 3.54 | 3.68 | | | |
| CD-50 | 5.6 | Dry | 23 | 2.54 | 0.240 | 4.04 | 1.58 | 4.22 | 4.53 | 0.06 | 0.68 | 0.85 |
| CD-50 | 5.6 | Initial | 85 | 2.69 | 0.237 | 4.09 | 1.98 | 4.22 | 4.15 | | | |
| CD-50 | 5.6 | Wet | 85 | 2.47 | 0.247 | 3.78 | 1.60 | 3.65 | 4.37 | −0.22 | −0.57 | 0.22 |

### Example 7

This example demonstrates that the use of alkyl acyloxy-substituted olefinic co-developers CD-46, CD-49, and CD-52 resulted in improved shelf-life stability with minimal silver efficiency and contrast changes.

All preparations, coating, imaging, and shelf-life testing were as described in Example 5. As shown in the following TABLE XII, these alkyl acyloxy-substituted olefinic co-developer provided smaller changes in silver efficiency and contrast after aging in low or high humidity as compared to use of the —O⁻K⁺-substituted co-developer CD-8.

TABLE XII

| | Amount of Co- | Initial or | Processing | | | | | | | | | |
|---|---|---|---|---|---|---|---|---|---|---|---|---|
| Co- | Developer | Aging | Humidity | | | | | | | | | |
| Developer | (×10⁻⁶ moles) | Conditions | % RH | Dmax/Ag | Dmin | Dmax | SPD2 | AC1 | AC2 | ΔDmax/Ag | ΔAC1 | ΔAC2 |
| CD-8 | 4.9 | Initial | 23 | 2.49 | 0.245 | 3.76 | 1.78 | 3.40 | 3.69 | | | |
| CD-8 | 4.9 | Dry | 23 | 2.30 | 0.250 | 3.73 | 1.49 | 2.91 | 3.39 | −0.18 | −0.49 | −0.28 |
| CD-8 | 4.9 | Initial | 85 | 2.69 | 0.247 | 4.20 | 1.99 | 4.50 | 4.41 | | | |
| CD-8 | 4.9 | Wet | 85 | 2.10 | 0.249 | 3.14 | 1.49 | 2.36 | 2.50 | −0.60 | −2.14 | −1.91 |
| CD-46 | 5.6 | Initial | 23 | 2.47 | 0.245 | 3.73 | 1.82 | 3.76 | 3.85 | | | |
| CD-46 | 5.6 | Dry | 23 | 2.48 | 0.250 | 4.09 | 1.58 | 3.93 | 4.41 | 0.01 | 0.17 | 0.55 |
| CD-46 | 5.6 | Initial | 85 | 2.64 | 0.246 | 4.19 | 2.01 | 4.59 | 4.31 | | | |
| CD-46 | 5.6 | Wet | 85 | 2.38 | 0.250 | 3.79 | 1.61 | 3.14 | 3.64 | −0.25 | −1.45 | −0.67 |
| CD-52 | 5.6 | Initial | 23 | 2.57 | 0.243 | 3.93 | 1.89 | 4.19 | 4.13 | | | |
| CD-52 | 5.6 | Dry | 23 | 2.55 | 0.250 | 4.03 | 1.56 | 3.88 | 4.39 | −0.02 | −0.30 | 0.26 |
| CD-52 | 5.6 | Initial | 85 | 2.67 | 0.246 | 4.17 | 2.07 | 4.87 | 4.53 | | | |
| CD-52 | 5.6 | Wet | 85 | 2.30 | 0.247 | 3.58 | 1.58 | 3.08 | 3.67 | −0.38 | −1.79 | −0.87 |
| CD-49 | 6.0 | Initial | 23 | 2.58 | 0.243 | 3.94 | 1.87 | 4.37 | 4.41 | | | |
| CD-49 | 6.0 | Dry | 23 | 2.61 | 0.250 | 4.17 | 1.65 | 4.85 | 5.13 | 0.03 | 0.48 | 0.72 |
| CD-49 | 6.0 | Initial | 85 | 2.71 | 0.244 | 4.17 | 2.07 | 5.06 | 4.73 | | | |
| CD-49 | 6.0 | Wet | 85 | 2.46 | 0.249 | 3.86 | 1.61 | 3.68 | 4.48 | −0.25 | −1.38 | −0.25 |

### Example 8

This example demonstrates that the use of alkyl acyloxy-substituted olefinic co-developers CD-47, CD-50, and CD-63 resulted in improved shelf-life stability with minimal silver efficiency and contrast changes.

All preparations, coating, imaging, and shelf-life testing were as described in Example 5. As shown in the following TABLE XIII, these alkyl acyloxy-substituted olefinic co-developer provided smaller changes in silver efficiency and contrast after aging in low or high humidity as compared to use of the hydroxy-substituted co-developer, CD-65.

TABLE XIII

| | Amount of Co- | Initial or | Processing | | | | | | | | | |
|---|---|---|---|---|---|---|---|---|---|---|---|---|
| Co- | Developer | Aging | Humidity | | | | | | | | | |
| Developer | (×10⁻⁶ moles) | Conditions | % RH | Dmax/Ag | Dmin | Dmax | SPD2 | AC1 | AC2 | ΔDmax/Ag | ΔAC1 | ΔAC2 |
| CD-65 | 4.4 | Initial | 23 | 2.51 | 0.240 | 3.78 | 1.68 | 2.96 | 3.15 | | | |
| CD-65 | 4.4 | Dry | 23 | 2.23 | 0.24 | 3.56 | 1.40 | 2.66 | 3.16 | −0.28 | −0.30 | 0.01 |
| CD-65 | 4.4 | Initial | 86 | 2.61 | 0.234 | 4.13 | 1.91 | 3.90 | 3.67 | | | |
| CD-65 | 4.4 | Wet | 86 | 2.22 | 0.244 | 3.48 | 1.50 | 2.51 | 2.81 | −0.39 | −1.38 | −0.87 |
| CD-47 | 5.6 | Initial | 23 | 2.57 | 0.239 | 3.93 | 1.79 | 3.54 | 3.43 | | | |
| CD-47 | 5.6 | Dry | 23 | 2.55 | 0.24 | 4.10 | 1.54 | 3.89 | 3.71 | −0.02 | 0.35 | 0.28 |
| CD-47 | 5.6 | Initial | 86 | 2.75 | 0.240 | 4.21 | 2.05 | 4.71 | 4.37 | | | |
| CD-47 | 5.6 | Wet | 86 | 2.52 | 0.246 | 4.00 | 1.64 | 3.70 | 4.18 | −0.23 | −1.00 | −0.19 |
| CD-50 | 5.6 | Initial | 23 | 2.39 | 0.239 | 3.70 | 1.71 | 2.90 | 3.06 | | | |
| CD-50 | 5.6 | Dry | 23 | 2.50 | 0.24 | 3.92 | 1.53 | 3.43 | 3.77 | 0.11 | 0.53 | 0.70 |
| CD-50 | 5.6 | Initial | 86 | 2.71 | 0.239 | 4.09 | 1.97 | 3.96 | 3.75 | | | |
| CD-50 | 5.6 | Wet | 86 | 2.64 | 0.243 | 3.99 | 1.63 | 3.60 | 3.96 | −0.07 | −0.36 | 0.21 |
| CD-63 | 5.6 | Initial | 23 | 2.45 | 0.236 | 3.50 | 1.65 | 2.86 | 3.13 | | | |
| CD-63 | 5.6 | Dry | 23 | 2.55 | 0.24 | 3.77 | 1.55 | 3.51 | 3.91 | 0.10 | 0.65 | 0.78 |
| CD-63 | 5.6 | Initial | 86 | 2.69 | 0.237 | 3.93 | 1.93 | 3.80 | 3.75 | | | |
| CD-63 | 5.6 | Wet | 86 | 2.62 | 0.242 | 3.75 | 1.57 | 3.11 | 3.80 | −0.07 | −0.69 | 0.05 |

The invention has been described in detail with particular reference to certain preferred embodiments thereof, but it will be understood that variations and modifications can be effected within the spirit and scope of the invention.

1. A photothermographic material comprising a support having on at least one side thereof, one or more photothermographic imaging layers comprising in reactive association:
a. a photosensitive silver halide,
b. a non-photosensitive source of reducible silver ions,
c. a reducing agent composition for said reducible silver ions,
d. a polymeric binder, and
e. a substituted olefinic co-developer,
wherein said reducing agent composition comprises a trisphenol reducing agent represented by the following Structure (I): 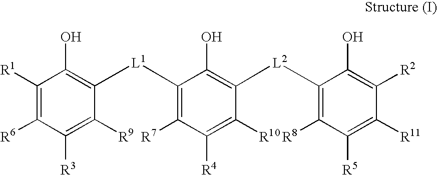
wherein L¹ and L² are independently sulfur or a mono-substituted or unsubstituted methylene groups,
R¹ and R² are independently primary or secondary substituted or unsubstituted alkyl groups having 1 to 12 carbon atoms,
R³, R⁴, and R⁵ are independently substituted or unsubstituted alkyl groups having 1 to 12 carbon atoms, substituted or unsubstituted alkoxy groups having 1 to 12 carbon atoms, or halo groups, and
R⁶, R⁷, R⁸, R⁹, R¹⁰, and R¹¹ are independently hydrogen or any substituent that is substitutable on a benzene ring.

2. The photothermographic material of claim 1 wherein L¹ and L² are independently a methylene group or a mono-substituted methylene group,
R¹ and R² are independently substituted or unsubstituted primary or secondary alkyl groups having 1 to 8 carbon atoms,
R³, R⁴, and R⁵ are independently substituted or unsubstituted alkyl groups having 1 to 6 carbon atoms, and
R⁶, R⁷, R⁸, R⁹, R¹⁰, and R¹¹ are independently hydrogen, or substituted or unsubstituted methyl, ethyl, or methoxy groups, or chloro groups.

3. The photothermographic material of claim 2 wherein L¹ and L² are unsubstituted methylene groups,
R¹ and R² are the same substituted or unsubstituted primary or secondary alkyl groups,
R³, R⁴, and R⁵ are the same substituted or unsubstituted methyl or ethyl groups, and
R⁶, R⁷, R⁸, R⁹, R¹⁰, and R¹¹ are independently hydrogen or unsubstituted methyl groups.

4. The photothermographic material of claim 1 wherein said reducing agent of Structure (I) is present in an amount of at least 0.5 mmol/m².

5. The photothermographic material of claim 1 wherein said substituted olefinic co-developer is present at a molar ratio to said reducing agent of Structure (I) of from about 0.001:1 to about 0.02:1.

6. The photothermographic material of claim 1 wherein said substituted olefinic co-developer is represented by the following Structure (IV): 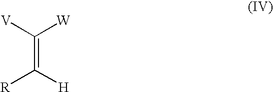
wherein V and W are independently aromatic or electron withdrawing groups, provided that at least one of V and W is an electron withdrawing group, or V and W can represent the atoms necessary to form a ring containing an electron withdrawing group,
R is a halo, hydroxy, thiohydrocarbyl, oxyhydrocarbyl, HET, —O⁻A⁺, or —S⁻A⁻ group,
HET is a 5- or 6-membered heteroaromatic group attached through a non-quaternary nitrogen atom,
A⁺ is a metal, quaternary ammonium, quaternary phosphonium cation, or ternary sulfonium cation, or the complex cation of an alkali metal cation with a CROWN ETHER, and
CROWN ETHER is a substituted or unsubstituted 12-crown-4, a substituted or unsubstituted 15-crown-5, or a substituted or unsubstituted 18-crown-6.

7. The photothermographic material of claim 6 wherein V is a carboalkoxy group having 2 to 13 carbon atoms, a carboxamido group having 2 to 13 carbon atoms, or an aryl group having 6 to 10 carbon atoms,
W is a cyano group,
R is a hydroxy, alkoxy, aryloxy, —O⁻A⁺, or alkyl-(C═O)O— group having 1 to 24 carbon atoms,
A⁺ is an alkali metal, quaternary ammonium, ternary sulfonium, or quaternary phosphonium cation, or a complex cation of an alkali metal cation with a CROWN ETHER,
HET is a 5- or 6-membered heteroaromatic ring group attached through a non-quaternary ring nitrogen atom of said 5- or 6-membered heterocyclic ring being composed of only carbon and nitrogen atoms, and
CROWN ETHER is a substituted or unsubstituted 15-crown-5 or a substituted or unsubstituted 18-crown-6.

8. The photothermographic material of claim 7 wherein R is a (primary alkyl)-(C═O)O— group in which the primary alkyl group has 1 to 24 carbon atoms.

9. The photothermographic material of claim 7 wherein V is a carboalkoxy group having 2 to 9 carbon atoms, a carboxamido group having 2 to 7 carbon atoms, or a halogen-substituted phenyl group,
R is a hydroxy, —O⁻A⁺, or (primary alkyl)-(C═O)O— group in which the primary alkyl group has 1 to 24 carbon atoms,
A⁺ is a lithium, sodium, or potassium cation, quaternary ammonium cation having 16 to 60 carbon atoms, quaternary phosphonium cation having 16 to 60 carbon atoms, or ternary sulfonium cation having 3 to 26 carbon atoms, or the complex cation of lithium, sodium, or potassium ions with a CROWN ETHER that is a substituted or unsubstituted 18-crown-6, and
HET is a pyrrole, diazole, triazole, or tetrazole group.

10. The photothermographic material of claim 1 comprising one of more of the following substituted olefinic co-developers:

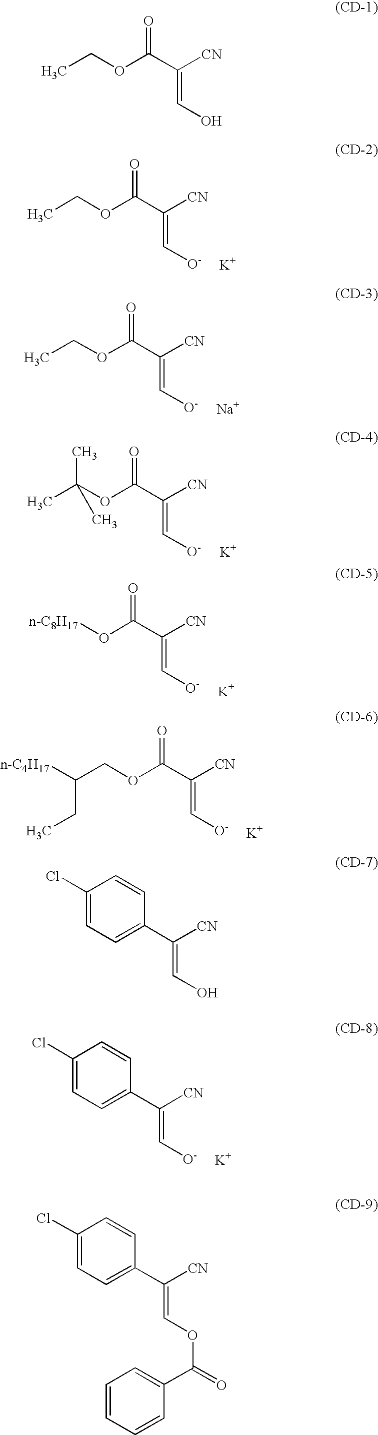

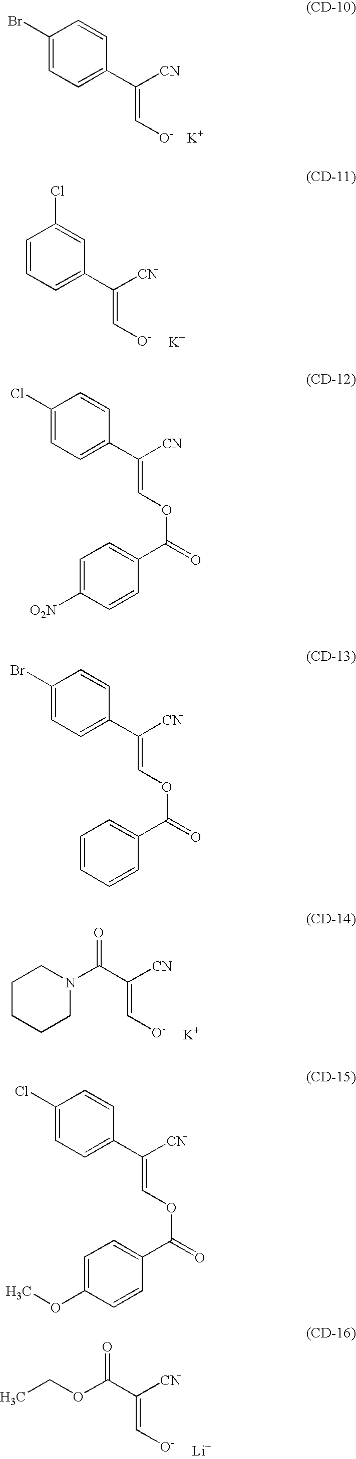

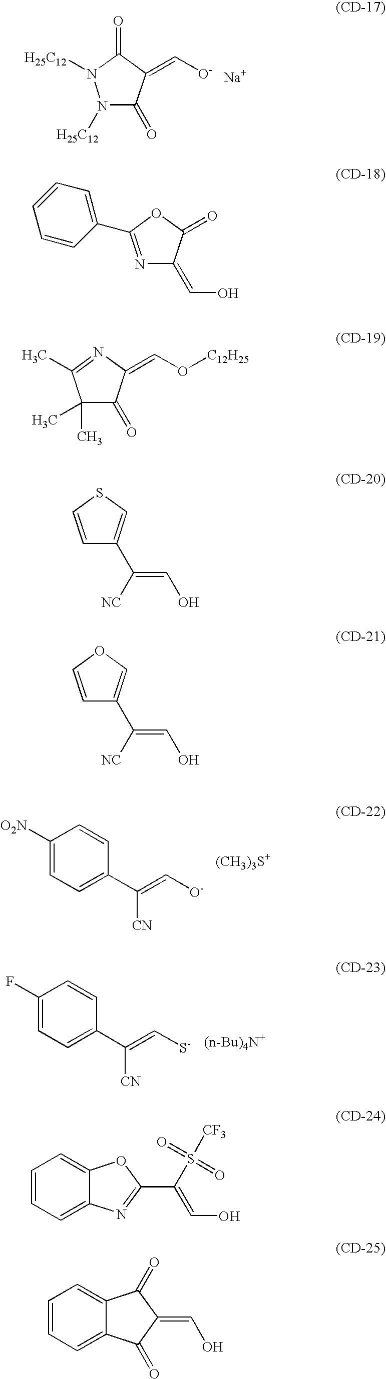

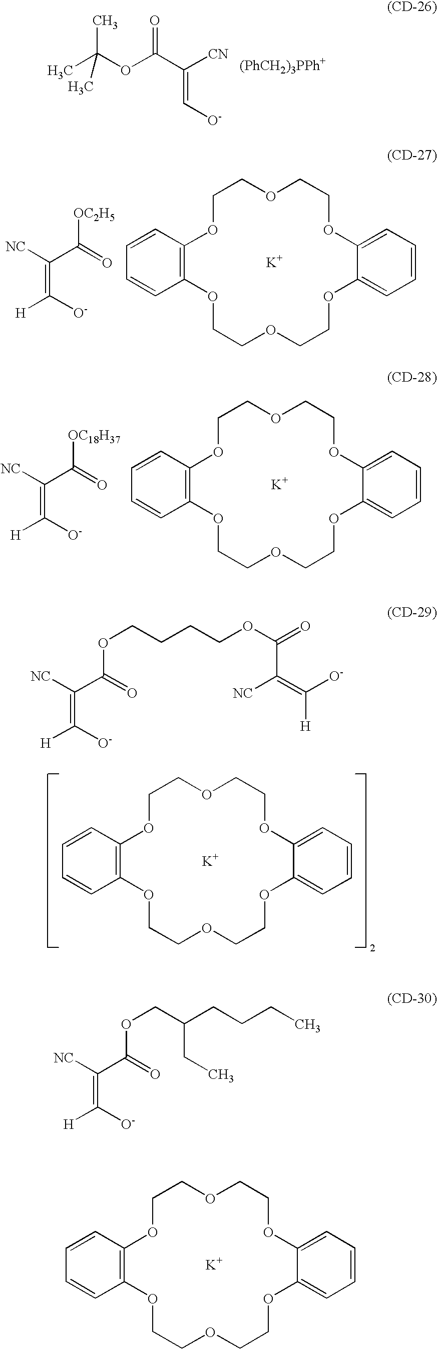

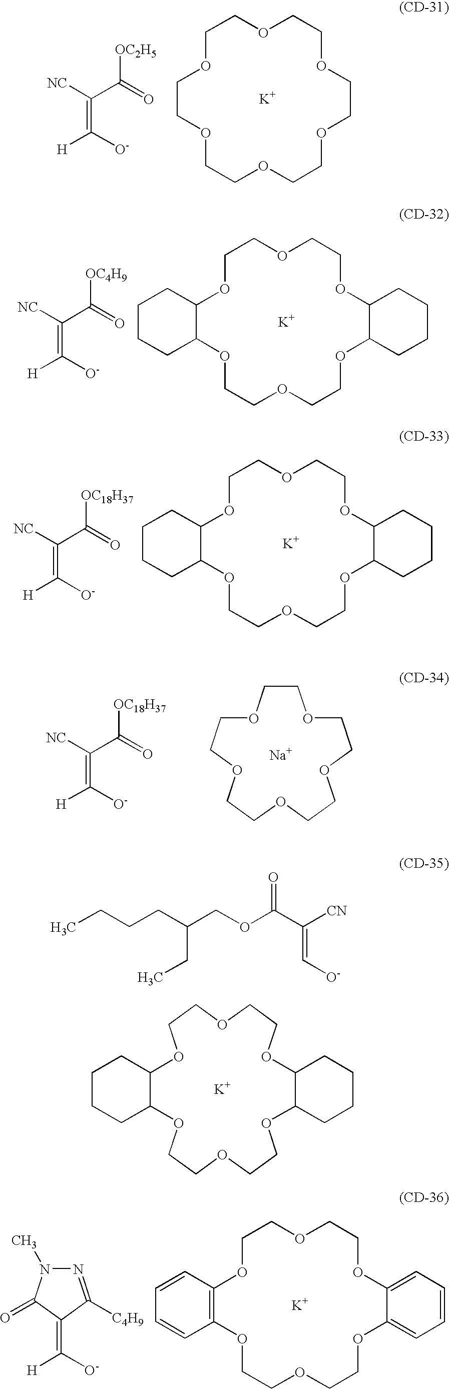

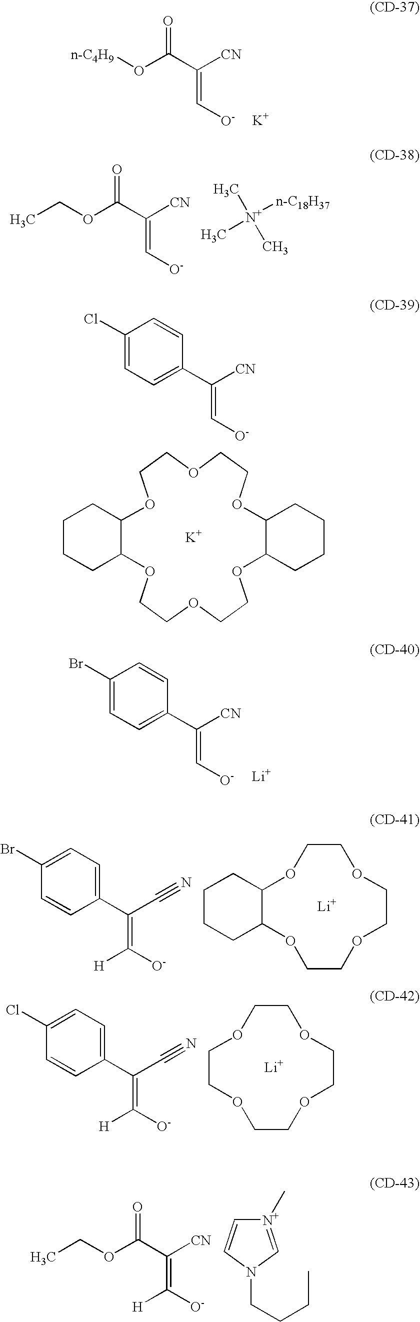

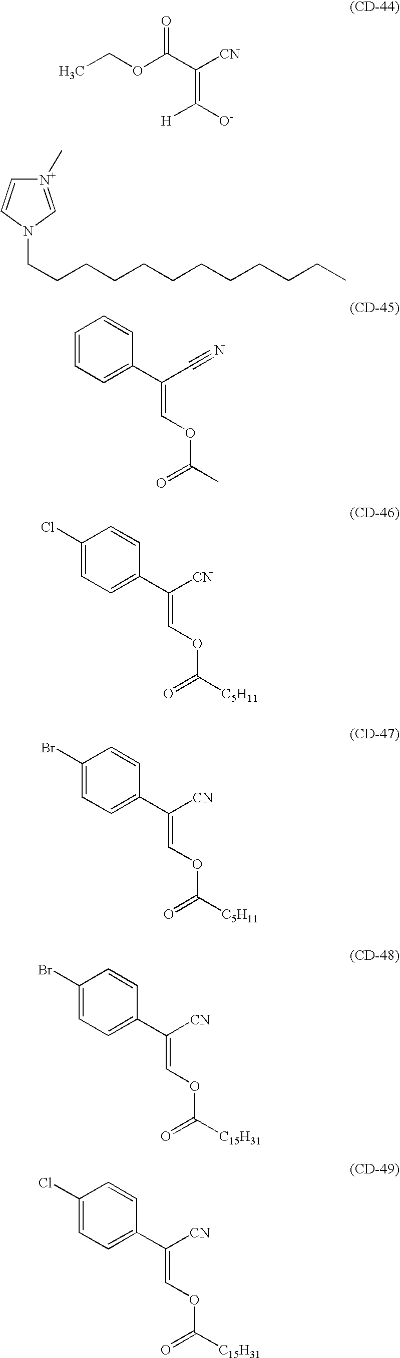

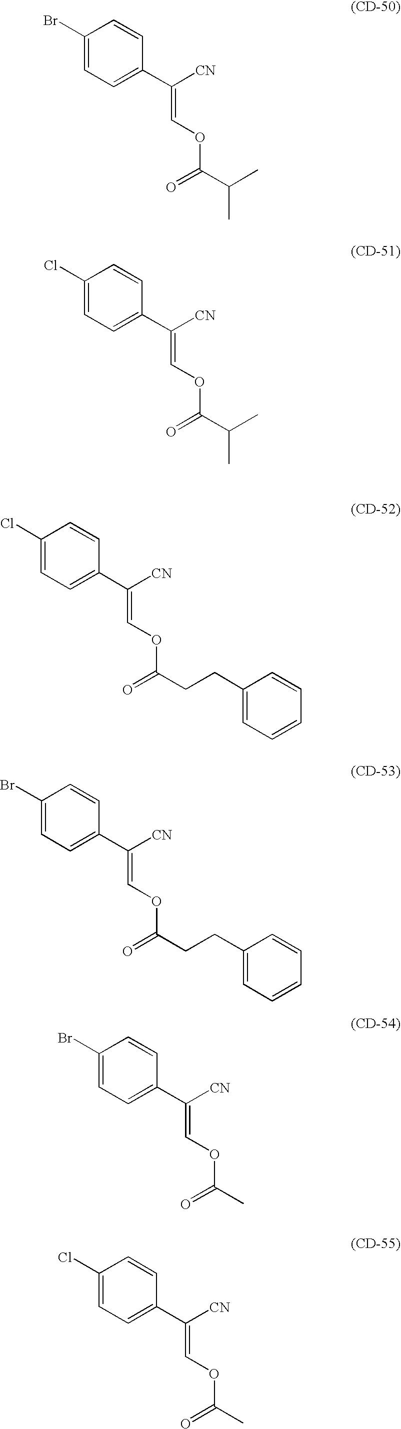

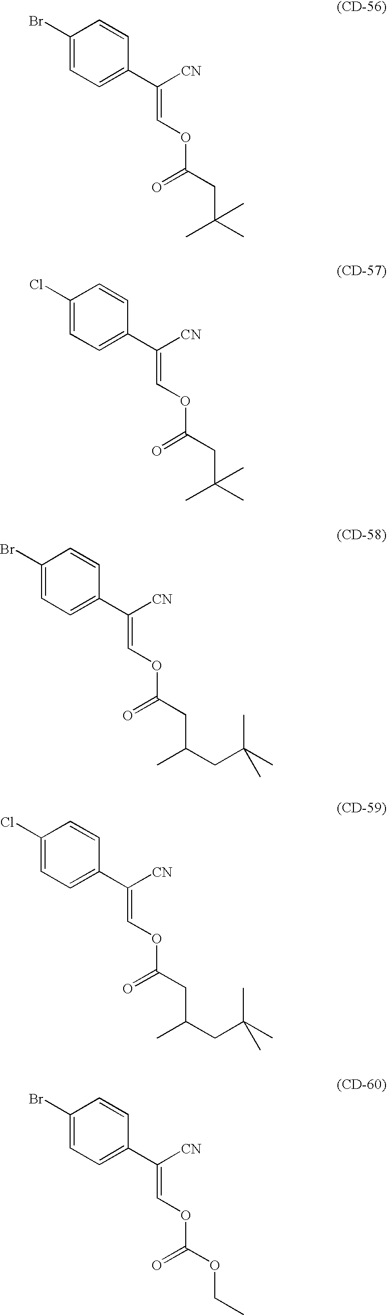

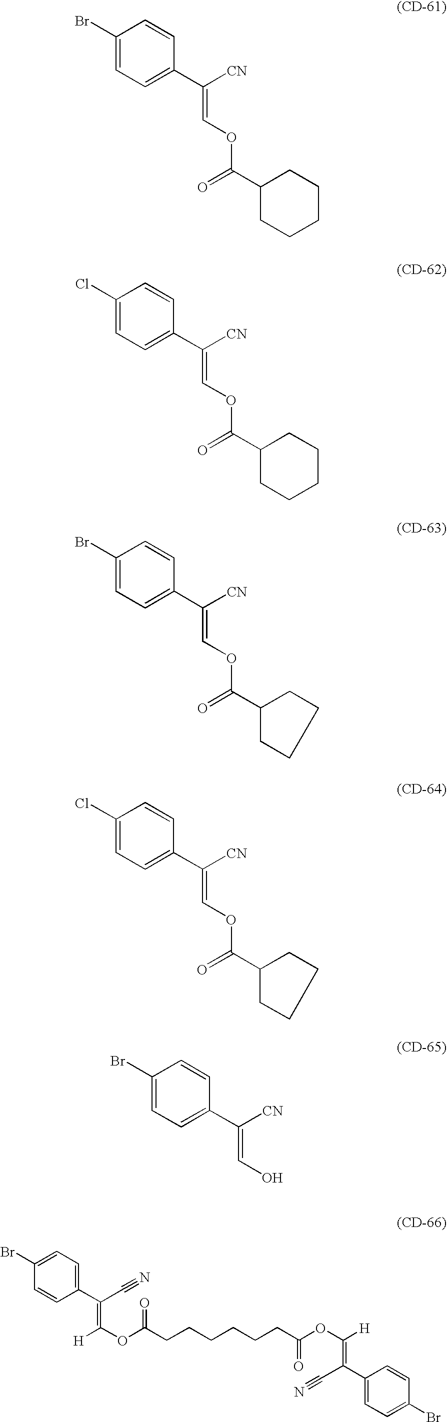

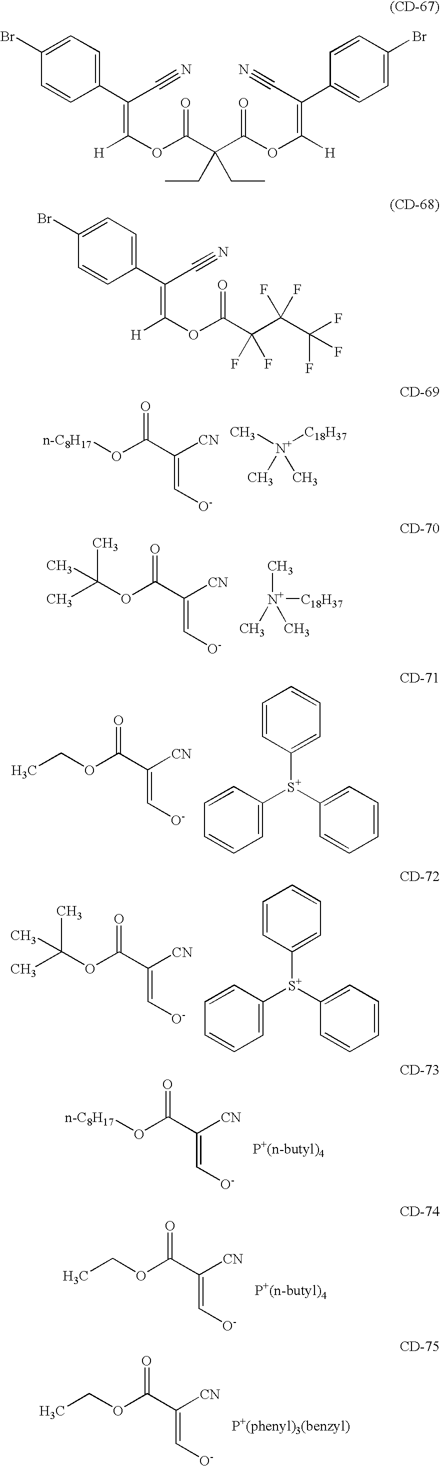

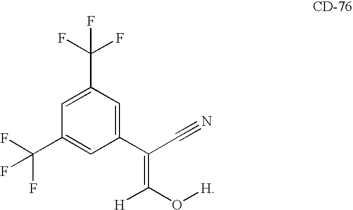

11. The photothermographic material of claim 1 wherein the total amount of silver is from about 1 to about 2.6 g/m².

12. The photothermographic material of claim 1 further comprising at least one additional reducing agent that is a monophenol or a bisphenol, or both.

13. The photothermographic material of claim 1 further comprising a protective overcoat layer disposed over said photothermographic layer, and interlayer, carrier layer, or any combination thereof.

14. The photothermographic material of claim 1 that provides a silver black-and-white image.

15. The photothermographic material of claim 1 wherein said photothermographic imaging layer has been coated out of an organic solvent and said polymeric binder is a hydrophobic binder that is soluble in said organic solvent.

16. The photothermographic material of claim 1 wherein said photosensitive silver halide is silver bromide or a silver iodobromide that is present predominantly in cubic or tabular grains,
said non-photosensitive source of reducible silver ions comprises at least silver behenate,
said polymeric binder is a polyvinyl butyral or polyvinyl acetal binder, and
said substituted olefinic co-developer is one or more of compounds CD-2, CD-7, CD-8, CD-10, CD-39, CD-40, CD-47, CD-48, CD-50, and CD-63 shown below,
wherein the total amount of silver is present in an amount of at least 1 g/m² and less than or equal to 2.6 g/m²,
said trisphenol reducing agent is one or more of Compounds I-2 and I-3 identified below in TABLE I′ in which each of R_{6,} R₇, R₈, R₉, R₁₀, and R₁₁ is hydrogen, and is present in an amount of from about 1 to about 5 mmol/m²,
said substituted olefinic co-developer is present in an amount of from about 0.005 to about 0.02 mmol/m², and the molar ratio of said substituted olefinic co-developer to said trisphenol reducing agent is from about 0.001:1 to about 0.02:1
TABLE I

| Compound | R₁, R₂ | R₃, R₅ | R₄ | L¹, L² |
|---|---|---|---|---|
| I-2 | CH₃ | CH₃ | CH₃ | CH₂ |
| I-3 | Cyclohexyl | CH₃ | CH₃ | CH₂ |

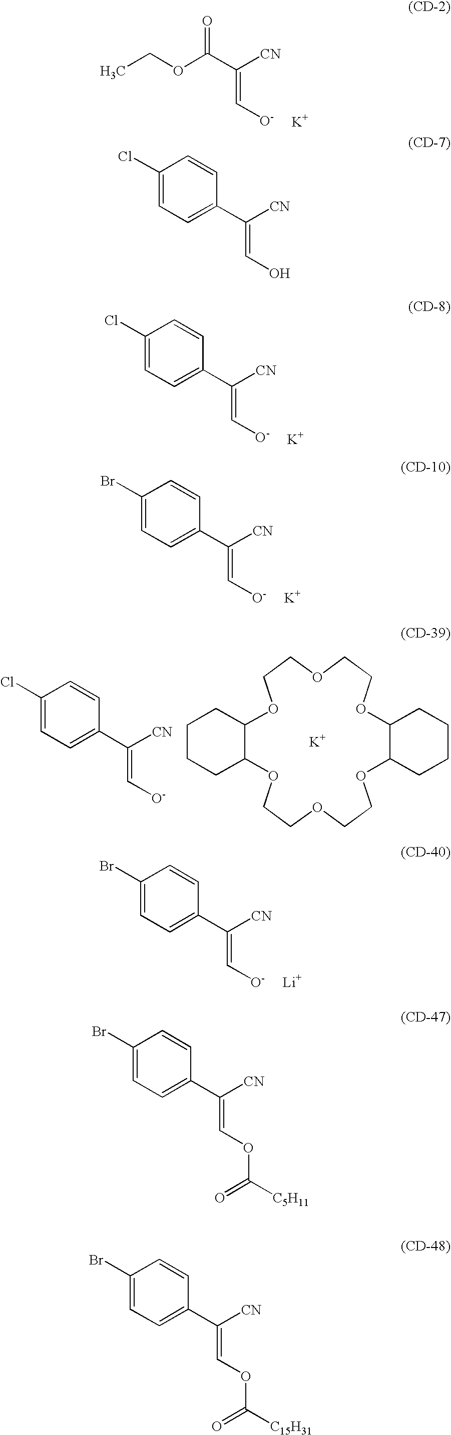

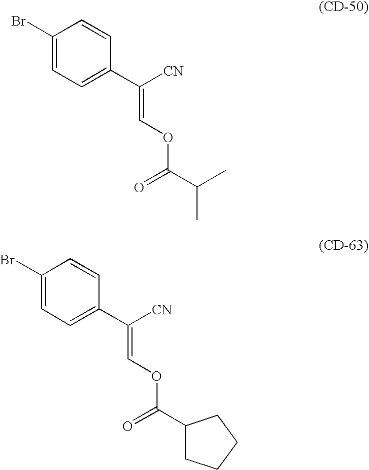

17. The photothermographic material of claim 16 further comprising at least one additional reducing agent that is either a monophenol or bisphenol.

18. The photothermographic material of claim 16 further comprising a quaternary phosphonium salt.

19. The photothermographic material of claim 18 further comprising at least one bisphenol additional reducing agent.

20. A method of forming a visible image comprising:
A) imagewise exposing the photothermographic material of claim 1 to electromagnetic radiation to form a latent image, and
B) simultaneously or sequentially, heating said exposed photothermographic material to develop said latent image into a visible image.

21. The method of claim 20 wherein said imagewise exposing is carried out using laser imaging at from about 600 to about 1200 nm or said development is carried out for at least 3 and up to and including 25 seconds, to provide a visible black-and-white image.

22. The method of claim 20 wherein said photothermographic material includes the following compounds as a substituted olefinic co-developer: 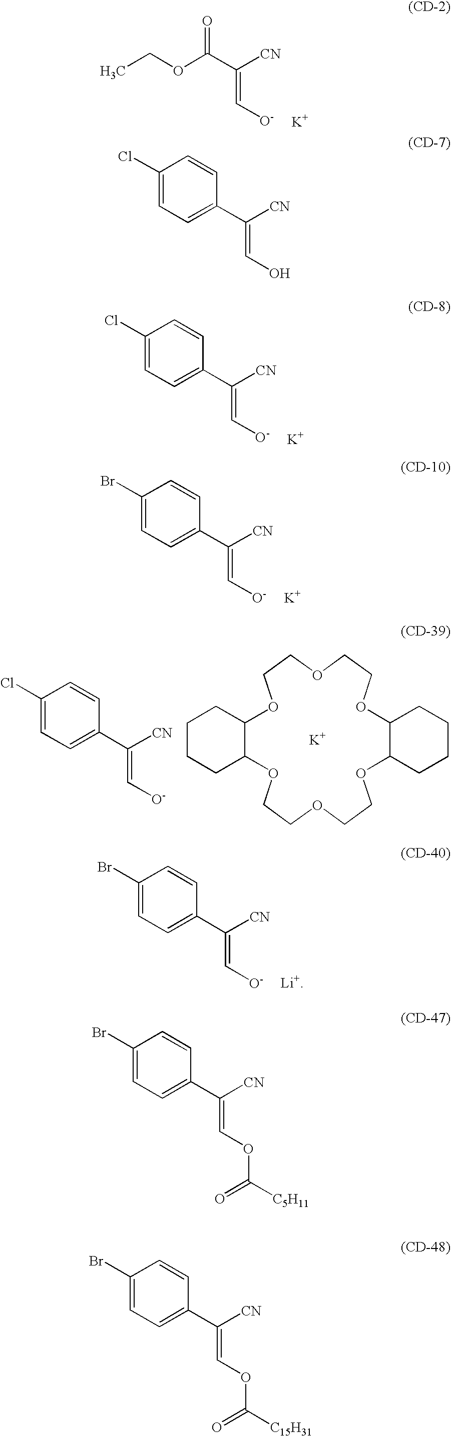 [chemical structure]
